(19) United States
(12) Patent Application Publication
(10) Pub. No.: US 2024/0403772 A1
(43) Pub. Date: Dec. 5, 2024

(54) GOAL-DRIVEN HUMAN-MACHINE INTERACTION ARCHITECTURE, AND SYSTEMS AND METHODS OF USE THEREOF

(71) Applicant: Meta Platforms Technologies, LLC, Menlo Park, CA (US)

(72) Inventors: Benjamin Lafreniere, Toronto (CA); Peiqi Tang, Redmond, WA (US); Kashyap Todi, Seattle, WA (US); Tanya Renee Jonker, Seattle, WA (US); David Owen Driver, Seattle, WA (US)

(21) Appl. No.: 18/648,242

(22) Filed: Apr. 26, 2024

Related U.S. Application Data
(60) Provisional application No. 63/498,700, filed on Apr. 27, 2023.
(60) Provisional application No. 63/498,715, filed on Apr. 27, 2023.
(60) Provisional application No. 63/498,740, filed on Apr. 27, 2023.
(60) Provisional application No. 63/498,716, filed on Apr. 27, 2023.

(51) Int. Cl. G06Q 10/0637; G06F 40/30; G06T 19/00

(52) U.S. Cl. CPC G06Q 10/0637; G06F 40/30; G06T 19/006

(57) ABSTRACT

A method includes assessing a semantic-based query for a user that includes user goals and assessing probability values and first goal probability values, both of which are associated with active digital actions. The method includes generating a decision engine to determine a user friction value and second goal probability values associated with the user goals using the first goal probability values and the probability values. Further, the method includes determining the user friction value and the second goal probability values using the first goal probability values and the probability values. Moreover, the method includes determining a plan of digital actions based on the user friction value, the second goal probability values, and the user goals. Furthermore, the method includes, in response to determining the user friction value exceeds a predetermined threshold, generating a query to adjust the active digital actions based on the semantic-based query for the user.

### RELATED APPLICATIONS

The Present application claims priority to U.S. Provisional App. Nos. 63/498,700 (filed Apr. 27, 2023), 63/498,715 (filed Apr. 27, 2023), 63/498,740 (filed Apr. 27, 2023), and 63/498,716 (filed Apr. 27, 2023), each of which is hereby incorporated by reference in its entirety.

### TECHNICAL FIELD

This disclosure relates, generally, to artificial reality (also known as extended reality or XR), such as virtual reality and augmented reality.

### BACKGROUND

Artificial reality is a form of reality that has been adjusted in some manner before presentation to a user, which may include, e.g., a virtual reality (VR), an augmented reality, a mixed reality (MR), an extended reality (ER), a hybrid reality, or some combination and/or derivatives thereof. Artificial reality content may include completely generated content or generated content combined with captured content (e.g., real-world photographs). Furthermore, artificial reality content may include real-world when a headset does not fully block the light of the real world and allow it to passthrough to the user's eyes so the user can explore surroundings in augmented reality. The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, an HMD with camera sensors and microphones as egocentric sensors, or any other hardware platform capable of providing artificial reality content to one or more viewers.

### SUMMARY

Particular embodiments described herein relate to systems and methods of using a low friction human-machine interaction system for a user to interact with computers to achieve intentions of the user with minimal user friction. The low friction human-machine interaction system can apply multimodal interaction (MMI) to generate one or more artificial intelligence (AI) models for artificial reality or smart-home actions. The low friction human-machine interaction system can assess, from a wearable artificial reality device, a semantic-based query for the user. The semantic-based query can include a plurality of user goals associated with an intention of the user. The low friction human-machine interaction system can perform high-information transfer, contextually optimized, and safe MMI using the semantic-based query. The low friction human-machine interaction system can dynamically provide a plurality of proactive, multimodal, and adaptive interfaces, such as a semantic filter interface or a semantic connection interface, or both, to the user to refine and disambiguate the user's intentions. In particular, the low friction human-machine interaction system can assess a model of intentions which can be a machine learning model, such as a decision tree model, trained to determine a plurality of first recommended digital actions using the semantic-based query of the user. The low friction human-machine interaction system can use the model of intentions to determine the plurality of first recommended digital actions using the semantic-based query for the user. Based on the semantic filter and the plurality of first recommended digital actions, the low friction human-machine interaction system can use a semantic filter to filter the plurality of first recommended digital actions to determine a plurality of first active digital actions associated with the intention of the user via the wearable artificial reality device. The low friction human-machine interaction system can determine a match between the intention of the user and the plurality of first active digital actions associated with the intention of the user. In response to determining the match, the low friction human-machine interaction system can transmit (e.g., to a server computer) the plurality of first active digital actions associated with the intention of the user to perform an operation based on the plurality of first active digital actions associated with the intention of the user. In response to determining the mismatch, the low friction human-machine interaction system can use the wearable artificial reality device and the model of intentions to determine a plurality of second active digital actions associated with the intention of the user using the semantic filter and the plurality of first recommended digital actions.

One example of a method to be performed by a computing system of an artificial reality device is described herein. This example method includes assessing, using the artificial reality device, a semantic-based query for a user, where the semantic-based query includes a plurality of user goals associated with an intention of the user. The method also includes assessing (e.g., using a server computer), based on the semantic-based query for the user, a plurality of probability values associated with a plurality of active digital actions and a plurality of first goal probability values associated with the plurality of active digital actions. Additionally, the method includes generating a decision engine to determine a user friction value and a plurality of second goal probability values associated with the plurality of user goals using the plurality of first goal probability values and the plurality of probability values associated with the plurality of active digital actions. Further, the method includes determining, using the decision engine, the user friction value and the plurality of second goal probability values associated with the plurality of user goals using the plurality of first goal probability values and the plurality of probability values associated with the plurality of active digital actions. Moreover, the method includes determining a plan of digital actions based on the user friction value, the plurality of second goal probability values, and the plurality of user goals. Furthermore, the method includes, in response to determining the user friction value exceeds a predetermined threshold, generating a query to the artificial reality device to adjust the plurality of active digital actions based on the semantic-based query for the user.

An example of non-transitory, computer-readable storage media is also described herein. The example storage media embodies software that is operable when executed to assess, using an artificial reality device, a semantic-based query for a user, where the semantic-based query includes a plurality of user goals associated with an intention of the user. The software is also operable when executed to assess, using a server computer and the semantic-based query for the user, a plurality of probability values associated with a plurality of active digital actions and a plurality of first goal probability values associated with the plurality of active digital actions. Additionally, the software is operable when executed to generate a decision engine to determine a user friction value and a plurality of second goal probability values associated with the plurality of user goals using the plurality of first goal probability values and the plurality of probability values associated with the plurality of active digital actions. Further, the software is operable when executed to determine, using the decision engine, the user friction value and the plurality of second goal probability values associated with the plurality of user goals using the plurality of first goal probability values and the plurality of probability values associated with the plurality of active digital actions. Moreover, the software is operable when executed to determine a plan of digital actions based on the user friction value, the plurality of second goal probability values, and the plurality of user goals. Furthermore, the software is operable when executed to, in response to determining the user friction value exceeds a predetermined threshold, generate a query to the artificial reality device to adjust the plurality of active digital actions based on the semantic-based query for the user.

An example of a system is also described herein. The example system includes one or more processors and one or more non-transitory, computer-readable storage media coupled to one or more of the processors and including instructions operable when executed by one or more of the processors to cause the system to assess, using an artificial reality device, a semantic-based query for a user, where the semantic-based query includes a plurality of user goals associated with an intention of the user. The instructions are also operable when executed to cause the system to assess, using a server computer and the semantic-based query for the user, a plurality of probability values associated with a plurality of active digital actions and a plurality of first goal probability values associated with the plurality of active digital actions. Additionally, the instructions are operable when executed to cause the system to generate a decision engine to determine a user friction value and a plurality of second goal probability values associated with the plurality of user goals using the plurality of first goal probability values and the plurality of probability values associated with the plurality of active digital actions. Further, the instructions are operable when executed to cause the system to determine, using the decision engine, the user friction value and the plurality of second goal probability values associated with the plurality of user goals using the plurality of first goal probability values and the plurality of probability values associated with the plurality of active digital actions. Moreover, the instructions are operable when executed to cause the system to determine a plan of digital actions based on the user friction value, the plurality of second goal probability values, and the plurality of user goals. Furthermore, the instructions are operable when executed to cause the system to, in response to determining the user friction value exceeds a predetermined threshold, generate a query to the artificial reality device to adjust the plurality of active digital actions based on the semantic-based query for the user.

Having summarized the first aspect generally related to generating a query for adjusting active digital actions, the second aspect is now summarized-relating to transmitting digital actions associated with user intent to a server for performance of an operation based on said digital actions.

One example method to be performed by a computing system of an artificial reality device is described herein. The method includes assessing, using the artificial reality device, a semantic-based query for a user, where the semantic-based query includes a digital action associated with an intention of the user. The method also includes assessing (e.g., using a server computer) a model of intentions, where the model of intentions is a machine learning model trained to determine a plurality of first recommended digital actions using the semantic-based query of the user. Additionally, the method includes predicting, using the model of intentions, the plurality of first recommended digital actions using the semantic-based query for the user. Further, the method includes determining, using the artificial reality device and the model of intentions, a plurality of first active digital actions associated with the intention of the user using a semantic filter and the plurality of first recommended digital actions. Moreover, the method includes determining a match between the intention of the user and the plurality of first active digital actions associated with the intention of the user. Furthermore, the method includes, in response to determining the match, transmitting (e.g., to a server computer) the plurality of first active digital actions associated with the intention of the user to perform an operation based on the plurality of first active digital actions associated with the intention of the user.

An example of non-transitory, computer-readable storage media is also described herein. The storage media embodies software that is operable when executed to assess, using an artificial reality device, a semantic-based query for a user, where the semantic-based query includes a digital action associated with an intention of the user. The software is also operable when executed to assess (e.g., using a server computer) a model of intentions, where the model of intentions is a machine learning model trained to determine a plurality of first recommended digital actions using the semantic-based query of the user. Additionally, the software is operable when executed to predict, using the model of intentions, the plurality of first recommended digital actions using the semantic-based query for the user. Further, the software is operable when executed to determine, using the artificial reality device and the model of intentions, a plurality of first active digital actions associated with the intention of the user using a semantic filter and the plurality of first recommended digital actions. Moreover, the software is operable when executed to determine a match between the intention of the user and the plurality of first active digital actions associated with the intention of the user. Furthermore, the software is operable when executed to, in response to determining the match, transmit (e.g., to a server computer) the plurality of first active digital actions associated with the intention of the user to perform an operation based on the plurality of first active digital actions associated with the intention of the user.

An example of a system is described herein. The system includes one or more processors and one or more non-transitory, computer-readable media coupled to one or more of the processors and including instructions operable when executed by one or more of the processors to cause the system to assess, using an artificial reality device, a semantic-based query for a user, wherein the semantic-based query includes a digital action associated with an intention of the user. The instructions are also operable when executed to cause the system to assess (e.g., using a server computer) a model of intentions, where the model of intentions is a machine learning model trained to determine a plurality of first recommended digital actions using the semantic-based query of the user. Additionally, the instructions are operable when executed to cause the system to predict, using the model of intentions, the plurality of first recommended digital actions using the semantic-based query for the user. Further, the instructions are operable when executed to cause the system to determine, using the artificial reality device and the model of intentions, a plurality of first active digital actions associated with the intention of the user using a semantic filter and the plurality of first recommended digital actions. Moreover, the instructions are operable when executed to cause the system to determine a match between the intention of the user and the plurality of first active digital actions associated with the intention of the user. Furthermore, the instructions are operable when executed to cause the system to in response to determining the match, transmit (e.g., to a server computer) the plurality of first active digital actions associated with the intention of the user to perform an operation based on the plurality of first active digital actions associated with the intention of the user.

Having summarized the second aspect generally related to use of transmitting actions associated with user intent, the third aspect is now summarized-relating to determining a probability distribution for user goals using context representations associated with response data and goal representations associated with user goals.

One example method to be performed by a computing system of an artificial reality device is described herein. The method includes assessing, using the artificial reality device, a semantic-based query for a user and response data from a plurality of on-board sensors, where the semantic-based query includes a plurality of user goals associated with an intention of the user, each of the plurality of user goals associated with a corresponding text description. The method also includes assessing (e.g., using a server computer) a first machine learning model, a second machine learning model, and a third machine learning model, where the first machine learning model is applied to determine context representations associated with the response data using the response data from the plurality of on-board sensors, where the second machine learning model is applied to determine goal representations associated with the plurality of user goals using the text descriptions of the plurality of user goals, and where the third machine learning model is applied to determine a probability distribution for the plurality of user goals using the context representations associated with the response data and the goal representations associated with the plurality of user goals. Additionally, the method includes determining, using the first machine learning model, the context representations associated with the response data using the response data from the plurality of on-board sensors. Further, the method includes determining, using the second machine learning model, the goal representations associated with the plurality of user goals using the text descriptions of the plurality of user goals. Moreover, the method includes determining, using the third machine learning model, a probability distribution for the plurality of user goals using the context representations associated with the response data and the goal representations associated with the plurality of user goals.

An example of non-transitory, computer-readable storage media is also described herein. The storage media embodies software that is operable when executed to assess, using an artificial reality device, a semantic-based query for a user and response data from a plurality of on-board sensors, where the semantic-based query includes a plurality of user goals associated with an intention of the user, each of the plurality of user goals associated with a corresponding text description. The software is also operable when executed to assess (e.g., using a server computer) a first machine learning model, a second machine learning model, and a third machine learning model, where the first machine learning model is applied to determine context representations associated with the response data using the response data from the plurality of on-board sensors, where the second machine learning model is applied to determine goal representations associated with the plurality of user goals using the text descriptions of the plurality of user goals, and where the third machine learning model is applied to determine a probability distribution for the plurality of user goals using the context representations associated with the response data and the goal representations associated with the plurality of user goals. Additionally, the software is operable when executed to determine, using the first machine learning model, the context representations associated with the response data using the response data from the plurality of on-board sensors. Further, the software is operable when executed to determine, using the second machine learning model, the goal representations associated with the plurality of user goals using the text descriptions of the plurality of user goals. Moreover, the software is operable when executed to determine, using the third machine learning model, a probability distribution for the plurality of user goals using the context representations associated with the response data and the goal representations associated with the plurality of user goals.

An example of a system is described herein. The system includes one or more processors and one or more non-transitory, computer-readable media coupled to one or more of the processors and including instructions operable when executed by one or more of the processors to cause the system to assess, using an artificial reality device, a semantic-based query for a user and response data from a plurality of on-board sensors, where the semantic-based query includes a plurality of user goals associated with an intention of the user, each of the plurality of user goals associated with a corresponding text description. The instructions are also operable when executed to cause the system to assess (e.g., using a server computer) a first machine learning model, a second machine learning model, and a third machine learning model, where the first machine learning model is applied to determine context representations associated with the response data using the response data from the plurality of on-board sensors, where the second machine learning model is applied to determine goal representations associated with the plurality of user goals using the text descriptions of the plurality of user goals, and where the third machine learning model is applied to determine a probability distribution for the plurality of user goals using the context representations associated with the response data and the goal representations associated with the plurality of user goals. Additionally, the instructions are operable when executed to cause the system to determine, using the first machine learning model, the context representations associated with the response data using the response data from the plurality of on-board sensors. Further, the instructions are operable when executed to cause the system to determine, using the second machine learning model, the goal representations associated with the plurality of user goals using the text descriptions of the plurality of user goals. Moreover, the instructions are operable when executed to cause the system to determine, using the third machine learning model, a probability distribution for the plurality of user goals using the context representations associated with the response data and the goal representations associated with the plurality of user goals.

Having summarized the third aspect generally related to determining a probability distribution for user goals, the fourth aspect is now summarized-relating to determining a user friction value and a disambiguated user goal using user goals and probability values associated with response data.

One example method to be performed by a computing system of an artificial reality device is described herein. The method includes assessing, using the artificial reality device, a semantic-based query for a user and response data from a plurality of on-board sensors, and where the semantic-based query includes a plurality of user goals associated with an intention of the user. The method also includes assessing (e.g., using a server computer) a plurality of first probability values associated with the response data and a plurality of second probability values associated with the plurality of user goals. Additionally, the method includes assessing (e.g., using a server computer) a machine learning model to determine a user friction value and a disambiguated user goal using the plurality of first probability values associated with the response data and the plurality of second probability values associated with the plurality of user goals. Further, the method includes determining, using the machine learning model, the user friction value and the disambiguated user goal using the plurality of user goals and the plurality of probability values associated with the response data.

An example of non-transitory, computer-readable storage media is also described herein. The storage media embodies software that is operable when executed to assess, using an artificial reality device, a semantic-based query for a user and response data from a plurality of on-board sensors, and where the semantic-based query includes a plurality of user goals associated with an intention of the user. The software is also operable when executed to assess (e.g., using a server computer) a plurality of first probability values associated with the response data and a plurality of second probability values associated with the plurality of user goals. Additionally, the software is operable when executed to assess (e.g., using a server computer) a machine learning model to determine a user friction value and a disambiguated user goal using the plurality of first probability values associated with the response data and the plurality of second probability values associated with the plurality of user goals. Further, the software is operable when executed to determine, using the machine learning model, the user friction value and the disambiguated user goal using the plurality of user goals and the plurality of probability values associated with the response data.

An example of a system is described herein. The system includes one or more processors and one or more non-transitory, computer-readable media coupled to one or more of the processors and including instructions operable when executed by one or more of the processors to cause the system to assess, using an artificial reality device, a semantic-based query for a user and response data from a plurality of on-board sensors, and where the semantic-based query includes a plurality of user goals associated with an intention of the user. The instructions are also operable when executed to cause the system to assess (e.g., using a server computer) a plurality of first probability values associated with the response data and a plurality of second probability values associated with the plurality of user goals. Additionally, the instructions are operable when executed to assess (e.g., using a server computer) a machine learning model to determine a user friction value and a disambiguated user goal using the plurality of first probability values associated with the response data and the plurality of second probability values associated with the plurality of user goals. Further, the instructions are operable when executed to determine, using the machine learning model, the user friction value and the disambiguated user goal using the plurality of user goals and the plurality of probability values associated with the response data.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A illustrates an example artificial reality system, in accordance with some embodiments.

FIG. 1B illustrates an example augmented reality system, in accordance with some embodiments.

FIGS. 2A and 2B illustrate example low friction human-machine interaction architectures of the artificial reality systems, in accordance with some embodiments.

FIG. 3 illustrates an example goal disambiguation AI stage of the low friction human-machine interaction system of the artificial reality systems, in accordance with some embodiments.

FIG. 4A illustrates an example goal inference to enable proactivity of the low friction human-machine interaction system, in accordance with some embodiments.

FIG. 4B illustrates an example goal interpretation to enable goal orientedness of the low friction human-machine interaction system, in accordance with some embodiments.

FIG. 5 illustrates an example neural network of the artificial reality systems to update goal probabilities and user cost, in accordance with some embodiments.

FIG. 6 illustrates an example goal value alignment versus incurred friction pareto front of the low friction human-machine interaction system of the artificial reality systems, in accordance with some embodiments.

FIGS. 7A and 7B illustrate example interface and friction for randomly selected tags and quasi-optimally selected goal tags, in accordance with some embodiments.

FIG. 8 illustrates an example semantic filter interface, in accordance with some embodiments.

FIGS. 9A-9B illustrate example semantic connection interfaces, in accordance with some embodiments.

FIG. 10 illustrates an example method for determining a plurality of active digital actions using a semantic-based query for a user, in accordance with some embodiments.

FIG. 11 illustrates an example method for determining a user friction value and a plan of digital action using a low friction human-machine interaction system based on a semantic-based query for a user, in accordance with some embodiments.

FIG. 12 illustrates an example method for determining context representations, goal representations, and a plurality of probability distribution over user's goals based on a semantic-based query for a user, in accordance with some embodiments.

FIG. 13 illustrates an example method for determining a user friction value and a disambiguated user goal using a semantic-based query for a user, in accordance with some embodiments.

FIG. 14 illustrates an example computer system, in accordance with some embodiments.

FIGS. 15A, 15B, 15C-1, and 15C-2 illustrate example artificial-reality systems, in accordance with some embodiments.

FIGS. 16A-16B illustrate an example wrist-wearable device, in accordance with some embodiments.

FIGS. 17A, 17B-1, 17B-2, and 17C illustrate example head-wearable devices, in accordance with some embodiments.

FIGS. 18A-18B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality, as described herein, is any superimposed functionality and or sensory-detectable presentation provided by an artificial-reality system within a user's physical surroundings. Such artificial-realities can include and/or represent virtual reality (VR), augmented reality, mixed artificial-reality, or some combination and/or variation one of these. For example, a user can perform a swiping in-air hand gesture to cause a song to be skipped by a song-providing API providing playback at, for example, a home speaker. An artificial reality environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

Many of the devices, systems, and methods described herein pertain to a low friction human-machine interaction architecture. Low friction human-machine interactions are important for security and personalization of artificial reality systems. Such interactions can occur in a contextualized human-agent interface between a user and a computer, such as a personal computer (PC). Similar to a paradigm shift of mobile phone adoption of the personal computer to mobile phone adoption of voice assistants, the low friction human-machine interaction system provides novel ways in which the user interacts with computers and design technologies. The configuration of the artificial reality systems is designed to perform high-information transfer, contextually optimized, and safe MMI to generate one or more proactive, goal-oriented, and human-augmenting artificial intelligence models for artificial reality and smart-home devices. For example, the AI models can leverage a combination of artificial reality glasses with egocentric observations and smart home devices with exocentric observations in a controlled environment.

In an embodiment, it remains a challenging problem to apply a traditional human-machine interaction system to achieve proficient interface usage because they are fundamentally restricted and limited. For example, the traditional human-machine interaction system is often limited in the delivery of information by leveraging a small number fixed unimodal input and output channels, such as touch user interface, voice assistants, etc. Thus, the traditional human-machine interaction system is often user initiated with limited contextual awareness, rather than machine-initiated and able to present contextually optimized interfaces to the user to issue commands for low-bandwidth input, such as parametric information, textures, etc. As another example, the traditional human-machine interaction system requires the user to adapt to a machine's capabilities and needs without adapting to the current context and the user to minimize user incurred friction of interaction. In particular, the traditional human-machine interaction system is restricted to a relatively narrow set of contexts which the user can issue commands using high-bandwidth input, such as speech input and/or natural language descriptions of the user's intention. The traditional human-machine interaction system restricts users and systems to express themselves to each other through one or few input modalities. Because the traditional human-machine interaction system is strictly reactive and mostly unimodal input for both input and output with very few exceptions, traditional human-machine interaction interfaces incur high friction and break social norms. Likewise, the traditional human-machine interaction system is characterized by entirely user-initiated interactions which inhibit the user's ability to reduce friction through anticipating the user's needs. As a result, the traditional human-machine interaction system has no contextual awareness which makes decisions that accrue excessive friction without the ability to learn and adapt. Likewise, the traditional human-machine interaction system suffers from a discovery problem where large parts of the functionality that the system is capable of performing are never discovered by the user.

In an embodiment, a technical benefit of the embodiment is to apply the contextually informed low friction human-machine interaction system to dynamically provide a plurality of proactive, multimodal, and adaptive interfaces, such as a semantic filter interface or a semantic connection interface, or both, to the user to refine and disambiguate the user's intentions which include one or more goals. The intentions of the user can include what the user wants to do in a given moment. For example, the low friction human-machine interaction system can apply a model of intentions to determine a plurality of recommended digital actions associated with the intentions of the user. As another example, the low friction human-machine interaction system can refine and disambiguate the plurality of recommended digital actions using a semantic filter and the model of intentions to determine a plurality of active digital actions which are consistent with the intentions of the user. The model of intentions can be equipped in a plurality of interfaces associated with the artificial reality systems, such as artificial reality glasses plus wristbands, to efficiently enhance user experience by lowering the barrier to entry, accelerating the time to learn, and minimizing user incurred friction. In particular, the user incurred friction is determined by a function of myriad contextual features that characterize the cost incurred by the interaction based on optimal realization of personal goals, nearly zero friction Input/Output (I/O), and maximal human expressiveness to communicate the user's goals to the machine.

In an embodiment, a technical benefit of the embodiment is to apply the low friction human-machine interfaces to allow the user to interact with the computer system by leveraging contextually optimized modalities or combinations thereof. For example, the low friction human-machine interfaces can generate contextually aware multimodal human-machine communication that automatically adapts the output to a particular context. As another example, the low friction human-machine interaction can be applied to build proactive human-machine communication, such as machine-initiated, and present contextually optimized interfaces to the user that can accept low- and/or high-bandwidth user input. The artificial reality systems can apply the low friction human-machine interaction interfaces to achieve nearly zero user incurred friction. Thus, the low friction human-machine interaction interfaces can discover capabilities previously unknown to the user, which in turn provides a much broader range of capabilities among a list of applications and further incentivizes third party development.

In an embodiment, a technical benefit of the embodiment is to apply the low friction human-machine interfaces to generate a contextually aware decision engine to ensure the user's safety at all times and minimize user incurred friction in any given context. The artificial reality systems may apply the low friction human-machine interaction interfaces to achieve equal opportunity and safety for the user (e.g., based on nearly zero friction I/O and/or zero time to learn). The low friction human-machine interaction interfaces dramatically reduce the barrier to access by enabling the user to effectively engage in the interaction even with limited expertise or prior knowledge and projecting them from potentially harmful interaction. Furthermore, the artificial reality systems may apply the low friction human-machine interaction interfaces to adapt to meet the needs of the machine and have the flexibility to correct for user input error, assist rapid onboarding from novice-to-expert, and adjust output and input requirements to individual needs to maximize accessibility.

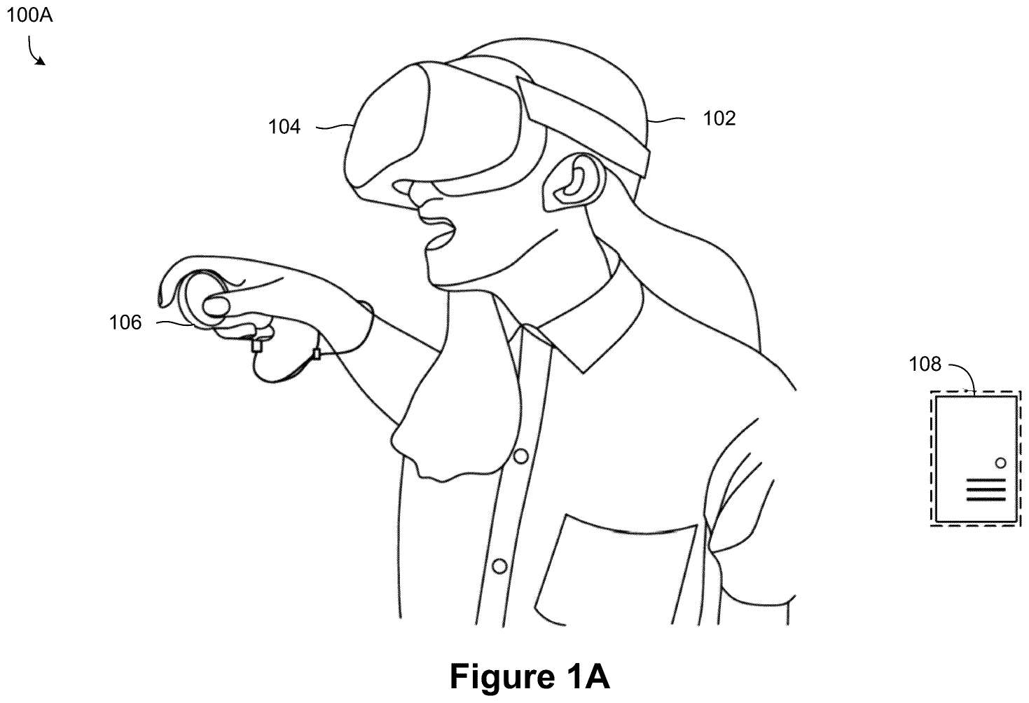

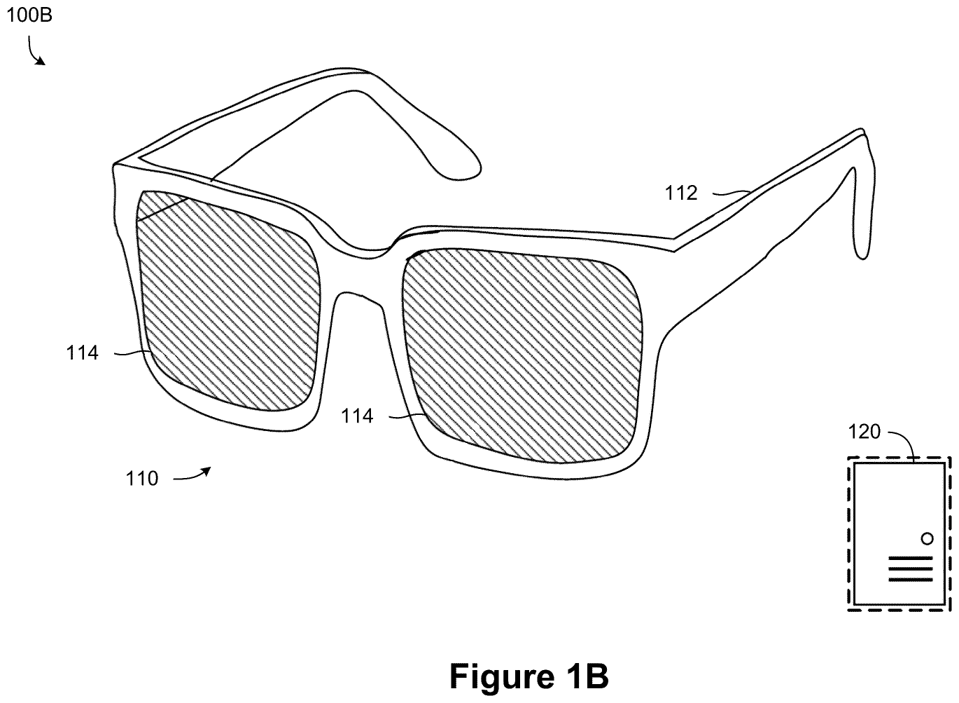

FIG. 1A illustrates an example artificial reality system 100A. In particular embodiments, the artificial reality system 100A may comprise a headset 104, a controller 106, and a computing system 108, etc. A user 102 may wear the headset 104 that could display visual artificial reality content to the user 102. The headset 104 may include an audio device that could provide audio artificial reality content to the user 102. The headset 104 may include one or more cameras which can capture images and videos of environments. The headset 104 may include an eye tracking system to determine the vergence distance of the user 102. The headset 104 may be referred to as an HMD. The controller 106 may comprise a trackpad and one or more buttons. The controller 106 may receive inputs from the user 102 and relay the inputs to the computing system 108. The controller 106 may also provide haptic feedback to the user 102. The computing system 108 may be connected to the headset 104 and the controller 106 through cables or wireless connections. The computing system 108 may control the headset 104 and the controller 106 to provide the artificial reality content to and receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example augmented reality system 100B. The augmented reality system 100B may include an HMD 110 (e.g., glasses) comprising a frame 112, one or more displays 114, and a computing system 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The augmented reality system 100B may further include a controller comprising a trackpad and one or more buttons. The controller may receive inputs from users and relay the inputs to the computing system 120. The controller may also provide haptic feedback to users. The computing system 120 may be connected to the HMD 110 and the controller through cables or wireless connections. The computing system 120 may control the HMD 110 and the controller to provide the augmented reality content to and receive inputs from users. The computing system 120 may be a standalone host computer system, an on-board computer system integrated with the HMD 110, a mobile device, or any other hardware platform capable of providing artificial reality content to and receiving inputs from users.

### Low Friction Human-Machine Interaction System Structural and Functional Overview

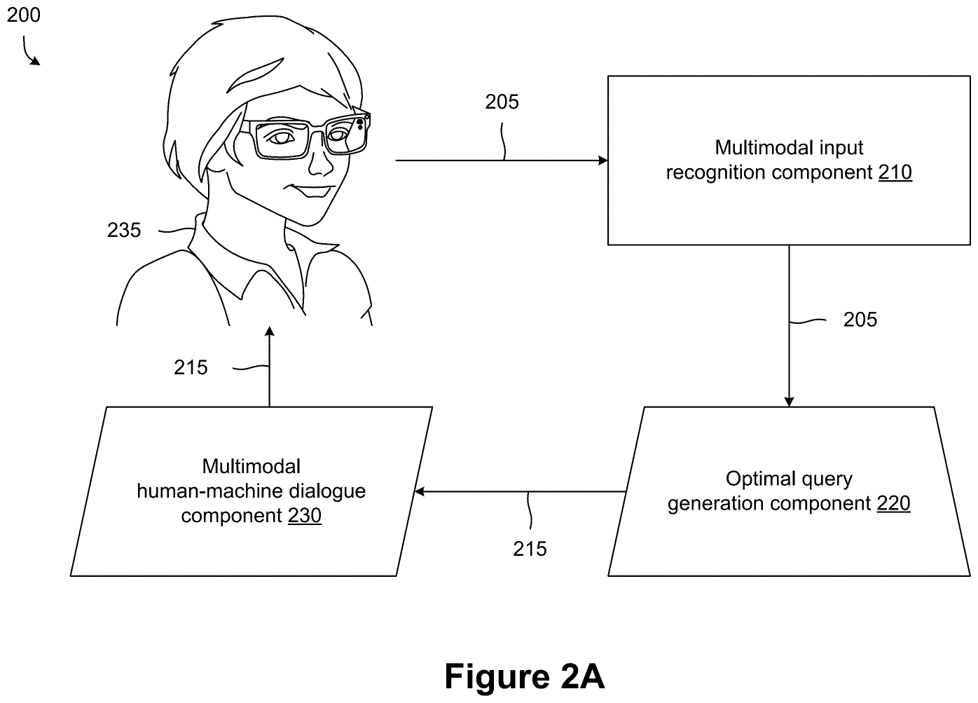

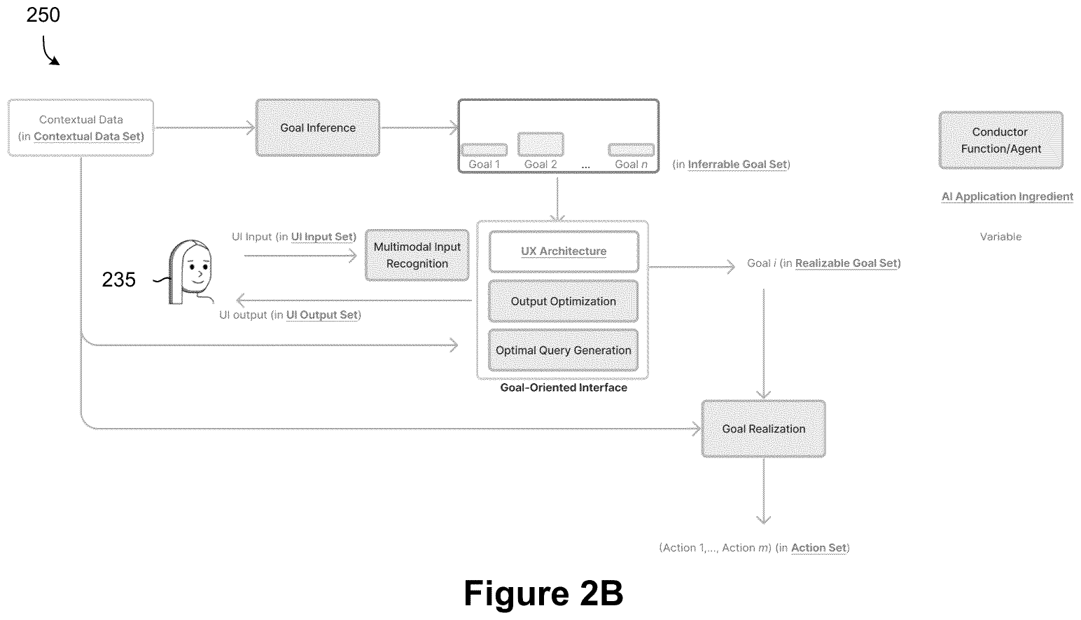

FIGS. 2A and 2B illustrate example low friction human-machine interaction architectures 200 and 250 of the artificial reality systems, in accordance with some embodiments. In particular embodiments, the low friction human-machine interaction architecture 200 of the artificial reality systems provides a framework of AI agents for interaction with a user, such as user 235 (e.g., user 102 of FIG. 1A), based on a plurality of human interface abstraction layers, attendant set of application programming interfaces (APIs), and deployment policy. The deployment policy is applied to ensure a system-level user safety across multiple dimensions of the user experience using policy deployment data 374. In particular, the deployment policy is optimized continuously when to seamlessly infer the user's goals at the highest levels of abstraction possible and aggregating and deploying AI agents in line with that goal. An AI agent includes at least a human-interface abstraction layer, attendant set of APIs, and deployment policy with strong system-level guarantees across multiple dimensions of the user experience, including user safety. The low friction human-machine interaction architecture 200 is characterized by a low friction human-machine interaction system which includes a multimodal input recognition component 210, an optimal query generation component 220, and a multimodal human-machine dialogue component 230. The artificial reality systems can apply the AI agents to infer one or more goals of a user, such as user 235, at a high level of abstraction. For example, the artificial reality systems can deploy and coordinate an ecosystem of task-specific agents, such as the multimodal input recognition component 210, the optimal query generation component 220, and the multimodal human-machine dialogue component 230, to help the user 235 to accomplish the one or more goals of the user by minimizing user friction and ensuring high quality user experience and user safety.

In an embodiment, traditional human-machine interaction paradigms are insufficient to achieve high-level goals of the user 235 with a low friction, high quality user experience and user safety. For example, traditional human-machine interaction paradigms simply provide a tool set for the user 235 to learn and deploy the tool set. In particular, the steps the user 235 must take to accomplish a goal have been statically optimized and compiled, yielding an interface comprising a menu system with a fixed view hierarchy that simply reacts to the user's commands. As another example, traditional human-machine interaction paradigms can focus exclusively on disambiguating users' low-level intent which often incur large user friction. The user 235 can repeatedly navigate the interface with fixed view hierarchy and deploy a low-level action primitive, such as navigate a menu, utter a spoken instruction, and use a keyboard shortcut to execute a command. This places a lower bound on the user friction incurred by interacting with the artificial reality systems. In particular, traditional human-machine interaction paradigms can employ burdensome, contextless system-navigation mechanisms across a small number of available I/O channels that will yield unacceptably high levels of user friction for all-day interactions within the artificial reality systems. As another example, predefined menu systems navigated using bandwidth-limited, high-attention explicit-input navigation, such as point-and-click, are burdensome and possibly infeasible when the user can only dedicate limited attention to the interface. Alternatively, voice commands of a higher bandwidth than point-and-click commands do not work well when they lack sufficient context, universally lack contextual appropriateness, such as subtlety, social acceptability, and intuitiveness, and do not lend themselves well to certain types of interactions. For example, traditional human-machine interaction paradigms can be difficult to achieve when the user wants to speak in a quiet place like a cinema during a performance. Furthermore, the traditional Windows Icon Menu Pointer (WIMP) GUI is tailored only to point-and-click interaction, leading to totally distinct, bifurcated interfaces for point-and-click and speech inputs.

However, the low friction human-machine interaction system can provide an interface which proactively infers one or more high-level goals of the user 235 from available context and dynamically adapts them accordingly for supporting continual, mixed real- and virtual-world artificial reality interactions. For example, the low friction human-machine interaction system can deliver high-level autonomous execution of goal optimal assistance by disambiguating the one or more high-level goals of the user 235. The low friction human-machine interaction system can reduce user friction to enhance high quality user experience and user safety. As another example, the low friction human-machine interaction system allows the user to operate at higher levels of abstraction than those designed by the application developer, or to access tailored action sequences that yield optimal performance toward the user's current goal. As a result, the low friction human-machine interaction system can provide a unified interface that supports contextually tailored, rich multimodal dialogues by seamlessly and intuitively transitioning across speech, gestural, and EMG-driven neural input modes and audio, visual, and haptic output modes.

In an embodiment, the multimodal input recognition component 210 can be activated by the user 235 via user initiated interaction 205 to collect onboard data, user data, population data, and world knowledge to infer what the user 235 intends to do at a high level of abstraction. For example, the multimodal input recognition component 210 can develop explicit-input recognition models, such as a model of intentions, that maximize realizable information transfer rate from human to machine across a broad range of contexts leveraging inputs across a spectrum of input bandwidths. As another example, the multimodal input recognition component 210 can use a variety of natural user inputs without requiring the user to learn specific commands or gestures obtained from various wearable sensor systems with varying hardware configurations and modalities, such as wristbands, artificial reality glasses, and peripheral sensors, etc. Thus, the multimodal input recognition component 210 can determine a universal multimodal representation space which is invariant to these factors by capturing the nuances of the various input data format with multiple modalities.

In an embodiment, the optimal query generation component 220 focuses on leveraging information theoretic, provably optimal, and contextually aware algorithms that identify the optimal query to generate at the current interaction state in order to minimize the context-dependent friction needed to disambiguate the user's goal. A traditional dialogue policy system, such as a canonical task-oriented dialogue system, is reactive rather than proactive. For example, the canonical task-oriented dialogue system asks questions to the user to facilitate slot filling rather than minimal frication value alignment. In particular, the canonical task-oriented dialogue system can not handle scenarios where the user has low input bandwidth. As another example, the canonical task-oriented dialogue system can terminate the interaction only when full value alignment has been achieved via complete slot filling. However, the optimal query generation component 220 can be activated by the user 235 via user initiated interaction 205 to apply a mathematical framework rooted in Bayesian optimal experimental design and models of situation perception based on a deep understanding of perceptual and cognitive processing to inform optimal interaction strategies that consider individual user capabilities and constraints and take into account the impact of overall contextual complexity. For a simple scenario of a fixed set of N goals and M queries with binary responses, the size of the state space can be determined by identifying a globally optimal query tree and solving a Markov Decision Process over the belief state space of N-dimensional categorical distributions S. The size of the state space is very large even based on equation 1 for a perfectly disambiguating likelihood and uniform prior. The optimal query generation component 220 can apply one or more optimal query generation algorithms 366, such as a greedy algorithm, to solve the solution for the large state of space of N-dimensional categorical distributions S with linear complexity in N and M. As a result, the optimal query generation component 220 can apply an MMI, such as a user-in-the-loop interaction that disambiguates the user's goal and desired AI agent policy, such as policy deployment data 374, while incurring minimal friction by (1) presenting the user with high expected-information-gain queries and (2) operating over contextually optimized I/O channels to ensure the MMIs are presented in a safe, non-intrusive manner. Thus, the combination can be optimized for minimal friction by using an improved communication and interaction interface between a human and a machine. The optimal query generation component 220 can leverage the output of goal inference, such as a probability distribution over the user's goals, to engage the user 235 in a proactive, multimodal, and contextually optimized dialogue that disambiguates the underlying goal with nearly zero friction which is defined as the cost to the user of the interaction, which can depend on myriad contextual and user-specific factors.

$$s ( q ) = {2}^{q} - 1 \qquad ( Eq . 1 )$$

where q is the number of queries and s is the size of the state space for the set of q queries.

In an embodiment, the multimodal human-machine dialogue component 230 represents the mediator between the user 235 and the low friction human-machine interaction of the artificial reality systems. The multimodal human-machine dialogue component 230 can communicate with the optimal query generation component 220 via proactive/system initiated interaction 215 to estimate the user cost and cognitive load in a given context, selects the optimal system output modalities based on the assessed cost, grounds user input in the given environment and context, and most importantly identifies what the user is paying attention to (e.g., focus on the physical or virtual aspects of the artificial reality world). Likewise, the multimodal human-machine dialogue component 230 provides the optimal query generation component 220 with recommendations for which output modality to select from to drive a safe and optimal multimodal output for the user 235. The multimodal human-machine dialogue component 230 further grounds the input of the user 235 in the present context to disambiguate the meaning as a response R(q) to the query q. These responsibilities are essential to ensure the safety of the user 235 and minimize the friction incurred by the user 235. As a result, the low friction human-machine interaction architecture 200 can generate a plurality of end-to-end multimodal input neural models that are capable of understanding the user's cognitive load and costs as well as selecting outputs that are safe, coherent, consistent, reliable, bias free, and have the most utility for the user 235. The multimodal human-machine dialogue component 230 can communicate with the user 235 via proactive/system initiated interaction 215 to assess the plurality of end-to-end multimodal input neural models.

Likewise, in FIG. 2B, the low friction human-machine interaction architecture 250 of the artificial reality systems provides a framework of AI agents for interaction with a user 235. The illustrated architecture 250 is another instance of the architecture 200 discussed above with respect to FIG. 2A.

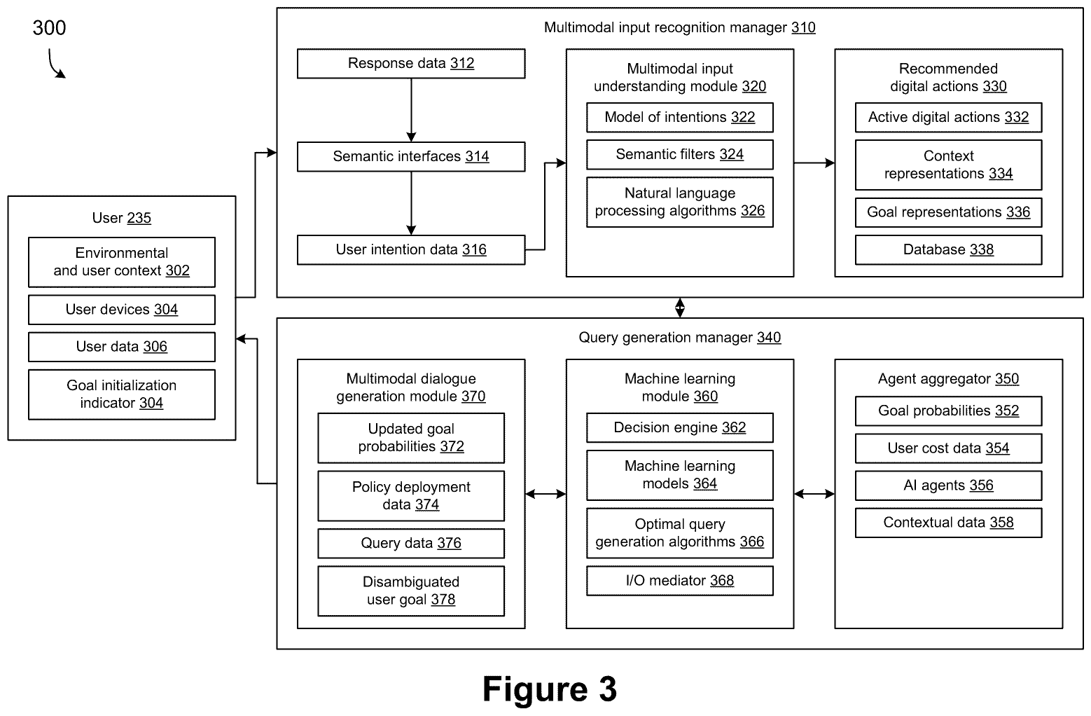

FIG. 3 illustrates an example goal disambiguation AI stage of the low friction human-machine interaction system 300 of the artificial reality systems. The low friction human-machine interaction system 300 can apply a framework of various artificial intelligent agents in a vast ecosystem to interact with the user 235 via user devices 304. The low friction human-machine interaction system 300 is programmed to include a multimodal input recognition manager 310 and a query generation manager 340. For example, the low friction human-machine interaction system 300 can apply user devices 304 to obtain user data 306 from the user 235 by using one or more wearable sensor systems with varying hardware configurations and modalities, such as wristbands, artificial reality glasses, EMG, Inertial Measurement Units (IMUs), camera, microphone, haptics, voice interface, and peripheral sensors, etc. As another example, the low friction human-machine interaction system 300 can apply user devices 304 to receive a goal initialization indicator 308 which indicates when/whether to initiate an MMI inner explicit loop of a goal disambiguation AI (GDAI) stage. The MMI inner explicit loop can receive (1) a distribution of goal probabilities 352 derived from an implicit outer loop of the GDAI stage, (2) contextual information 358, such as environmental and user context, and (3) explicit multimodal input from the user to disambiguate the user's goals. Using these inputs, the MMI inner explicit loop can apply the decision engine 362 to (1) decide when/whether to initiate an explicit loop using an initialization indicator, and if so, (2) identify queries which deliver disambiguated goal(s) with nearly zero friction dependent on the context. As a result, the MMI inner explicit loop can generate (1) contextually appropriate and safe multimodal outputs that optimally disambiguate the user's goal(s) and (2) a disambiguated goal that will seed a policy deployment AI (PDAI) stage and provides feedback to the outer loop of the GDAI stage. In particular, the goal initialization indicator 308 can be determined using a goal probability distribution, such as updated goal probabilities 372, an environmental and user context 302, and a model for setting feasible queries and history.

In an embodiment, the multimodal input recognition manager 310 is programmed to accurately recognize and interpret user input to convey the user's intention to the artificial reality systems. The low friction human-machine interaction system 300 firstly disambiguates the user's goal in the GDAI stage. Then the low friction human-machine interaction system 300 designs and implements a policy, such as policy deployment data 374, in PDAI stage to help the user 235 to achieve the user's goal based on the received semantic-based query. The low friction human-machine interaction system 300 executes an inner explicit loop to determine updated goal probabilities 372 within an outer implicit loop of the GDAI stage to determine a disambiguated goal 378 which aligns with the intentions of the user 235 for the PDAI stage. For example, when the user 325 initiates the use of the artificial reality systems and the goal initialization indicator 308 is set to launch the MMI explicit loop, the multimodal input recognition manager 310 can receive a semantic-based query, such as user data 306, from the user 235 and response data 312 from a plurality of on-board sensors. The semantic-based query includes a digital action associated with the intentions of the user or a plurality of user goals associated with the intentions of the user. The plurality of user goals are determined in open domain using a natural language processing algorithm 326 and the text descriptions of the plurality of user goals. Each of the plurality of user goals is associated with a corresponding text description. Likewise, the response data 312 can be measurements of the plurality of on-board sensors of the artificial reality systems, including wristbands, artificial reality glasses, EMG, IMUs, camera, microphone, haptics, voice interface, and peripheral sensors.

In an embodiment, the response data 312 includes 1) an explicit multimodal input, such as user data 306, from the user 235 which include the user's response R(q) to the machine's query q, 2) onboard data, such as updated goal probabilities 372, derived from the implicit outer loop that seeds the optimal query generation (OQG) algorithms 366, and (3) contextual information, such as environmental and user context 302, that allows MMI to ensure that the user 235 incurs minimal friction in any context. For example, the user's response R(q) can be a single, simple, intuitive one-bit response, such as a “click” driven on wristband devices. As a result, the multimodal input recognition manager 310 can leverage a diverse array of multiple on-board sensors to develop multimodal languages to be used by arbitrary combinations of wearable technology in any context. Likewise, the multimodal input recognition manager 310 can rapidly adapt to any new users, gestures, and hardware configurations on device to unlock robust and adaptable multimodal user input recognition to increase accessibility. In particular, the multimodal user input can be explicit low-bandwidth to high-bandwidth multimodal data from various devices. As another example, the multimodal user input can include a small vocabulary of gestural input recognized on wristband devices. The multimodal user input can focus on single bit input recognition on wristband devices through multimodal sensor fusion, such as IMU, EMG, and representation learning. The multimodal input recognition manager 310 can apply gesture personalization and learning on tethered wristband devices to improve model robustness in scenarios of missing or corrupt data from single sensors through learning input modality invariant representations. The multimodal input recognition manager 310 can use semantic and medium-bandwidth gestures on wristband devices through extended multimodal sensor fusion, such as IMU, EMG, vision, etc. Likewise, the multimodal input recognition manager 310 can recognize subtle multimodal expressions to understand nuanced user behavior in low-bandwidth scenarios by using robust sensor configuration independent multimodal input recognition for low- to high-bandwidth interactions leveraging a semantic multimodal embedding space based on one or more personalization of gesture recognition models.

In an embodiment, the multimodal input recognition manager 310 is programmed to apply one or more computer-implemented natural language processing (NLP) algorithms 326 to derive semantic meaning from the text descriptions associated with the plurality of user goals or to analyze the syntactic correctness of the text descriptions associated with the plurality of user goals. For example, the one or more computer-implemented natural NLP algorithms 326 can be used to remove non-alphabetical characters (e.g., periods and commas, stop words, and extra spaces) and determine a list of tokens (words) and bigrams in unstructured text data of the text descriptions associated with the plurality of user goals. In particular, the list of tokens can be reduced into their root forms by applying stemming and lemmatization. As another example, the one or more computer-implemented NLP algorithms 326 can use a Bag of Words model to formulate the unstructured text data of the text descriptions associated with the plurality of user goals as word vectors to derive semantics such as a classification of the plurality of user goals containing the text, the topics of the text, the meaning of the text or portions thereof, a sentiment of the text or portions thereof, an intent of the text or portions thereof, tone of the text, targeted tone of the text, or other semantics.

In a particular embodiment, the low friction human-machine interaction interfaces can be applied across a wide spectrum from low- to high-bandwidth interaction modes to disambiguate one or more goals of the user with minimal friction in any context. High-bandwidth interaction is often used in virtual reality and computational video because the rate at which humans and machines interact can increase substantially due to the changes in speed, computer graphics, new media, and new input/output devices. In order to improve the user experience, the low friction human-machine interaction can significantly extend user abilities far beyond present human capabilities and dramatically reduce barriers to access new capabilities by allowing the user to rapidly learn to interact with machines. The low friction human-machine interfaces can support a broad range of output prompts. These output prompts can be designed to accept and make optimal use of a wide range of bandwidths of user input that is appropriate across a broad range of contexts and levels of user expertise. The user can issue very high-bandwidth input, such as voice input. The user's explicit-input bandwidth is heavily restricted in many practical contexts. For example, in many “on the go” scenarios the user can issue both one or two bits of input, such as a pinch, head-nod, verbal affirmation, and high-bandwidth speech- or typing-based input. As another example, a user may not be able to perform EMG typing which uses sensors to detect and record electrical activity from the muscles and convert it into input information for the artificial reality systems. As a result, the low friction human-machine interaction interfaces can be applied to achieve maximal user alignment based on optimal realization of personal goals, nearly zero friction I/O in a real-world context, including contexts with limited explicit input bandwidth.

### User Interface Structural and Functional Overview

In an embodiment, the multimodal input recognition manager 310 is programmed to provide a plurality of user semantic interfaces 314, such as a semantic filter interface and a semantic connection interface, through which the low friction human-machine interaction system 300 can determine a plurality of recommended digital actions 330 by mapping the digital action associated with the intentions of the user in the semantic-based query to the plurality of recommended digital actions using a model of intentions 322. The model of intentions may be personalized to each individual user. Likewise, the model of intentions may be refined by the artificial reality systems over time based on the user's usage patterns. In particular, the multimodal input recognition manager 310 can apply the model of intentions to determine a vector representation of the digital action associated with the intentions of the user. Likewise, the multimodal input recognition manager 310 can apply the model of intentions to determine vector representations of digital actions of a training dataset. The training dataset can include various available digital actions stored in a database 338 from many different data sources, including prior use of the artificial reality systems for the user or other users, explicit training data, and/or linguistic models, etc. The multimodal input recognition manager 310 can determine an embedding of the vector representation of the digital action associated with the intentions of the user in a multi-dimensional embedding space and an embedding of the vector representations of the digital actions of the training dataset in the multi-dimensional embedding space. As a result, the multimodal input recognition manager 310 can identify one or more recommended digital actions based on, for each of the one or more recommended digital actions, a respective similarity of the embedding of the vector representation of the digital action associated with the intentions of the user to the embedding of the vector representations of the digital actions of the training dataset.

Furthermore, the multimodal input recognition manager 310 can determine a plurality of first active digital actions 332 associated with the intentions of the user using a semantic filter 324 and the plurality of first recommended digital actions 330. In particular, the multimodal input recognition manager 310 can apply the model of intentions 322 to allow the user 235 to interactively refine and disambiguate the recommended digital actions 330 via the semantic interfaces 314 using semantics-based filters 324 when the predicted recommended digital actions 330 are inaccurate or have a high level of uncertainty based on the intentions of the user 235. That is, the low friction human-machine interaction system 300 can understand the intentions of the user 235 and determine a plurality of first active digital actions 332 from a plurality of recommended digital actions 330 to perform interactive disambiguation of the user's intentions. For example, the multimodal input recognition manager 310 can take the form of taking actions on the behalf of the user 235. In particular, the multimodal input recognition manager 310 can present information or actions that the system could perform upon confirmation from the user 235 and provide user interfaces through which the user 235 can take actions to advance goals of the user. In particular, the digital actions or interfaces are used as part of the interaction between the user 235 and the digital actions or interfaces system 300 to disambiguate the intentions of the user 235. For example, a digital action like “Set an alarm for 7:00 am” can have associations with the concepts, such as “clock,” “alarm,” “wake up,” “morning,” etc. When the artificial reality systems are unclear about whether the user 235 is interested in setting an alarm or doing other digital actions related to a morning routine, one way to query the user 235 can be a prompt: “Are you interested in ‘morning’ actions? [Yes/No].”

In an embodiment, the multimodal input recognition manager 310 is programmed to determine a match between the intentions of the user, such as user intention data 316, and the plurality of first active digital actions, such as active digital actions 332, associated with the intentions of the user 235. In response to determining the match, the multimodal input recognition manager 310 can transmit the plurality of first active digital actions associated with the intentions of the user to the artificial reality systems to perform an operation based on the plurality of first active digital actions associated with the intentions of the user. In response to determining a mismatch, the multimodal input recognition manager 310 can determine a plurality of second active digital actions associated with the intentions of the user 235 using the semantic filters 324 and the recommended digital actions 330. In particular, the mismatch can occur when the plurality of first active digital actions 332 are incorrect or incomplete to meet the intentions of the user 235. For example, the user 235 can access the functionality, such as semantic filters 324, from the recommended digital actions 330 that the low friction human-machine interaction system can support to disambiguate the recommended digital actions 330 in order to achieve an accurate enough view of the user's goals. As another example, the multimodal input recognition manager 310 can dynamically generate different semantic interfaces 314 presented to the user 235 based on the user intention data 316 and the model of intentions 322. As a result, the multimodal input recognition manager 310 can provide optimal interface recommendations with a set of semantic-based query concept designs to the user 235.

In particular, the query generation manager 340 is programmed to apply decision engine 362 for goal inference and multimodal dialogue generation. The step of goal inference may map multiple observations of the artificial reality systems to a probability distribution, such as goal probabilities 352, over the user's goals at different levels of abstraction at the current moment in time. The observations of the artificial reality systems can include contextual data gleaned from contextual data 358, the status of the artificial reality systems, and various global sources of knowledge. The overarching objective of goal inference is to learn individual users' personalized mappings from observations to goals with as little user-specific data as possible and with the greatest levels of confidence possible in order to enable user goal achievement and minimize user friction. For example, the query generation manager 340 can apply the decision engine 362 to determine high-confidence, low-entropy predictions of machine's queries using minimal additional information to disambiguate the user's goals. In particular, the decision engine 362 is coupled to a first knowledge base which includes goal inference engine API, query-generation rules, and safety rules. In particular, the goal inference engine API includes standards for semantic metadata, safety standards (goal editability and interpretability). The query-generation rules include algorithms for generating the plurality of machine's queries that enable disambiguating all supported goals. The safety rules includes processes for editability and interpretability for safety.

### Contextual Representation Structural and Functional Overview

In an embodiment, the query generation manager 340 can apply goal inference using context representation, goal-policy learning, and fair policy learning. For example, the query generation manager 340 can apply the goal-policy learning to learn the mapping from the system's observations, such as contextual data gleaned from contextual data 358 and environmental and user context 302 to a probability distribution, such as goal probabilities 352, over the user's goals at different levels of abstraction at a current moment in time. As another example, the query generation manager 340 can apply the fair policy learning to ensure fairness, and unbiasedness in the personalized goal policies that are learned. In particular, the goal of the fair policy learning is to ensure that goal policies are invariant to discriminatory factors among protected groups of the population.

In an embodiment, the query generation manager 340 is programmed to determine contextual representations 334 associated with the response data 312 using a first machine learning model 364 and the response data 312 from the plurality of on-board sensors, such as user devices 304. In particular, the context representation can include 1) virtual/physical world context, 2) allocentric user context, 3) egocentric user context, and 4) internal user context. The virtual/physical world context can characterize the state of the virtual/physical world and any associated exploitable structure, such as map of physical environment with objects and states, Knowledge Graph, social graph, contextual data 358, and the status of the artificial reality systems. The allocentric user context can localize the user in virtual/physical world context, such as localization in physical or virtual environments, identify relevant Knowledge-Graph concept, and deduce relevant social subgraphs. The egocentric user context can allow the system to recover the user's sensory signals firsthand, including seeing what the user sees via eye tracking registered with egocentric video, hearing what the user hears via spatialized audio, and feeling what the user feels via wristbands (or gloves) with touch sensing and/or EMG sensing. The internal user context can represent features characterizing the user's biophysical, cognitive, affective, and emotive state which will likely be driven by wrist-based biosensing. These contextual elements provide important factors for goal inference to disambiguate the intentions of the user. For example, the virtual/physical world context and the allocentric user context are essential when the user's location and virtual/physical surroundings have high mutual information of the user's behavior, such as “Navigate to a destination” after entering a car. The egocentric user context is essential to capture when the user's raw sensory inputs drive the goals of the user, such as “Reduce noise” when the room is loud. The internal user context is relevant when the user's cognitive, affective, or emotive state motivate the user's behavior, such as “Reduce stress levels” when the user is experiencing anxiety. The role of context representation for goal inference is to aggregate all sources of context that are relevant for predicting the user goal at each moment in time.

In an embodiment, the query generation manager 340 is programmed to determine goal representations 336 associated with the plurality of user goals associated with the intentions of the user, such user intention data 316, using a second machine learning model 364 and the text descriptions of the plurality of user goals. For each of the plurality of user goals, the query generation manager 340 can determine a respective goal representation of a user goal using the corresponding text description associated with the user goal. Likewise, for each of the goal representations, the query generation manager 340 can determine a respective goal description of a goal representation using the corresponding goal representation. The query generation manager 340 can apply goal-policy learning using a third machine learning model 364 and policy deployment data 374 to map the context representation to a probability distribution, such as goal probabilities 352, over the plurality of user goals at each moment in time using both context representations 334 associated with the response data 312 and the goal representations 336 associated with the user intention data 316. The query generation manager 340 can apply the third machine learning model 364 to determine vector representations associated with the response data 312 using the context representations 334 associated with the response data 312. The query generation manager 340 can apply the third machine learning model 364 to determine an embedding of the vector representations associated with the response data 312 in a multi-dimensional embedding space based on a combination of the vector representations associated with the response data 312. Likewise, the query generation manager 340 can apply the third machine learning model 364 to determine vector representations associated with the plurality of user goals using the goal representations 336 associated with the plurality of user goals. The query generation manager 340 can apply the third machine learning model 364 to determine embeddings of the vector representations associated with the plurality of user goals in the multi-dimensional embedding space based on the vector representations associated with the plurality of user goals. As a result, the query generation manager 340 can apply the third machine learning model 364 to determine the probability distribution for the plurality of user goals, such as goal probabilities 352, using the embedding of the vector representations associated with the response data 312 and the embeddings of the vector representations associated with the plurality of user goals. The query generation manager 340 can apply the third machine learning model 364 to determine a similarity score between two user goals of the plurality of user goals using the goal representations 336 associated with the two user goals. The query generation manager 340 can organize the plurality of user goals based on the similarity scores associated with the plurality of user goals.

Furthermore, the third machine learning model 364 can be based on inverse behavioral modeling, such as inverse reinforcement learning, and supervisory methods, such as recommender systems. For example, the inverse reinforcement learning is best suited to cases when the behavior of the user 235 is associated with the solution to an optimization problem. As another example, the inverse behavioral modeling is best suited for cases where data corresponding to context-goal pairs are available. As a result, the third machine learning model 364 can be applied to proactively decide when/whether to initiate interaction, identify a sequence of machine's queries which deliver disambiguated goals with minimal friction, and enable the user to terminate the interaction early. Because the low friction human-machine interaction system 300 can bind user goals to deployable AI agents 356 and aggregations of those agents, and the user 235 can deploy those AI agents 356 as a part of the natural device usage. Thus, the low friction human-machine interaction system 300 can have access to such labels and thus can apply supervisory methods to goal-policy learning. Furthermore, the goal-policy learning requires robustness to nonstationary user behavior to support an ever-evolving roster of supported goals and AI agents. As a result, the query generation manager 340 can apply goal-policy learning to ensure that goal policies are invariant to discriminatory factors among protected groups of the population.

### Goal Disambiguation Structural and Functional Overview

In an embodiment, the query generation manager 340 is programmed to determine updated goal probabilities 372 using a goal inference engine, such as decision engine 362. The input parameters include relevant contextual data x gleaned from contextual information 358, the status of the artificial reality systems, and various global sources of knowledge, such as goal probabilities 352, user cost data 354, and active digital actions 332. The query generation manager 340 can assess minimal context information, such as time of day, medium-grained location, and calendar, from contextual information 358 to perform inference. The goal probabilities 352 indicate a prior probability distribution P[Y|X=x] associated with an action Y of the artificial reality systems characterizing the user's underlying policy that is optimal with respect to the intentions of the user, such as the active digital actions 332, before engaging the user 235. The low friction human-machine interaction system 300 can apply the decision engine 362 to determine a user friction value, such as user cost data 354, and a conditional probability distribution P[R(q)=j|X=x], such as updated goal probabilities 372, using a greedy optimal ultra-low-friction interface algorithm based on equation 2. Based on the updated goal probabilities 372, the query generation manager 340 can generate a plurality of machine's queries including a plan of digital actions, such as query data 376, tailored to the current context, aimed at rapidly and efficiently disambiguating the user's goal at the highest level of abstraction possible. For example, when the machine's queries are perfectly disambiguating, the prior probability distribution and the conditional probability distribution can be simply described based on equation 3 and equation 4, respectively.

$$P [ R ( q ) = j \vert X = x ] = {\sum }_{y} P [ R ( q ) = j \vert X = x , Y = y ] P [ Y = y \vert X = x ] \qquad ( Eq . 2 )$$

$$P [ R ( q ) = j \vert X = x , Y = y ] = \{ \begin{matrix}1 , & y ∈ {D}_{j} ( q ) \\ 0 , & otherwise\end{matrix} \qquad ( Eq . 3 )$$

$$P [ R ( q ) = j \vert X = x ] = {\sum }_{y} P [ Y = k \vert X = x ] \qquad ( Eq . 4 )$$

where R(q) is the user's response to the machine's query q, P[R(q)=j|X=x] is the conditional probability distribution for the j-th user's response to query q given the artificial reality systems context X, P[Y=y|X=x] is the prior probability distribution associated with an action Y of the artificial reality systems, Dⱼ(q) is the digital actions available in the artificial reality systems.

Furthermore, the query generation manager 340 is programmed to determine a plurality of machine's context-optimal query, such as query data 376, by solving a greedy-optimal low-friction interface problem. The greedy-optimal ultra-low-friction interface problem is formulated by selecting the machine's context-optimal query that minimizes user friction, such as user cost data 354, via maximization of the net information gain of the query in the current context based on equation 5. The net information gain E(R(q)=j|X=x) is defined as the relative entropy using the prior probability distribution P[Y=y|X=x] and the posterior probability distribution P[Y=y|X=x, R(q)=j] based on equation 7. In particular, the posterior probability distribution P[Y=y|X=x, R(q)=j] can be determined by applying Bayes' theorem using the prior probability distribution P[Y=y|X=x] based on equation 6. The user cost data 354 can be a learned function of myriad features, including the user's familiarity with the command modality, user expertise level, the environmental context, cognitive load, etc. For example, the user friction can be the entropy of the probability distribution which provides a theoretical lower bound on the number of input bits needed to fully disambiguate the user's goal. As another example, the user friction can be quantified by the total expected number of explicit-input bits. The decision engine 362 can include an objective based on equation 5 and equation 6 to determine a disambiguated user goal 378 at a high level of abstraction. In particular, the decision engine 362 includes an objective to minimize the user friction by maximizing a net information gain E(R(q)=j|X=x) of the plan of digital actions in current context. The net information gain E(R(q)=j|X=x) can be determined by subtracting an information cost from an information gain of the plan of digital actions. When the user friction is below a predetermined threshold, the query generation manager 340 can terminate an interaction session with the artificial reality device and determine a goal value alignment by a survey conducted by the user after terminating the interaction session with the artificial reality device based on the intention of the user. The query generation manager 340 can generate a pareto front of the goal value alignment vs the user friction for display on a user interface. In particular, the query generation manager 340 can determine an initialization indicator based on the pareto front of the goal value alignment vs the user friction.

$${q}^{*} = argmax {\sum }_{j} ( P [ R ( q ) = j \vert X = x ] [ {\sum }_{j} P [ Y = y \vert X = x , R ( q ) = j ] {log}_{2} ( P [ Y = y \vert X = x , R ( q ) = j ] ) - {log}_{2} ( s ( q ) ) \qquad ( Eq . 5 )$$

$$P [ Y = y \vert X = x , R ( q ) = j ] = \frac{P [ R ( q ) = j \vert X = x , Y = y ] P [ Y = y \vert X = x ]}{P [ R ( q ) = j \vert X = x ]} \qquad ( Eq . 6 )$$

$$E ( R ( q ) = j \vert X = x ) = {\sum }_{y} P [ Y = y \vert X = x , R ( q ) = j ] {log}_{2} ( P [ Y = y \vert X = x , R ( q ) = j ) \qquad ( Eq . 7 )$$

where q* is the machine's context-optimal query, R(q) is the user's response to the machine's query q, P[R(q)=j|X=x] is the conditional probability distribution for the j-th user response to query q given the artificial reality systems action Y and context X, P[Y=y|X=x] is the prior probability distribution associated with an action Y of the artificial reality systems, P[Y=y|X=x, R(q)=j] is the posterior probability distribution for the artificial reality systems action Y given the j-th user response to query q and context X, s (q) is user cost to query q, and E(R(q)=j|X=x) is relative entropy for the j-th user response to query q given the artificial reality systems action Y and context X.

In an embodiment, the query generation manager 340 can use an agent aggregator 350 to map the disambiguated user goal 378 to a policy which includes the plan of digital actions, each of the plan of digital actions associated with an available AI agent 356 or an aggregation of AI agents 356. The query generation manager 340 can deploy the resulting AI agents 356 accordingly to achieve one or more goals associated with the intentions of the user. The query generation manager 340 can determine an agent aggregator 350 by mapping current context of the plan of digital actions to a plurality of AI agent aggregations of task representations which include task state, task constraints, and task rewards. For example, the agent aggregator 350 can activate a low-level AI agent 356 that deploys a single action primitive, such as “send message,” etc. As another example, the agent aggregator 350 can generate higher-level AI agents 356 by combining and coordinating multiple lower-level ones for an assembly of AI agents to provide the mechanism for generating AI agents 356 at coarser levels of abstraction that can unlock greater levels of autonomous execution. In particular, the agent aggregator 350 can be coupled to a second knowledge base which includes an agent aggregator API, a task representation library, representation-generation rules, aggregation rules, and safety rules. Specifically, the agent aggregator API provides standards for task representation that are necessary for rational aggregation in order to facilitate pattern-based aggregation. The agent aggregator API also provides protocols for prescribing metadata needed for interpretability of aggregations that include a particular AI agent, as well as standards for information needed to reason about safe deployment. In addition, the second knowledge base can track and keep up-to-date an ever-growing library of task representations that define different families of goals and facilitate authoring AI agents that optimize toward different goals within that family. The second knowledge base prescribes rules for admissible authored and automated aggregation, as well as rules for determining AI agent deployment safety.

In an embodiment, because higher-level AI agents 356 have a strong ability to reduce user friction due to their greater information-theoretic value, the query generation manager 340 can select a high-level AI agent to trigger the deployment of a large number of action primitives. Thus, it allows an AI agent to be modularized and aggregated with other AI agents to the greatest degree possible. The query generation manager 340 can synthesize capabilities across AI agents 356 in service of user goals using all available system observations, all historical data of individual-user behavior, preferences, and goals. In particular, the query generation manager 340 can understand the capabilities of all available AI agents 356 in an interpretable manner, such that the user 235 can effectively interact with the AI agents 356 to achieve the intentions of the user.

In an embodiment, the agent aggregator 350 consists of three components: authored aggregation, automated aggregation, and safe AI agent deployment. The authored aggregation can apply AI agents 356 that operate at higher levels of abstraction and share those creations for others to build upon. The authored aggregation can uncover various emergent phenomena obtained by combining lower-level capabilities into higher-level ones, unlocking previously unforeseen user experiences and unanticipated user value. The automated aggregation can include pattern-based aggregation and rational aggregation. In pattern-based aggregation, the agent aggregator 350 can either mine individual-user data or population-level user data to determine which sequences of AI agents 356 are often deployed in certain contexts. The automated aggregation will accelerate the shift toward users operating at higher and higher levels of abstraction based purely on users' patterns of device usage. In rational aggregation, the agent aggregator 350 can exploit common task representations shared across AI agents 356 that operate within the same task family (e.g., object rearrangement) to define a higher level, composited user goal (e.g., prepare four recipes and clean up the kitchen) in formal mathematical terms. The rational aggregation can allow novel, higher level goals to be assembled in a precise way, and action primitives native to different aggregated AI agents 356 to be interlaced and pipelined. As a result, the agent aggregator 350 can deliver provably optimal performance toward novel and higher-level user goals by using careful prescription of the task representations within well-defined goal families to ensure rigorous composability. In particular, the agent aggregator 350 can ensure these automated aggregations are interpretable, which can be made possible by metadata that can be exposed to the agent aggregator API. The safe AI agent deployment can determine which AI agents and aggregations thereof can be deployed safely in the current context. It is desired that the AI agents 356 are equipped with multiple I/O modality options such that the best modes can be set by an I/O mediator for the current context. However, it is challenging to deploy an AI agent regardless of the specific I/O modality due to safety considerations. For example, a conversational AI agent that requires the user to deploy significant cognitive attention to the interaction (e.g., a trivia bot), should not be deployed in cases where the user's concentration cannot be compromised (e.g., crossing a busy intersection). The safe AI agent deployment will apply rules for such safe deployment, and will gate all AI agents 356 through the resulting filter.

In an embodiment, the query generation manager 340 can use an I/O mediator 368 to generate contextually appropriate I/O channels of the artificial reality systems for both the multimodal dialogue of the goal inference engine and the AI agents in order to ensure the dialogue is optimized for both the user experience and safety in the current context. The query generation manager 340 can determine the I/O mediator 368 to appropriately tailor the current context and promote consistency of a plurality of modalities across multiple deployments of an AI agent. Likewise, the query generation manager 340 can use the I/O mediator 368 to determine a user experience quality value associated with contextual appropriateness and consistency based on the plan of digital actions. For example, the query generation manager 340 can use context-adaptive interactions to define a set of admissible I/O modalities that can be leveraged in the current context by the multimodal dialogue generation module 370 underpinning the multimodal understanding module 320, agent aggregator 350, and machine learning module 360. In particular, the query generation manager 340 aims to set these I/O channels to promote the user experience, i.e., defining I/O channels that are contextually appropriate, intuitive for the present interaction, and promote experiential consistency across deployments of the same capability. Of course, the appropriateness of specific I/O channels and the effective bandwidth afforded by those channels depends on a wide range of variables, including contextual factors, user capabilities and expertise level, and the nature of the interaction itself. The query generation manager 340 can learn appropriate mappings from these variables to achieve several goals: 1) optimized available I/O channels and forms to maximize user value alignment 2) optimal realization of personal goals and zero time to learn, and 3) minimal user incurred friction with nearly zero friction and maximal human expressiveness. Furthermore, the query generation manager 340 can apply safe interactions for admissible I/O channels for the current context through a safety lens. In In particular, not only the I/O channels themselves, but also the specific way in which those I/O channels manifest themselves to the user 235 are critical for safety. For example, a visual cue cannot impede the driver's awareness of their physical surroundings while driving is admissible in the periphery or as an overlay on the dashboard, but. the query generation manager 340 can define I/O channels, as well as details around their deployment, to ensure user safety in the current context. In particular, the multimodal dialogue generation module 370 is coupled to a third knowledge base which includes an I/O mediator API, a system-supported I/O channels, contextual I/O rules, and safety rules. Specifically, the I/O Mediator API defines standards for the I/O specification for contextual fit and safety standards for I/O activation safety. The third knowledge base also keeps an up-to-date, personalized inventory of system-supported I/O channels, the languages and alphabet associated with those channels, and the user's current comfort/familiarity with each of those channels. Furthermore, the contextual I/O rules and safety I/O rules define available mappings from contextual features to I/O channels and styles of deployment that promote a strong user experience and safety, respectively.

In an embodiment, the multimodal dialogue generation module 370 is programmed to generate a bespoke multimodal dialogue tailored to the current context for rapidly and efficiently disambiguating the user's goal at the highest level of abstraction possible. the multimodal dialogue generation module 370 can apply the decision engine 362 and the agent aggregator 350 to generate a dialogue to minimize expected number of explicit input commands needed to disambiguate the intention of the user. Thus, multimodal dialogue generation module 370 can primarily minimize user friction of the low friction human-machine interaction architecture 200. In particular, the multimodal dialogue generation module 370 includes three key components to multimodal dialogue generation: optimal query generation, explainable recommendations, and explainable AI agent deployment. The optimal query generation comprises the algorithmic backbone for computing the sequence of interfaces that minimizes the expected number of explicit input commands needed for the goal inference engine to converge on the user's true underlying goal. Beginning with the probability distribution over goals provided by goal inference, the algorithm presents a query to the user 235 in the form of a UI element to which the user 235 responds. This response allows the goal inference engine to update the distribution, such as updated goal probabilities 372, over the user's goal, such as user intention data 316. The selected query at each of these iterations corresponds to the one yielding maximum expected information gain from the plurality of admissible machine's queries. However, because the user's goals are defined at different levels of abstraction, and each goal is equipped with a different information theoretic value associated with the number of action primitives its associated AI agent 356 can deploy autonomously. Thus, the optimal query generation algorithms 366 can incentivize disambiguating higher-level goals and provide a mechanism to drive down user friction. In particular, the machine's query output, such as query data 376, and the associated user response input, such as response data 312, can involve different modalities. These modalities can change between the plurality of admissible machine's queries. The ability of a given machine's query to reduce user friction, such as its expected information gain, is determined by the expressiveness of both the machine's query and response sets. These modalities can be determined in collaboration with the I/O mediator 368.

In an embodiment, the multimodal dialogue generation module 370 can generate the query data 376 as explainable recommendations to the user 235. The query data can essentially suggest specific AI agents or actions to take at the current moment in time. To build trust between the human and machine and promote a greater level of symbiosis, the multimodal dialogue generation module 370 can apply one or more machine learning models 364, such as decision trees, to generate the query data 376 which are interpretable using interpretable input contextual features. Likewise, the user 235 can interactively communicate with the multimodal dialogue generation module 370 to provide feedback to the machine that the contextual features are incorrect or incomplete.

In an embodiment, the multimodal dialogue generation module 370 can apply explainable AI agent deployment to make sure the user 235 is fully aware of the consequences of optimizing toward the articulated goals. In particular, the multimodal dialogue generation module 370 can present to the user in various multimodal output formats that the anticipated outcome of declaring that particular goal in terms of the sequence of deployed action primitives and anticipated effects that deployment will have on the user 235, the physical environment, the virtual environment, and other users when it converges on the user's goal with higher levels of confidence.

In particular embodiments, one or more of the content objects of the low friction human-machine interaction system 300 of the artificial reality systems may be associated with a privacy setting. The privacy settings (or “access settings”) for an object, such as the response data 312 of the user 235, may be stored in any suitable manner, such as, for example, in association with the object, in the multimodal input recognition manager 310 and query generation manager 340, in another suitable manner, or any combination thereof. A privacy setting of an object may specify how the object (or particular information associated with an object) can be accessed (e.g., viewed or shared) using the low friction human-machine interaction system 300 of the artificial reality systems. Where the privacy settings for an object allow a particular user to access that object, the object may be described as being “visible” with respect to that user. As an example and not by way of limitation, a user of the low friction human-machine interaction system 300 of the artificial reality systems may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access the response data 312 associated with the user 235, thus excluding those users from accessing the response data 312 associated with the user 235 (while also possibly allowing certain users not within the set of users to access the response data 312 associated with the user 235). In particular embodiments, privacy settings may be associated with particular response data 312 associated with the user 235. Privacy settings of the response data 312 associated with the user 235 may specify how the response data 312, information associated with the response data 312, or content objects associated with the response data 312 can be accessed using the low friction human-machine interaction system 300 of the artificial reality systems. As an example and not by way of limitation, the multimodal input recognition manager 310 and the query generation manager 340 corresponding to a particular response data 312 associated with the user 312 may have a privacy setting specifying that the periocular response data 312 may only be accessed by the user 235 in the particular response data 312. In particular embodiments, privacy settings may allow users to opt in or opt out of having their actions logged by the low friction human-machine interaction system 300 of the artificial reality systems. In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of the artificial reality systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, the multimodal input recognition manager 310 and the query generation manager 340 may be authorization/privacy servers for enforcing privacy settings. In response to a request from the user 235 (or other entity) for a particular object stored in a database 338, the low friction human-machine interaction system 300 of the artificial reality systems may send a request to the database 338 for the object. The request may identify the user 235 associated with the request and may only be sent to the user 235 if the authorization server determines that the user 235 is authorized to access the object based on the privacy settings associated with the object. If the requesting user 235 is not authorized to access the object, the authorization server may prevent the requested object from being retrieved from the database 338, or may prevent the requested object from being sent to the user 235. In the search query context, an object may only be generated as a search result if the querying user 235 is authorized to access the object. In other words, the object must have a visibility that is visible to the querying user 235. If the object has a visibility that is not visible to the user 235, the object may be excluded from the search results. Although this disclosure describes enforcing privacy settings in a particular manner, this disclosure contemplates enforcing privacy settings in any suitable manner.

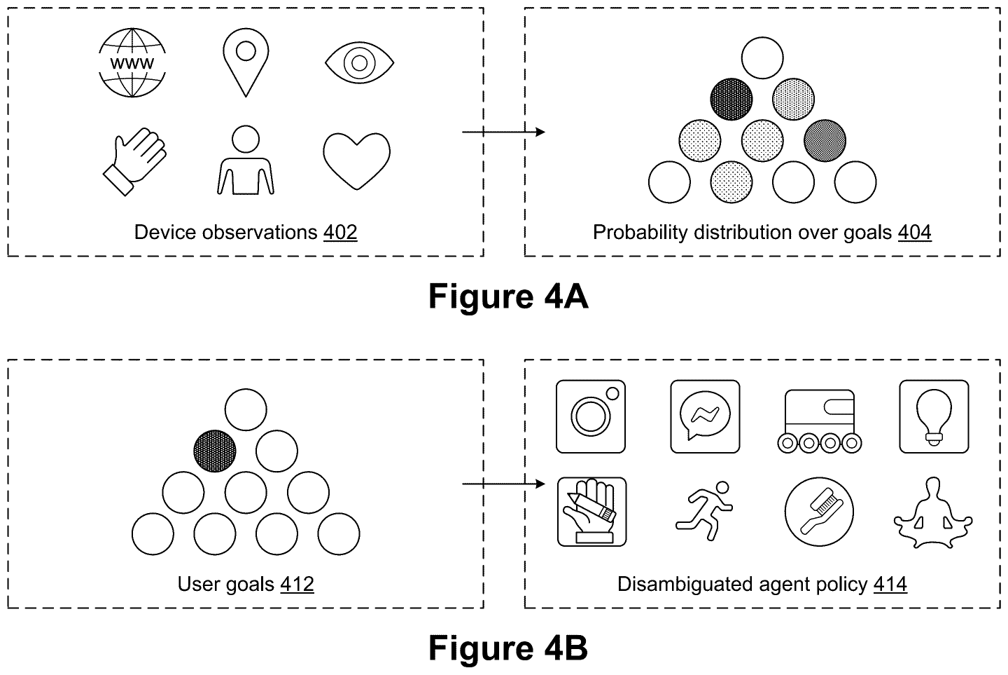

FIG. 4A illustrates an example goal inference to enable proactivity of the low friction human-machine interaction system. The query generation manager 340 can be applied to achieve proactivity of the low friction human-machine interaction system 300 by mapping a plurality of device observations 402 to a probability distribution over goals 404 at each moment in time. The plurality of device observations 402 can be determined from multiple sources of contextual data from various sensors, such as wristbands, artificial reality glasses, EMG, IMU, camera, microphone, haptics, voice interface, and peripheral sensors, etc. The probability distribution over goals 404 can enable the machine to proactively present the user 235 with optimized interfaces that minimize the expected interaction effort needed to fully disambiguate the true underlying goal of the user 235. In particular, the query generation manager 340 can determine updated goal probabilities 372 using the decision engine 362 based on a dual-encoder architecture and relevant time series of device observations 402 to the human's goal expressed in natural language.

FIG. 4B illustrates an example goal interpretation to enable goal orientedness of the low friction human-machine interaction system. The query generation manager 340 can be applied to achieve goal orientedness of the low friction human-machine interaction system 300 using MMI. Specifically, the query generation manager 340 can map a high-level user goal 412 to a disambiguated policy 414 associated with the high-level user goal 412. The user goal 412 can be determined from the probability distribution over goals 404 in a user-in-the-loop interaction that disambiguates the user goal 412 and the disambiguated agent policy 414. The disambiguated agent policy 414 includes at least one candidate instruction list of actions that can realize the user goal 412 using AI agents in the low friction human-machine interaction system 300. In particular, the query generation manager 340 can transmit the policy to the policy deployment data 374 for generating dialog interfaces to be presented to the user 235. For example, the goal 412 can include a goal hierarchy which allows the goal 412 to be decomposed into instructions, plans, or policies composed of subgoals that can themselves be further decomposed recursively. Specifically, the goal 412 can be represented by a goal hierarchy with circle opacity representing probability mass. Each goal may have a structure that is simple or complex. A simple goal can be decomposed into a list of sub-goals. Likewise, a complex goal can be decomposed into a Markov decision process with an observation space, action space, dynamics model, and reward function. In order to achieve the policy 414, the query generation manager 340 can use an affordance encoder to work on one or more device's actions, such as application functionality, that can contribute to goal realization for the user 235. As a result, the query generation manager 340 can help the user 235 to achieve high-level, affordance-agnostic goals which minimizes the human's cognitive planning effort and the need to acquire expert device-specific knowledge.

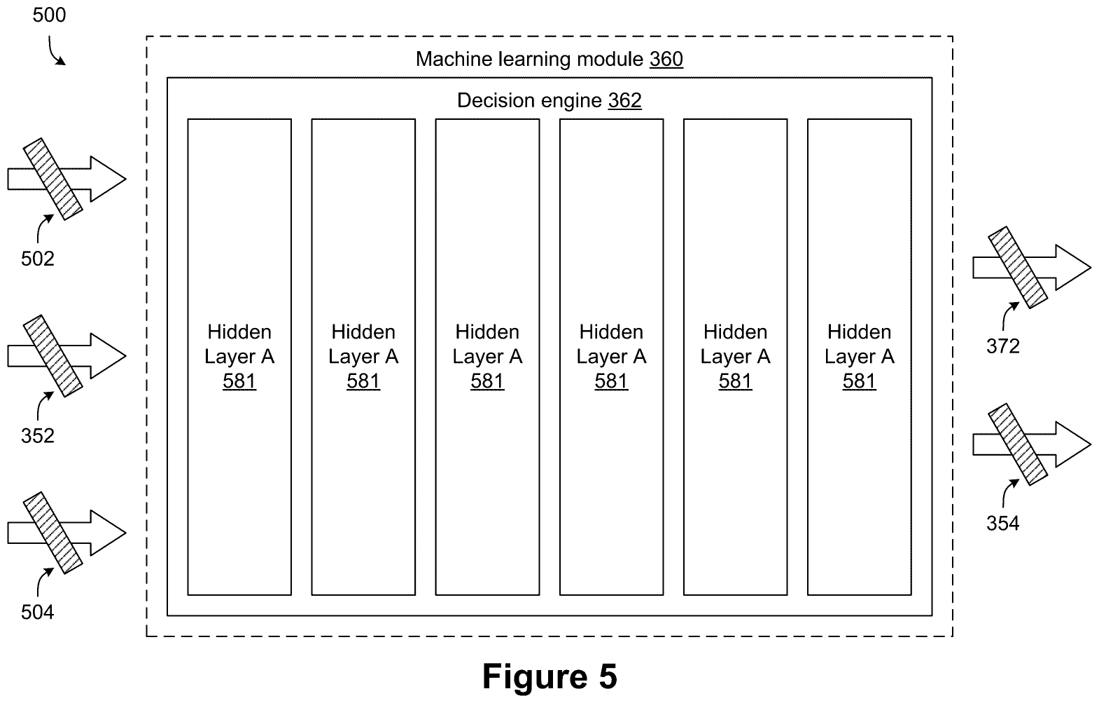

FIG. 5 illustrates an example neural network 500 of the artificial reality systems to update goal probabilities 372 and user cost 354. The neural network 500 may include one or more machine learning models, such as a decision engine 362, a feedforward neural network, a Bayesian analysis algorithm, a convolutional neural network, and a long short-term memory. The input parameters may include digital actions data 502, goal probabilities 352, and user goals data 504. For example, the digital actions data 502 may include a plurality of digital actions determined from the response data 312 of the artificial reality systems. The low friction human-machine interaction system 300 may determine a respective probability value associated each of the plurality of digital actions from a hard-coding value or a value learned from prior experience of the artificial reality systems. The goal probabilities 352 may include a plurality of goal probabilities values associated with the plurality of digital actions in the digital actions data 502. In particular, the goal probabilities 352 may be determined from the response data 312 based on the interaction between the user and the artificial reality systems. The user goals data 504 may a plurality of user goals associated with the low friction human-machine interaction system 300. The low friction human-machine interaction system 300 may determine a respective probability value associated each of the plurality of user goals from prior experience of the artificial reality systems. The neural network 500 may include six hidden layers, such as hidden layer A 581, hidden layer B 582, hidden layer C 583, hidden layer D 584, hidden layer E 585, hidden layer F 586, which may be a convolutional layer, a pooling layer, a rectified linear unit (ReLU) layer, a softmax layer, a regressor layer, a dropout layer, and/or various other hidden layer types. In particular embodiments, the number of hidden layers may be greater than or less than six. These hidden layers can be arranged in any order as long as they satisfy the input/output size criteria. Each layer comprises of a set number of image filters. The output of filters from each layer is stacked together in the third dimension. This filter response stack then serves as the input to the next layer(s). Each hidden layer may be featured by 20 neurons or any appropriate number of neurons.

In particular embodiments, the hidden layers are configured as follows. The hidden layer A 581 and the hidden layer B 582 may be down-sampling blocks to extract high-level features from the input data set. The hidden layer D 584 and the hidden layer E 585 may be up-sampling blocks to output the classified or predicted output data set. The hidden layer C 583 may perform residual stacking as bottleneck between down-sampling blocks (e.g., hidden layer A 581, hidden layer B 582) and up-sampling blocks (e.g., hidden layer D 584, hidden layer E 585). The hidden layer F 586 may include a softmax layer or a regressor layer to classify or predict a predetermined class or a value based on input attributes.

In a convolutional layer, the input data set is convolved with a set of learned filters that are designed to highlight specific characteristics of the input data set. A pooling layer produces a scaled down version of the output by considering small neighborhood regions and applying a desired operation filter (e.g. min, max, mean, etc.) across the neighborhood. A ReLU layer enhances a nonlinear property of the network by introducing a non-saturating activation function. One example of such a non-saturating function is to threshold out negative responses (i.e., set negative values to zero). A fully connected layer provides a high-level reasoning by connecting each node in the layer to all activation nodes in the previous layer. A softmax layer maps the inputs from the previous layer into a value between 0 and 1 or between −1 and 1. Therefore, a softmax layer allows for interpreting the outputs as probabilities and selection of classified facie with highest probability. In particular embodiments, a softmax layer may apply a symmetric sigmoid transfer function to each element of the raw outputs independently to interpret the outputs as probabilities in the range of values between −1 and 1. A dropout layer offers a regularization technique for reducing network over-fitting on the training data by dropping out individual nodes with a certain probability. A loss layer (e.g., utilized in training) defines a weight dependent cost function that needs to be optimized (i.e., bring the cost down toward zero) for improved accuracy. In particular embodiments, each hidden layer is a combination of a convolutional layer, a pooling layer, and a ReLU layer in a multilayer architecture. As example and not by way of limitation, each hidden has a convolutional layer, a pooling layer, and a ReLU layer.

In particular embodiments, the neural network 500 may include an activation function in a ReLU layer (e.g., hidden layer F 586) to calculate the misfit function based on the difference between the predicted friction value and a ground truth (e.g., a value of “0”). In particular embodiments, the neural network 500 may use a simple data split technique to separate the input data, such as digital actions data 502, goal probabilities 352, and user goals data 504, used for the training, validation, and testing of the physics constrained machine learning models. As example and not by way of limitation, the data split technique may consider 70% of the input data for model training (e.g., tuning of the model parameters), 15% of the obtained input data for validation (e.g., performance validation for each different set of model parameters), and 15% of the obtained input data for testing the final trained model. However, the data split technique may be appropriately adjusted (e.g., by the user) to prevent over-fitting that results in the neural network 50 with limited generalization capabilities (e.g., models that underperform when predicting unseen sample data).

Furthermore, the neural network 500 may apply a nested k-fold inner/outer cross-validation to tune and validate the optimal parameters of the model. In one or more embodiments, the nested stratified inner/outer cross-validation may be a software and/or hardware system that includes functionality to mitigate the over-fitting problem of the model by applying a k-fold inner cross-validation and a k-fold outer cross-validation. The k-fold inner cross-validation and the k-fold outer cross-validation may have different values of the “k” parameter. In some example embodiments, the nested inner/outer cross-validation defines one or more physics constrained machine learning algorithms and their corresponding models in a grid and evaluates one or more performance metrics of interest (e.g., area under curve (AUC), accuracy, geometric mean, f1 score, mean absolute error, mean squared error, sensitivity, specificity, etc.) to find the optimal parameters of the neural network 500.

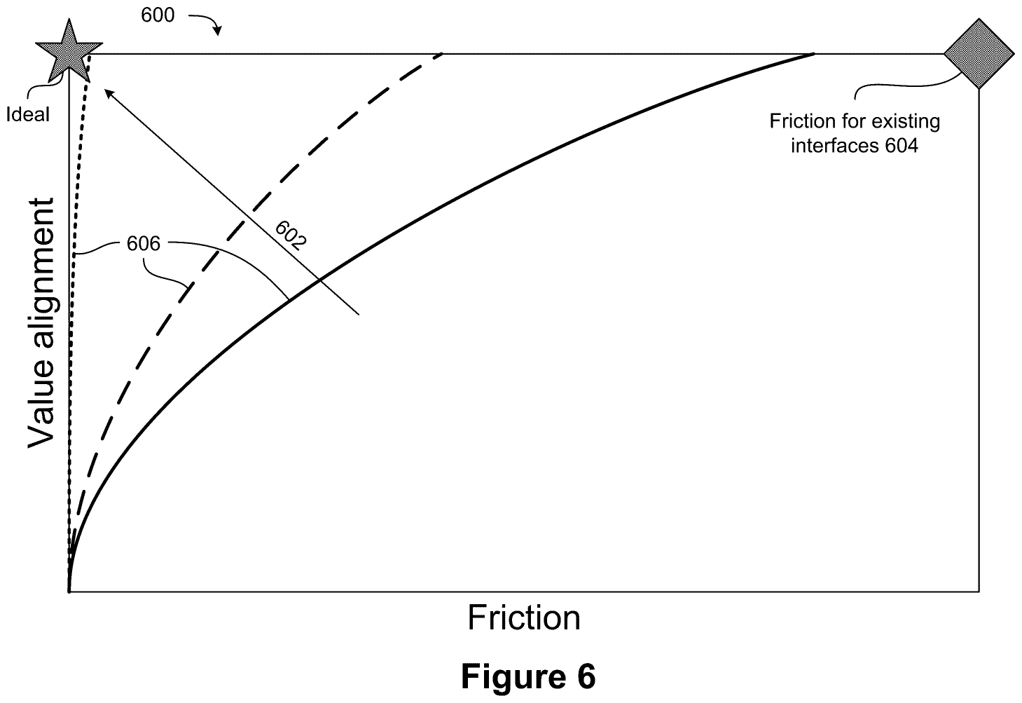

FIG. 6 illustrates an example goal value alignment versus incurred friction pareto front 600 of the low friction human-machine interaction system of the artificial reality systems. The low friction human-machine interaction system 300 can generate a pareto front 600 of user value alignment versus incurred friction. The user value alignment indicates progress towards learning the user's goal and the incurred friction indicate interaction cost to the user. The low friction human-machine interaction system 300 can generate a pareto front 600 of user value alignment versus incurred friction. For example, the low friction human-machine interaction system 300 allows the user 235 to navigate the user value alignment versus incurred friction pareto front 600 and determine the precise tradeoff between friction and value alignment the user 235 prefers. As another example, the low friction human-machine interaction system 300 can provide a quantitative mechanism for proactive initiation with the user 235, such a wake-signal elimination. As a result, the low friction human-machine interaction system 300 can optimize one or more AI models, such as model of intentions 322, decision engines 362, machine learning models 364, to achieve a high value/friction rate. The objective of the low friction human-machine interaction system 300 is to achieve nearly zero friction 602 by pushing the pareto front curves 606 from the friction for existing interfaces 604 using a plurality of iterations of the MMI. Likewise, the user 235 can terminate the MMI at any time along the pareto front 600. In particular, this proactive service layer can dynamically adapt to a given context to leverage multimodal inputs and outputs across a range of bandwidths and interfaces, such as fixed goals with closed set queries and responses to dynamic goals with open set queries and responses.

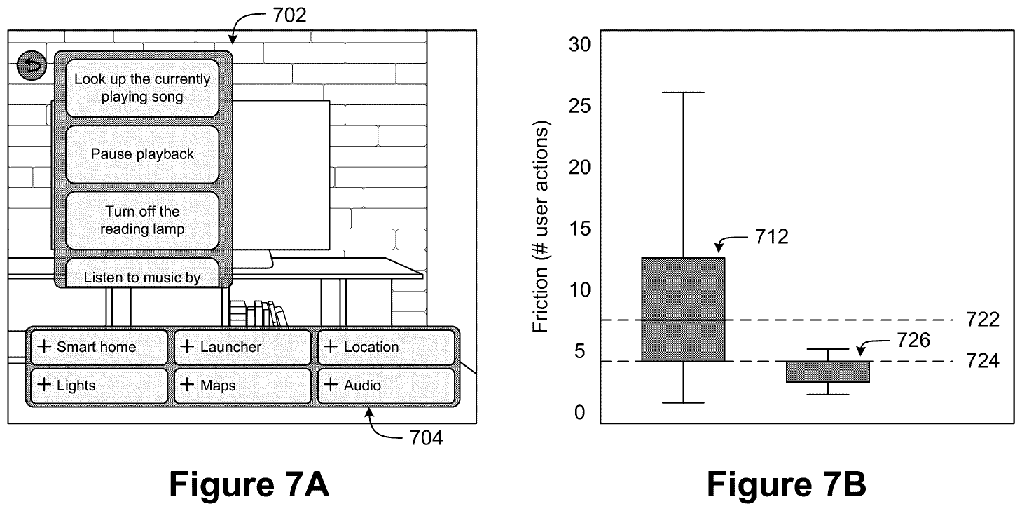

FIGS. 7A and 7B illustrate example interface and friction for randomly selected tags and quasi-optimally selected goal tags. FIG. 7A shows an interface with three most probable goals 702 are presented, along with six tags for queries 704 in the bottom. The user 235 can select tags until a specific goal is presented. FIG. 7B compares user friction in terms of the number of user goals when the tags are selected randomly, such as random tags 712, versus when the tags are selected quasi-optimally, such as quasi-optimal tags 726, using an optimal query generation algorithm 366, such as the greedy-optimal ultra-low-friction interface algorithm. It is clear that the median 724 for the quasi-optimal tags 726 is much smaller than the median 722 for the random tags 712 which is a 2-3 fold improvement in the mean/median. Likewise, the quasi-optimal tags 726 has a much tighter distribution, such as a factor of 6 improvement in the upper quintile, than the random tags 712.

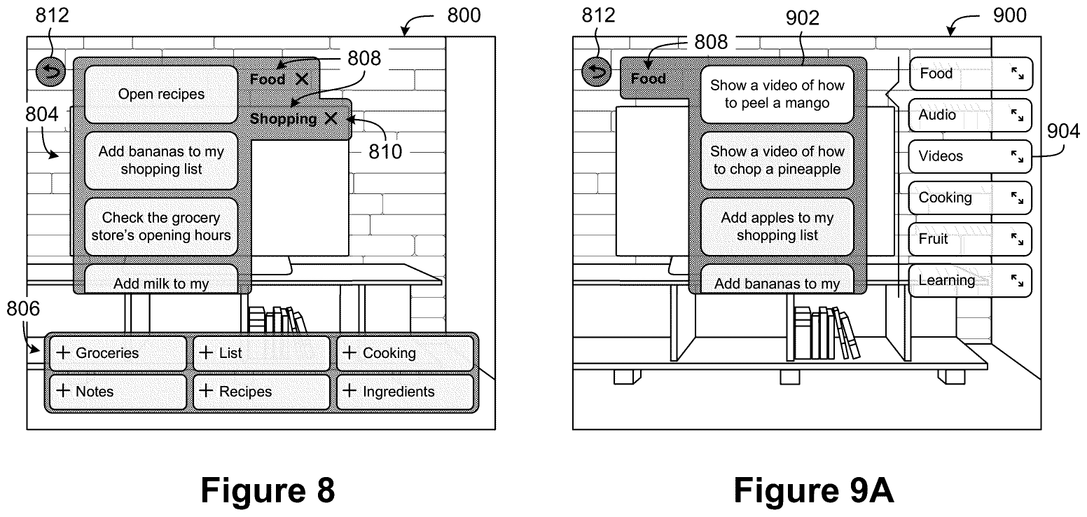

FIG. 8 illustrates an example semantic filter interface 800. FIG. 8 shows a semantic filter interface 800 with a plurality of recommended digital actions 804, each recommended digital action associated with a plurality of recommended semantic tags 806. The low friction human-machine interaction system 300 can display the plurality of recommended digital actions 804 on the semantic filter interface 800 in the user's field of view. For example, a recommended digital action can be “Show a video of how to chop a pineapple” which is associated with multiple semantic tags shown in the bottom, such as “Groceries,” “List,” “Cooking,” “Notes,” “Recipes,” and “Ingredients,” etc. The user can select the semantic tags 806 to filter the plurality of recommended digital actions 804 in the system. In particular, the user can activate these recommended digital actions 804 and semantic tags 806 with a click and scroll through the list of recommended digital actions 804 using a scroll wheel (or other scrolling mechanism) or by clicking and dragging with a mouse. For example, the user can activate these recommended digital actions 804 and/or semantic tags 806 by pointing to an item and clicking using a pinch or another micro-gesture. The user can interact with the semantic filter interface 800 to navigate a space of actions which includes the plurality of recommended digital actions. Furthermore, the user can select one or more active tags 808 using the plurality of corresponding recommended tags 806 associated with the activated recommended digital action 804. The low friction human-machine interaction system 300 can determine a plurality of active digital actions associated with the intention of the user by filtering the plurality of recommended digital actions 804 that match the one or more active tags 808 on the semantic filter interface 800. For example, when the user selects the semantic tags of “Food” and “Shopping,” a list of active tags 808 of “Food” and “Shopping” may be displayed to the right of recommended digital actions 804 in the semantic filter interface 800. In particular, the list of recommended digital actions 804 only contains digital actions that match all the active tags 808. The user can click recommended semantic tags 806 to add new active tags to the list of active tags 808. Likewise, the user can remove an active tag by clicking an “X” button 810 next to it or undo the last digital action taken in the semantic filter interface by clicking the “Undo” button 812.

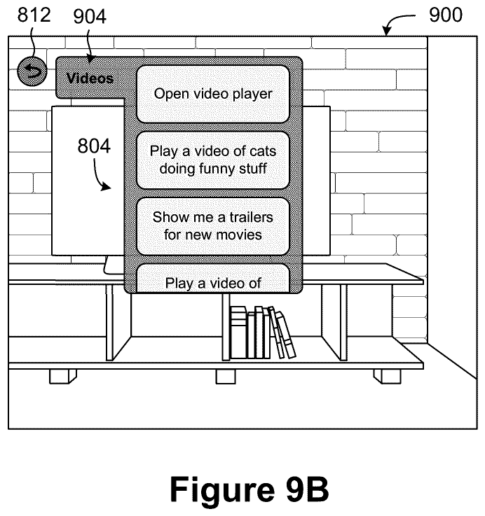

FIGS. 9A and 9B illustrate example semantic connection interface 900. FIG. 9A shows a semantic connection interface 900 with a plurality of action tags, such as action tags A 902 and action tags B 904, associated with an active tag 808. The low friction human-machine interaction system 300 can display the one or more active tags on a semantic connection interface 900 in the user's field of view. Each of the one or more active tags is associated with a plurality of second recommended digital actions, such as action tags A 902. The user can select an active tag 808 from the one or more active tags on the semantic connection interface 900. The low friction human-machine interaction system 300 can apply the model of intentions to determine the plurality of second recommended digital actions based on the selected active tag 808 on the semantic connection interface 900. Furthermore, the low friction human-machine interaction system 300 can determine the plurality of first active digital actions associated with the intention of the user by filtering the plurality of second recommended digital actions that match the selected active tag 808 on the semantic connection interface 900. For example, the active tag 808 of “Food” is associated with a plurality of action tags A 902, such as “Show a video of how to peel a mango,” “Show a video of how to chop a pineapple,” and “Add apples to my shopping list,” etc. As another example, each action tag in action tags A 902 is associated with a list of selected recommended semantic tags, such as action tags B 904. The user can click an active tag 808 to display the list of action tags A 902 and action tags B 904 associated with the active tag 808. Unlike the semantic filter interface 800, the semantic connection interface 900 only includes at most one active tag 808. FIG. 9B shows a semantic connection interface 900 with a list of recommended digital actions 804 associated with an action tag 902. For example, the action tag 902 is associated with a list of recommended digital actions 804, such as “Play me a video of cats doing funny stuff,” etc. In particular, the user can activate these recommended digital actions 804 with a click and scroll through the list of recommended digital actions 804 using a scroll wheel or by a mechanism for scrolling. The list of recommended digital actions 804 is reordered so that digital actions with that tag are displayed at the top. The user can click the action tags B 904 to display the list of recommended digital actions 804 associated with the action tag B 904. The user can hover the cursor over a digital action to display the tags associated with that digital action. Likewise, the user can undo the last digital action taken in the semantic connection interface 900 by clicking the “Undo” button 812.

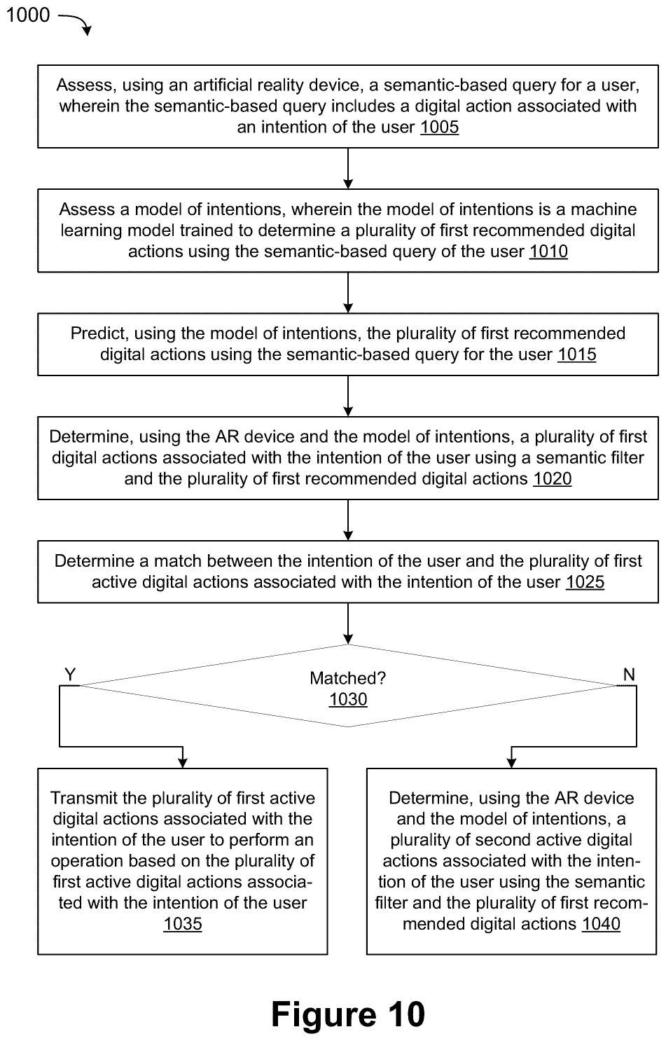

FIGS. 10-13 illustrate various example methods 1000-1300, in accordance with some embodiments. Operations (e.g., steps) of the methods 1000-1300 can be performed by one or more processors (e.g., central processing unit and/or MCU) of a system (e.g., artificial reality system 100A, augmented reality system 100B, computer system 1400). At least some of the operations shown in FIGS. 10-13 correspond to instructions stored in a computer memory or computer-readable storage medium (e.g., storage, RAM, and/or memory). Operations of the methods 1000-1300 can be performed by a single device alone or in conjunction with one or more processors (e.g., processor 1402) and/or hardware components of another communicatively coupled device (e.g., headset 104, controller 106, HMD 110) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by a particular component or device (e.g., a computing system of an artificial reality device), but the operations should not be construed as limiting the performance thereof to a particular device in all embodiments.

FIG. 10 illustrates an example method 1000 for determining a plurality of active digital actions using a semantic-based query for a user. The method 1000 may begin at step 1005, where the computing system can obtain a semantic-based query for a user. In particular embodiments, the semantic-based query includes a digital action associated with an intention of the user. For example, the semantic-based query may be “Set a morning routine” from the user. At step 1010, the method may assess a model of intentions from a server computer. In particular embodiments, the model of intentions can be a machine learning model trained using a decision tree algorithm to determine a plurality of first recommended digital actions based on the semantic-based query of the user. In particular embodiments, the model of intentions can be applied to determine a vector representation of the digital action associated with the intention of the user. Likewise, the model of intentions can be applied to determine vector representations of a plurality of recommended digital actions. For example, the recommended digital actions can be a list of digital actions available in the artificial reality systems. For example, a recommended digital action can be “Set an alarm for 7:00 am” which is associated multiple concepts “clock,” “alarm,” “wake up,” “morning,” etc. As another example, the recommended digital actions can be selected from a training dataset which includes prior use of the low friction human-machine interaction system 300. In particular embodiments, the model of intentions can be applied to determine an embedding of the vector representation of the digital action associated with the intention of the user in a multi-dimensional embedding space. Likewise, the model of intentions can be applied to determine embeddings of the vector representations of the plurality of recommended digital actions of the training dataset in the multi-dimensional embedding space. The model of intentions can be applied to determine, for each of the one or more recommended digital actions, a respective similarity of the embedding of the vector representation of the digital action associated with the intention of the user to the embedding of the vector representation of the recommended digital action of the training dataset. As a result, the model of intentions can be applied to identify one or more recommended digital actions using the calculated similarity between the embedding of the vector representation of the digital action associated with the intention of the user and the embeddings of the vector representations of the recommended digital actions.

At step 1015, the method may use the model of intentions to predict the plurality of first recommended digital actions using the semantic-based query for the user. In particular embodiments, the plurality of recommended digital actions can be presented to the user on a semantic interface in the user's environment so the user can interact with the artificial reality systems through artificial reality glasses. At step 1020, the method may use the artificial reality systems and the model of intentions to determine a plurality of first active digital actions associated with the intention of the user using a semantic filter and the plurality of first recommended digital actions. For example, the multiple concepts associated with a recommended digital action can include a plurality of active digital actions. The low friction human-machine interaction system 300 can use the semantic filter to determine the plurality of first active digital actions associated with the intention of the user. At step 1030, the method can make a determination whether the plurality of first active digital actions match the intention of the user. Where the plurality of first active digital actions match the intention of the user, the process may proceed to step 1035 to transmit the plurality of first active digital actions associated with the intention of the user to the server computer to perform an operation based on the plurality of first active digital actions associated with the intention of the user. Where the plurality of first active digital actions do not match the intention of the user, the process may proceed to step 1040 to use the model of intentions to determine a plurality of second active digital actions associated with the intention of the user using the semantic filter and the plurality of first recommended digital actions.

Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for determining active digital actions based on a semantic-based query for the user including the particular steps of the method of FIG. 10, this disclosure contemplates any suitable method for determining active digital actions based on a semantic-based query for the user including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.
(A1) A method performed, for example, by a computing system of an artificial reality device (e.g., headset 104, controller 106, HMD 110). The method includes assessing (e.g., using the artificial reality device) a semantic-based query for a user. In some embodiments, the semantic-based query includes a digital action associated with an intention of the user. The method also includes assessing (e.g., using a server computer) a model of intentions. In some embodiments, the model of intentions is a machine learning model trained to determine a plurality of first recommended digital actions (e.g., recommended digital actions 804) using the semantic-based query of the user. Additionally, the method includes predicting, using the model of intentions, the plurality of first recommended digital actions using the semantic-based query for the user. Further, the method includes determining, using the artificial reality device and the model of intentions, a plurality of first active digital actions associated with the intention of the user using a semantic filter and the plurality of first recommended digital actions. Moreover, the method includes determining a match between the intention of the user and the plurality of first active digital actions (e.g., matching active tags 808) associated with the intention of the user. Furthermore, the method includes, in response to determining the match, transmitting the plurality of first active digital actions associated with the intention of the user (e.g., to a server computer) to perform an operation (e.g., open recipes) based on the plurality of first active digital actions associated with the intention of the user.
(A2) The method of (A1), further including, in response to determining the mismatch, determining, using the artificial reality device and the model of intentions, a plurality of second active digital actions associated with the intention of the user using the semantic filter and the plurality of first recommended digital actions.
(A3) The method of either (A1) or (A2), further including generating the model of intentions using a decision tree algorithm. The method also includes determining, using the model of intentions, a vector representation of the digital action associated with the intention of the user. Additionally, the method includes determining, using the model of intentions, vector representations of a plurality of recommended digital actions using a training dataset, wherein the training dataset includes prior use of the artificial reality device. Further, the method includes determining, using the model of intentions, an embedding of the vector representation of the digital action associated with the intention of the user in a multi-dimensional embedding space. Moreover, the method includes determining, using the model of intentions, embeddings of the vector representations of the plurality of recommended digital actions of the training dataset in the multi-dimensional embedding space. Furthermore, the method includes identifying one or more recommended digital actions based on, for each of the one or more recommended digital actions, a respective similarity of the embedding of the vector representation of the digital action associated with the intention of the user to the embedding of the vector representation of the recommended digital action of the training dataset.
(A4) The method of any one of (A1) through (A3), further including displaying, using the artificial reality device, the plurality of first recommended digital actions on a semantic filter interface in the user's field of view. In some embodiments, each of the plurality of first recommended digital actions is associated with a plurality of corresponding tags. The method also includes determining, using the artificial reality device, a recommended digital action by scrolling through of the plurality of first recommended digital actions with a mechanism for scrolling. Additionally, the method includes activating the recommended digital action by pointing to an item and clicking using a pinch or other micro-gesture.
(A5) The method of (A4), further including interacting, using the artificial reality device, with the semantic filter interface to navigate a space of actions, wherein the space of actions includes the plurality of first recommended digital actions.
(A6) The method of either (A4) or (A5), further including selecting, using the artificial reality device, one or more active tags using the plurality of corresponding tags associated with the activated recommended digital action. The method also includes determining the plurality of first active digital actions associated with the intention of the user by filtering the plurality of first recommended digital actions that match the one or more active tags on the semantic filter interface.
(A7) The method of (A6), further including displaying, using the artificial reality device, the one or more active tags on a semantic connection interface in the user's field of view. In some embodiments, each of the one or more active tags is associated with a plurality of second recommended digital actions. The method also includes selecting an active tag from the one or more active tags on the semantic connection interface. Additionally, the method includes determining, using the artificial reality device and the model of intentions, the plurality of second recommended digital actions based on the selected active tag on the semantic connection interface. Further, the method includes determining the plurality of first active digital actions associated with the intention of the user by filtering the plurality of second recommended digital actions that match the selected active tag on the semantic connection interface.
(A8) The method of (A7), where the plurality of first active digital actions associated with the intention of the user are displayed at the top in the plurality of second recommended digital actions on the semantic connection interface.
(A9) The method of either (A7) or (A8), further including hovering the cursor over a particular digital action of the plurality of second recommended digital actions to display the plurality of corresponding tags associated with the particular digital action. The method also includes selecting the active tag using the plurality of corresponding tags associated with the particular digital action of the plurality of second recommended digital actions.
(B1) One or more non-transitory, computer-readable storage media embodying software that is operable when executed to assess, using an artificial reality device (e.g., headset 104, controller 106, HMD 110), a semantic-based query for a user (e.g., user 235). In some embodiments, the semantic-based query includes a digital action associated with an intention of the user. The software is also operable when executed to assess (e.g., using a server computer) a model of intentions. In some embodiments, the model of intentions is a machine learning model trained to determine a plurality of first recommended digital actions using the semantic-based query of the user. Additionally, the software is operable when executed to predict, using the model of intentions, the plurality of first recommended digital actions using the semantic-based query for the user. Further, the software is operable when executed to determine, using the artificial reality device and the model of intentions, a plurality of first active digital actions associated with the intention of the user using a semantic filter and the plurality of first recommended digital actions. Moreover, the software is operable when executed to determine a match between the intention of the user and the plurality of first active digital actions associated with the intention of the user. Furthermore, the software is operable when executed to, in response to determining the match, transmit the plurality of first active digital actions associated with the intention of the user (e.g., to a server computer) to perform an operation based on the plurality of first active digital actions associated with the intention of the user.
(B2) The one or more non-transitory, computer-readable storage media of (B1), where the software is further operable when executed to, in response to determining the mismatch, determine, using the artificial reality device and the model of intentions, a plurality of second active digital actions associated with the intention of the user using the semantic filter and the plurality of first recommended digital actions.
(B3) The one or more non-transitory, computer-readable storage media of either (B1) or (B2), where the software is further operable when executed to generate the model of intentions using a decision tree algorithm. The software is further operable when executed to determine, using the model of intentions, a vector representation of the digital action associated with the intention of the user. Additionally, the software is further operable when executed to determine, using the model of intentions, vector representations of a plurality of recommended digital actions using a training dataset. In some embodiments, the training dataset includes prior use of the artificial reality device. Further, the software is further operable when executed to determine, using the model of intentions, an embedding of the vector representation of the digital action associated with the intention of the user in a multi-dimensional embedding space. Moreover, the software is further operable when executed to determine, using the model of intentions, embeddings of the vector representations of the plurality of recommended digital actions of the training dataset in the multi-dimensional embedding space. Furthermore, the software is further operable when executed to identify one or more recommended digital actions based on, for each of the one or more recommended digital actions, a respective similarity of the embedding of the vector representation of the digital action associated with the intention of the user to the embedding of the vector representation of the recommended digital action of the training dataset.
(B4) The one or more non-transitory, computer-readable storage media of any one of (B1) through (B3), where the software is further operable when executed to display, using the artificial reality device, the plurality of first recommended digital actions on a semantic filter interface in the user's field of view. In some embodiments, each of the plurality of first recommended digital actions is associated with a plurality of corresponding tags. The software is also operable when executed to determine, using the artificial reality device, a recommended digital action by scrolling through of the plurality of first recommended digital actions with a mechanism for scrolling. Additionally, the software is operable when executed to activate the recommended digital action by pointing to an item and clicking using a pinch or other micro-gesture.
(B5) The one or more non-transitory, computer-readable storage media of (B4), where the software is further operable when executed to interact, using the artificial reality device, with the semantic filter interface to navigate a space of actions, wherein the space of actions includes the plurality of first recommended digital actions.
(B6) The one or more non-transitory, computer-readable storage media of either (B4) or (B5), where the software is further operable when executed to select, using the artificial reality device, one or more active tags using the plurality of corresponding tags associated with the activated recommended digital action. The software is also operable when executed to determine the plurality of first active digital actions associated with the intention of the user by filtering the plurality of first recommended digital actions that match the one or more active tags on the semantic filter interface.
(B7) The one or more non-transitory, computer-readable storage media of (B6), where the software is further operable when executed to display, using the artificial reality device, the one or more active tags on a semantic connection interface in the user's field of view. In some embodiments, each of the one or more active tags is associated with a plurality of second recommended digital actions. The software is also operable when executed to select an active tag from the one or more active tags on the semantic connection interface. Additionally, the software is operable when executed to determine, using the artificial reality device and the model of intentions, the plurality of second recommended digital actions based on the selected active tag on the semantic connection interface. Further, the software is operable when executed to determine the plurality of first active digital actions associated with the intention of the user by filtering the plurality of second recommended digital actions that match the selected active tag on the semantic connection interface.
(B8) The one or more non-transitory, computer-readable storage media of (B7), where the plurality of first active digital actions associated with the intention of the user are displayed at the top in the plurality of second recommended digital actions on the semantic connection interface.
(B9) The one or more non-transitory, computer-readable storage media of either (B7) or (B8), where the software is further operable when executed to hover the cursor over a particular digital action of the plurality of second recommended digital actions to display the plurality of corresponding tags associated with the particular digital action. The software is also operable when executed to select the active tag using the plurality of corresponding tags associated with the particular digital action of the plurality of second recommended digital actions.
(C1) A system includes one or more processors (e.g., processor 1402) and one or more non-transitory, computer-readable media (e.g., memory 1404, storage 1406) coupled to one or more of the processors and including instructions operable when executed by one or more of the processors to cause the system to assess, using an artificial reality device (e.g., headset 104, controller 106, HMD 110), a semantic-based query for a user (e.g., user 235). In some embodiments, the semantic-based query includes a digital action associated with an intention of the user. The instructions are also operable when executed to cause the system to assess (e.g., using a server computer) a model of intentions. In some embodiments, the model of intentions is a machine learning model trained to determine a plurality of first recommended digital actions using the semantic-based query of the user. Additionally, the instructions are operable when executed to cause the system to predict, using the model of intentions, the plurality of first recommended digital actions using the semantic-based query for the user. Further, the instructions are operable when executed to cause the system to determine, using the artificial reality device and the model of intentions, a plurality of first active digital actions associated with the intention of the user using a semantic filter and the plurality of first recommended digital actions. Moreover, the instructions are operable when executed to cause the system to determine a match between the intention of the user and the plurality of first active digital actions associated with the intention of the user. Furthermore, the instructions are operable when executed to cause the system to, in response to determining the match, transmit the plurality of first active digital actions associated with the intention of the user (e.g., to a server computer) to perform an operation based on the plurality of first active digital actions associated with the intention of the user.
(C2) The system of (C1), where the instructions are further operable when executed by the one or more of the processors to cause the system to, in response to determining the mismatch, determine, using the artificial reality device and the model of intentions, a plurality of second active digital actions associated with the intention of the user using the semantic filter and the plurality of first recommended digital actions.

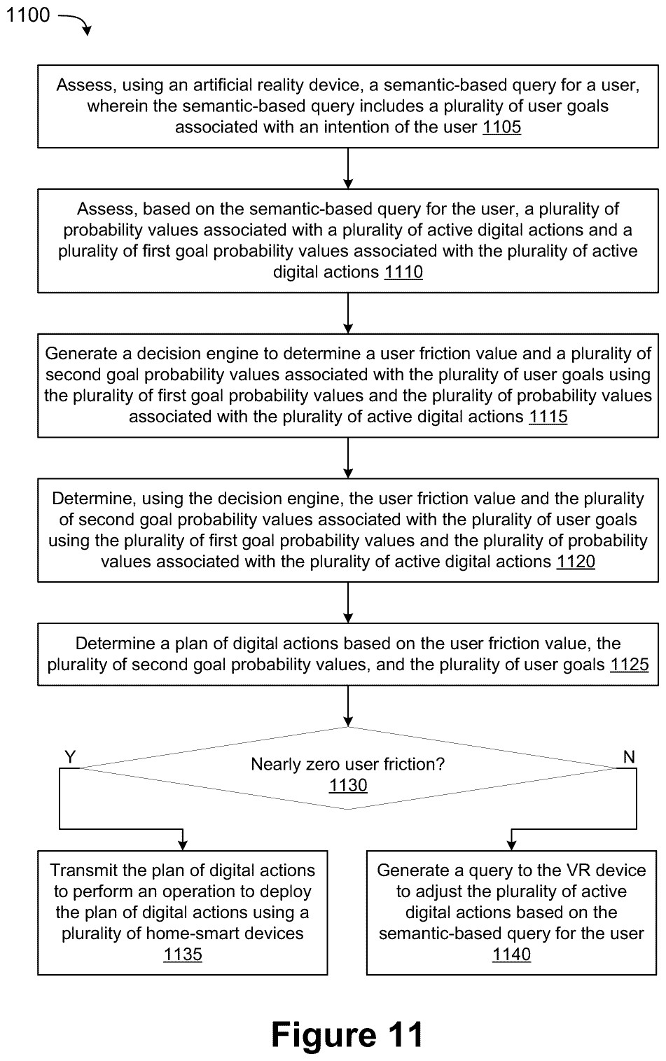

FIG. 11 illustrates an example method 1100 for determining a user friction value and a plan of digital action using a low friction human-machine interaction system 300 based on a semantic-based query for a user. The method 1100 may begin at step 1105, where the computing system can obtain a semantic-based query for a user. In particular embodiments, the semantic-based query includes a plurality of user goals associated with an intention of the user. At step 1110, the method may use a server computer to assess a plurality of probability values associated with a plurality of active digital actions and a plurality of first goal probability values associated with the plurality of active digital actions based on the semantic-based query for the user. In particular embodiments, the plurality of probability values associated with a plurality of active digital actions can be predetermined or learned from prior experience by the low friction human-machine interaction system 300. In particular embodiments, the low friction human-machine interaction system 300 can determine the plurality of first goal probability values associated with the plurality of active digital actions using response data 312 from the user 235.

At step 1115, the method may generate a decision engine 362 to determine a user friction value and a plurality of second goal probability values associated with the plurality of user goals using the plurality of first goal probability values and the plurality of probability values associated with the plurality of active digital actions. In particular embodiments, the low friction human-machine interaction system 300 can train the decision engine 362 using a greedy optimal ultra-low-friction interface algorithm. For example, the decision engine 362 includes an objective to minimize the user friction value by maximizing a net information gain of the plan of digital actions in current context. In particular, the net information gain is determined by subtracting an information cost from an information gain of the plan of digital actions. At step 1120, the method may use the decision engine to determine the user friction value and the plurality of second goal probability values associated with the plurality of user goals using the plurality of first goal probability values and the plurality of probability values associated with the plurality of active digital actions. At step 1125, the method may determine a plan of digital actions based on the user friction value, the plurality of second goal probability values, and the plurality of user goals. In particular embodiments, the low friction human-machine interaction system 300 can use an agent aggregator 350 to map current context of the plan of digital actions to a plurality of AI agent aggregations of task representations, wherein the task representations comprise task state, task constraints, and task rewards.

At step 1130, the method can make a determination whether the user friction value is below a predetermined threshold. Where the user friction value is below a predetermined threshold, the process may proceed to step 1135 to transmit the plan of digital actions (e.g., to a server computer) to perform an operation to deploy the plan of digital actions using a plurality of home-smart devices. Where the user friction value is above a predetermined threshold, the process may proceed to step 1140 to generate a query to the artificial reality systems to adjust the plurality of active digital actions based on the semantic-based query for the user.

Particular embodiments may repeat one or more steps of the method of FIG. 11, where appropriate. Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for determining a user friction value and a plan of digital actions based on a semantic-based query for the user including the particular steps of the method of FIG. 11, this disclosure contemplates any suitable method for determining a user friction value and a plan of digital actions based on a semantic-based query for the user including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.
(D1) A method performed, for example, by a computing system of an artificial reality device (e.g., headset 104, controller 106, HMD 110). The method includes assessing, using the artificial reality device, a semantic-based query for a user. In some embodiments, the semantic-based query includes a plurality of user goals associated with an intention of the user. The method also includes assessing, based on the semantic-based query for the user, a plurality of probability values associated with a plurality of active digital actions and a plurality of first goal probability values associated with the plurality of active digital actions. Additionally, the method includes generating a decision engine (e.g., decision engine 362) to determine a user friction value and a plurality of second goal probability values associated with the plurality of user goals using the plurality of first goal probability values and the plurality of probability values associated with the plurality of active digital actions. Further, the method includes determining, using the decision engine, the user friction value and the plurality of second goal probability values associated with the plurality of user goals using the plurality of first goal probability values and the plurality of probability values associated with the plurality of active digital actions. Moreover, the method includes determining a plan of digital actions based on the user friction value, the plurality of second goal probability values, and the plurality of user goals. Furthermore, the method includes, in response to determining the user friction value exceeds a predetermined threshold, generating a query to the artificial reality device to adjust the plurality of active digital actions based on the semantic-based query for the user.
(D2) The method of (D1), further including, in response to determining the user friction value does not exceed a predetermined threshold, transmitting the plan of digital actions (e.g., to a server computer) to perform an operation to deploy the plan of digital actions using a plurality of home-smart devices.
(D3) The method of either (D1) or (D2), further including displaying, using the artificial reality device, the user friction value and the plan of digital actions on a user interface.
(D4) The method of any one of (D1) through (D3), further including training the decision engine using a greedy optimal ultra-low-friction interface algorithm, wherein the decision engine includes an objective to minimize the user friction value by maximizing a net information gain of the plan of digital actions in current context, and wherein the net information gain is determined by subtracting an information cost from an information gain of the plan of digital actions.
(D5) The method of any one of (D1) through (D4), where the plurality of first goal probability values are associated with a prior probability distribution associated with the plurality of active digital actions before engaging the user, and where the plurality of second goal probability values are associated with a conditional probability distribution associated with the plurality of active digital actions after engaging the user.
(D6) The method of any one of (D1) through (D5), further including determining an agent aggregator to map current context of the plan of digital actions to a plurality of AI agent aggregations of task representations. In some embodiments, the task representations comprise task state, task constraints, and task rewards.
(D7) The method of (D6), further including generating, using the decision engine and the agent aggregator, a dialogue to minimize expected number of explicit input commands needed to disambiguate the intention of the user.
(D8) The method of any one of (D1) through (D7), where the user friction value is a learned function of myriad features which include user's familiarity with a command codality, a user expertise, an environment context, a cognitive load, and where the user friction value is a number of input bits needed to issue a given command for disambiguating the intention of the user.
(D9) The method of any one of (D1) through (D8), further including determining an I/O mediator (e.g., I/O mediator 368) to appropriately tailor a current context and promote consistency of a plurality of modalities across multiple deployments of an AI agent. The method also includes determining, using the I/O mediator, a user experience quality value associated with contextual appropriateness and consistency based on the plan of digital actions.
(E1) One or more non-transitory, computer-readable storage media embodying software that is operable when executed to assess, using an artificial reality device (e.g., headset 104, controller 106, HMD 110), a semantic-based query for a user, wherein the semantic-based query includes a plurality of user goals associated with an intention of the user. The software is also operable when executed to assess (e.g., using a server computer) based on the semantic-based query for the user, a plurality of probability values associated with a plurality of active digital actions and a plurality of first goal probability values associated with the plurality of active digital actions. Additionally, the software is operable when executed to generate a decision engine to determine a user friction value and a plurality of second goal probability values associated with the plurality of user goals using the plurality of first goal probability values and the plurality of probability values associated with the plurality of active digital actions. Further, the software is operable when executed to determine, using the decision engine, the user friction value and the plurality of second goal probability values associated with the plurality of user goals using the plurality of first goal probability values and the plurality of probability values associated with the plurality of active digital actions. Moreover, the software is operable when executed to determine a plan of digital actions based on the user friction value, the plurality of second goal probability values, and the plurality of user goals. Furthermore, the software is operable when executed to, in response to determining the user friction value exceeds a predetermined threshold, generate a query to the artificial reality device to adjust the plurality of active digital actions based on the semantic-based query for the user.
(E2) The one or more non-transitory, computer-readable storage media of (E1), where the software is further operable when executed to, in response to determining the user friction value does not exceed a predetermined threshold, transmit the plan of digital actions (e.g., to a server computer) to perform an operation to deploy the plan of digital actions using a plurality of home-smart devices.
(E3) The one or more non-transitory, computer-readable storage media of either (E1) or (E2), where the software is further operable when executed to display, using the artificial reality device, the user friction value and the plan of digital actions on a user interface.
(E4) The one or more non-transitory, computer-readable storage media of any one of (E1) through (E3), where the software is further operable when executed to train the decision engine using a greedy optimal ultra-low-friction interface algorithm. In some embodiments, the decision engine includes an objective to minimize the user friction value by maximizing a net information gain of the plan of digital actions in current context, and wherein the net information gain is determined by subtracting an information cost from an information gain of the plan of digital actions.
(E5) The one or more non-transitory, computer-readable storage media of any one of (E1) through (E4), where the plurality of first goal probability values are associated with a prior probability distribution associated with the plurality of active digital actions before engaging the user, and where the plurality of second goal probability values are associated with a conditional probability distribution associated with the plurality of active digital actions after engaging the user.
(E6) The one or more non-transitory, computer-readable storage media of any one of (E1) through (E5), where the software is further operable when executed to determine an agent aggregator to map current context of the plan of digital actions to a plurality of AI agent aggregations of task representations, and where the task representations comprise task state, task constraints, and task rewards.
(E7) The one or more non-transitory, computer-readable storage media of (E6), where the software is further operable when executed to generate, using the decision engine and the agent aggregator, a dialogue to minimize expected number of explicit input commands needed to disambiguate the intention of the user,
(E8) The one or more non-transitory, computer-readable storage media of any one of (E1) through (E7), where the user friction value is a learned function of myriad features which include user's familiarity with a command codality, a user expertise, an environment context, a cognitive load, and where the user friction value is a number of input bits needed to issue a given command for disambiguating the intention of the user.
(E9) The one or more non-transitory, computer-readable storage media of any one of (E1) through (E8), where the software is further operable when executed to determine an I/O mediator to appropriately tailor a current context and promote consistency of a plurality of modalities across multiple deployments of an AI agent. The software is also operable when executed to determine, using the I/O mediator, a user experience quality value associated with contextual appropriateness and consistency based on the plan of digital actions.
(F1) A system includes one or more processors (e.g., processor 1402) and one or more non-transitory, computer-readable media (e.g., memory 1404, storage 1406) coupled to one or more of the processors and including instructions operable when executed by one or more of the processors to cause the system to assess, using an artificial reality device, a semantic-based query for a user. In some embodiments, the semantic-based query includes a plurality of user goals associated with an intention of the user. The instructions are also operable when executed to cause the system to assess (e.g., using a server computer) based on the semantic-based query for the user, a plurality of probability values associated with a plurality of active digital actions and a plurality of first goal probability values associated with the plurality of active digital actions. Additionally, the instructions are operable when executed to cause the system to generate a decision engine to determine a user friction value and a plurality of second goal probability values associated with the plurality of user goals using the plurality of first goal probability values and the plurality of probability values associated with the plurality of active digital actions. Further, the instructions are operable when executed to cause the system to determine, using the decision engine, the user friction value and the plurality of second goal probability values associated with the plurality of user goals using the plurality of first goal probability values and the plurality of probability values associated with the plurality of active digital actions. Moreover, the instructions are operable when executed to cause the system to determine a plan of digital actions based on the user friction value, the plurality of second goal probability values, and the plurality of user goals. Furthermore, the instructions are operable when executed to cause the system to, in response to determining the user friction value exceeds a predetermined threshold, generate a query to the artificial reality device to adjust the plurality of active digital actions based on the semantic-based query for the user.
(F2) The system of (F1), where the instructions are further operable when executed by the one or more of the processors to cause the system to, in response to determining the user friction value does not exceed a predetermined threshold, transmit the plan of digital actions (e.g., to a server computer) to perform an operation to deploy the plan of digital actions using a plurality of home-smart devices.

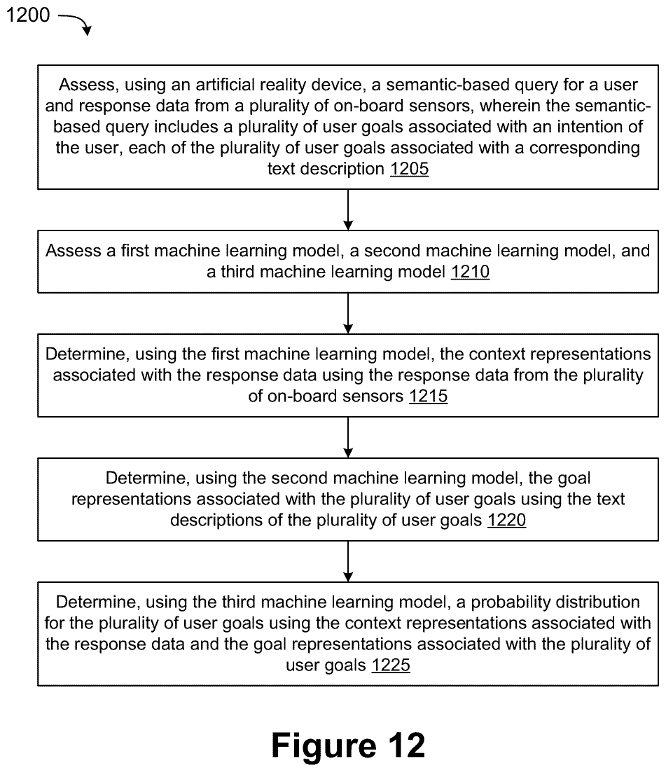

FIG. 12 illustrates an example method 1200 for determining context representations, goal representations, and a plurality of probability distribution over user's goals based on a semantic-based query for a user. The method 1200 may begin at step 1205, where the computing system can obtain a semantic-based query for a user and response data from a plurality of on-board sensor. In particular embodiments, the semantic-based query can include a plurality of user goals associated with an intention of the user and each of the plurality of user goals is associated with a corresponding text description. In particular embodiments, the response data is determined from measurements of the plurality of on-board sensors of the artificial reality device, the plurality of on-board sensors including wristbands, artificial reality glasses, EMG, IMUs, camera, microphone, haptics, voice interface, and peripheral sensors. At step 1210, the method may assess (e.g., using a server computer) a first machine learning model, a second machine learning model, and a third machine learning model. In particular embodiments, the first machine learning model is applied to determine context representations associated with the response data using the response data from the plurality of on-board sensors. In particular embodiments, the second machine learning model is applied to determine goal representations associated with the plurality of user goals using the text descriptions of the plurality of user goals. In particular embodiments, the third machine learning model is applied to determine a probability distribution for the plurality of user goals using the context representations associated with the response data and the goal representations associated with the plurality of user goals.

At step 1215, the method may use the first machine learning model to determine the context representations associated with the response data using the response data from the plurality of on-board sensors. At step 1220, the method may use the second machine learning model, the goal representations associated with the plurality of user goals using the text descriptions of the plurality of user goals. In particular embodiments, for each of the goal representations, the low friction human-machine interaction system 300 can use the second machine learning model to determine a respective goal description of a goal representation using the corresponding goal representation. At step 1225, the method may use the third machine learning model, a probability distribution for the plurality of user goals using the context representations associated with the response data and the goal representations associated with the plurality of user goals. The low friction human-machine interaction system 300 can use the third machine learning model to determine first vector representations associated with the response data using the context representations associated with the response data and second vector representations associated with the plurality of user goals using the goal representations associated with the plurality of user goals. The low friction human-machine interaction system 300 can use the third machine learning model to determine an embedding of the first vector representations associated with the response data in a multi-dimensional embedding space based on a combination of the first vector representations associated with the response data. Likewise, the low friction human-machine interaction system 300 can use the third machine learning model to determine embeddings of the second vector representations associated with the plurality of user goals in the multi-dimensional embedding space based on the second vector representations associated with the plurality of user goals. Thus, the low friction human-machine interaction system 300 can use the third machine learning model to determine the probability distribution for the plurality of user goals using the embedding of the first vector representations associated with the response data and the embeddings of the second vector representations associated with the plurality of user goals.

Particular embodiments may repeat one or more steps of the method of FIG. 12, where appropriate. Although this disclosure describes and illustrates particular steps of the method of FIG. 12 as occurring in a particular order, this disclosure contemplates any suitable steps of the method of FIG. 12 occurring in any suitable order. Moreover, although this disclosure describes and illustrates an example method for determining context representations, goal representations, and a plurality of probability distribution over user's goals based on a semantic-based query for the user including the particular steps of the method of FIG. 12, this disclosure contemplates any suitable method for determining context representations, goal representations, and a plurality of probability distribution over user's goals based on a semantic-based query for the user including any suitable steps, which may include all, some, or none of the steps of the method of FIG. 12, where appropriate. Furthermore, although this disclosure describes and illustrates particular components, devices, or systems carrying out particular steps of the method of FIG. 12, this disclosure contemplates any suitable combination of any suitable components, devices, or systems carrying out any suitable steps of the method of FIG. 12.
(G1) A method performed, for example, by a computing system of an artificial reality device (e.g., headset 104, controller 106, HMD 110). The method includes assessing, using the artificial reality device, a semantic-based query for a user and response data from a plurality of on-board sensors. In some embodiments, the semantic-based query includes a plurality of user goals associated with an intention of the user, each of the plurality of user goals associated with a corresponding text description. The method also includes assessing (e.g., using a server computer) a first machine learning model, a second machine learning model, and a third machine learning model. In some embodiments, the first machine learning model is applied to determine context representations associated with the response data using the response data from the plurality of on-board sensors. Additionally, in some embodiments, the second machine learning model is applied to determine goal representations associated with the plurality of user goals using the text descriptions of the plurality of user goals. Further, in some embodiments, the third machine learning model is applied to determine a probability distribution for the plurality of user goals using the context representations associated with the response data and the goal representations associated with the plurality of user goals. Additionally, the method includes determining, using the first machine learning model, the context representations associated with the response data using the response data from the plurality of on-board sensors. Further, the method includes determining, using the second machine learning model, the goal representations associated with the plurality of user goals using the text descriptions of the plurality of user goals. Moreover, the method includes determining, using the third machine learning model, a probability distribution for the plurality of user goals using the context representations associated with the response data and the goal representations associated with the plurality of user goals.
(G2) The method of (G1), where the response data is determined from measurements of the plurality of on-board sensors of the artificial reality device, the plurality of on-board sensors including wristbands, artificial reality glasses, EMG, IMUs, camera, microphone, haptics, voice interface, and peripheral sensors.
(G3) The method of either (G1) or (G2), further including determining, using the second machine learning model, for each of the plurality of user goals, a respective goal representation of a user goal using the corresponding text description associated with the user goal.
(G4) The method of any one of (G1) through (G3), further including determining, using the second machine learning model, for each of the goal representations, a respective goal description of a goal representation using the corresponding goal representation.
(G5) The method of any one of (G1) through (G4), further including determining, using the third machine learning model, first vector representations associated with the response data using the context representations associated with the response data. The method also includes determining, using the third machine learning model, second vector representations associated with the plurality of user goals using the goal representations associated with the plurality of user goals. Additionally, the method includes determining, using the third machine learning model, an embedding of the first vector representations associated with the response data in a multi-dimensional embedding space based on a combination of the first vector representations associated with the response data. Further, the method includes determining, using the third machine learning model, embeddings of the second vector representations associated with the plurality of user goals in the multi-dimensional embedding space based on the second vector representations associated with the plurality of user goals. Moreover, the method includes determining, using the third machine learning model, the probability distribution for the plurality of user goals using the embedding of the first vector representations associated with the response data and the embeddings of the second vector representations associated with the plurality of user goals.
(G6) The method of any one of (G1) through (G5), further including determining, using the third machine learning model, a similarity score between two user goals of the plurality of user goals using the goal representations associated with the two user goals.
(G7) The method of any one of (G1) through (G6), where the plurality of user goals are determined in open domain using a natural language processing algorithm and the text descriptions of the plurality of user goals.
(G8) The method of any one of (G1) through (G7), where the context representations associated with the response data include virtual/physical world context, allocentric user context, egocentric user context, and internal user context.
(G9) The method of (G8), where the virtual/physical world context characterizes a state of virtual/physical world and associated exploitable structures, where the allocentric user context characterizes the location of the user in the virtual/physical world context, where the egocentric user context allows to recover the user's sensory signals from the on-board sensors, and where the internal user context characterizes the user's biophysical, cognitive, affective, and emotive state.
(H1) One or more non-transitory, computer-readable storage media embodying software that is operable when executed to assess, using an artificial reality device, a semantic-based query for a user and response data from a plurality of on-board sensors. In some embodiments, the semantic-based query includes a plurality of user goals associated with an intention of the user, each of the plurality of user goals associated with a corresponding text description. The software is also operable when executed to assess (e.g., using a server computer) a first machine learning model, a second machine learning model, and a third machine learning model. In some embodiments, the first machine learning model is applied to determine context representations associated with the response data using the response data from the plurality of on-board sensors. In some embodiments, the second machine learning model is applied to determine goal representations associated with the plurality of user goals using the text descriptions of the plurality of user goals. In some embodiments, the third machine learning model is applied to determine a probability distribution for the plurality of user goals using the context representations associated with the response data and the goal representations associated with the plurality of user goals. Additionally, the software is operable when executed to determine, using the first machine learning model, the context representations associated with the response data using the response data from the plurality of on-board sensors. Further, the software is operable when executed to determine, using the second machine learning model, the goal representations associated with the plurality of user goals using the text descriptions of the plurality of user goals. Moreover, the software is operable when executed to determine, using the third machine learning model, a probability distribution for the plurality of user goals using the context representations associated with the response data and the goal representations associated with the plurality of user goals.
(H2) The one or more non-transitory, computer-readable storage media of (H1), wherein the response data is determined from measurements of the plurality of on-board sensors of the artificial reality device, the plurality of on-board sensors including wristbands, artificial reality glasses, EMG, IMUs, camera, microphone, haptics, voice interface, and peripheral sensors.
(H3) The one or more non-transitory, computer-readable storage media of either (H1) or (H2), where the software is further operable when executed to determine, using the second machine learning model, for each of the plurality of user goals, a respective goal representation of a user goal using the corresponding text description associated with the user goal.
(H4) The one or more non-transitory, computer-readable storage media of any one of (H1) through (H3), where the software is further operable when executed to determine, using the second machine learning model, for each of the goal representations, a respective goal description of a goal representation using the corresponding goal representation.
(H5) The one or more non-transitory, computer-readable storage media of any one of (H1) through (H4), where the software is further operable when executed to determine, using the third machine learning model, first vector representations associated with the response data using the context representations associated with the response data. The software is also operable when executed to determine, using the third machine learning model, second vector representations associated with the plurality of user goals using the goal representations associated with the plurality of user goals. Additionally, the software is operable when executed to determine, using the third machine learning model, an embedding of the first vector representations associated with the response data in a multi-dimensional embedding space based on a combination of the first vector representations associated with the response data. Further, the software is operable when executed to determine, using the third machine learning model, embeddings of the second vector representations associated with the plurality of user goals in the multi-dimensional embedding space based on the second vector representations associated with the plurality of user goals. Moreover, the software is operable when executed to determine, using the third machine learning model, the probability distribution for the plurality of user goals using the embedding of the first vector representations associated with the response data and the embeddings of the second vector representations associated with the plurality of user goals.
(H6) The one or more non-transitory, computer-readable storage media of any one of (H1) through (H5), where the software is further operable when executed to determine, using the third machine learning model, a similarity score between two user goals of the plurality of user goals using the goal representations associated with the two user goals.
(H7) The one or more non-transitory, computer-readable storage media of any one of (H1) through (H6), where the plurality of user goals are determined in open domain using a natural language processing algorithm and the text descriptions of the plurality of user goals.
(H8) The one or more non-transitory, computer-readable storage media of any one of (H1) through (H7), where the context representations associated with the response data include virtual/physical world context, allocentric user context, egocentric user context, and internal user context.
(H9) The one or more non-transitory, computer-readable storage media of (H8), where the virtual/physical world context characterizes a state of virtual/physical world and associated exploitable structures, where the allocentric user context characterizes the location of the user in the virtual/physical world context, where the egocentric user context allows to recover the user's sensory signals from the on-board sensors, and where the internal user context characterizes the user's biophysical, cognitive, affective, and emotive state.
(I1) A system includes one or more processors (e.g., processor 1402) and one or more non-transitory, computer-readable media (e.g., memory 1404, storage 1406) coupled to one or more of the processors and including instructions operable when executed by one or more of the processors to cause the system to assess, using an artificial reality device, a semantic-based query for a user and response data from a plurality of on-board sensors. In some embodiments, the semantic-based query includes a plurality of user goals associated with an intention of the user, each of the plurality of user goals associated with a corresponding text description. The instructions are also operable when executed to cause the system to assess (e.g., using a server computer) a first machine learning model, a second machine learning model, and a third machine learning model. In some embodiments, the first machine learning model is applied to determine context representations associated with the response data using the response data from the plurality of on-board sensors. In some embodiments, the second machine learning model is applied to determine goal representations associated with the plurality of user goals using the text descriptions of the plurality of user goals. In some embodiments, the third machine learning model is applied to determine a probability distribution for the plurality of user goals using the context representations associated with the response data and the goal representations associated with the plurality of user goals. Additionally, the instructions are operable when executed to cause the system to determine, using the first machine learning model, the context representations associated with the response data using the response data from the plurality of on-board sensors. Further, the instructions are operable when executed to cause the system to determine, using the second machine learning model, the goal representations associated with the plurality of user goals using the text descriptions of the plurality of user goals. Moreover, the instructions are operable when executed to cause the system to determine, using the third machine learning model, a probability distribution for the plurality of user goals using the context representations associated with the response data and the goal representations associated with the plurality of user goals.

(I2) The system of (I1), where the response data is determined from measurements of the plurality of on-board sensors of the artificial reality device, the plurality of on-board sensors including wristbands, artificial reality glasses, EMG, IMUs, camera, microphone, haptics, voice interface, and peripheral sensors.

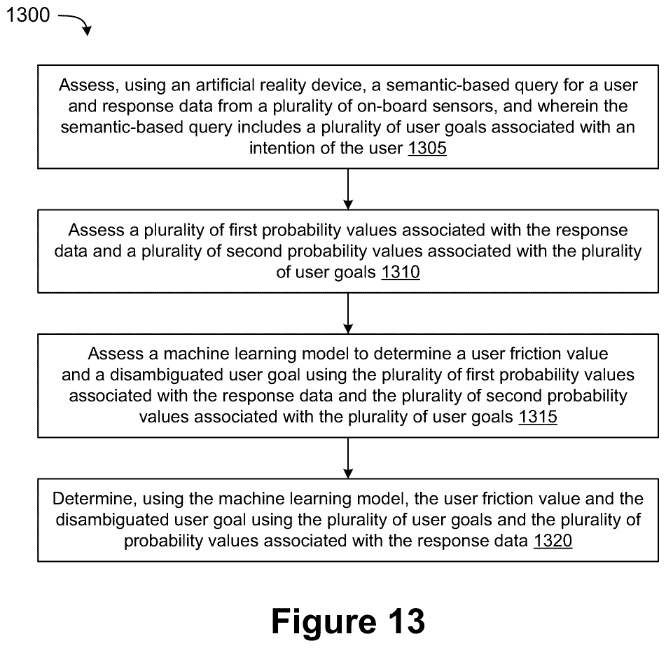

FIG. 13 illustrates an example method 1300 for determining a user friction value and a disambiguated user goal using a semantic-based query for a user. The method 1300 may begin at step 1305, where the computing system can obtain a semantic-based query for a user and response data from a plurality of on-board sensor. In particular embodiments, the semantic-based query can include a plurality of user goals associated with an intention of the user. In particular embodiments, the response data is determined from measurements of the plurality of on-board sensors of the artificial reality device, the plurality of on-board sensors including wristbands, artificial reality glasses, EMG, IMUs, camera, microphone, haptics, voice interface, and peripheral sensors. At step 1310, the method may use a server computer to assess a plurality of first probability values associated with the response data and a plurality of second probability values associated with the plurality of user goals. At step 1315, the method may use the server computer to assess a machine learning model to determine a user friction value and a disambiguated user goal using the plurality of first probability values associated with the response data and the plurality of second probability values associated with the plurality of user goals. In particular embodiments, the machine learning model is generated using a machine learning algorithm which includes an objective function based on a relative entropy using the plurality of first probability values associated with the response data and the plurality of second probability values associated with the user goals. In particular embodiments, the low friction human-machine interaction system 300 can determine a goal value alignment by a survey conducted by the user after terminating the interaction session with the artificial reality device based on the intention of the user. In particular embodiments, the low friction human-machine interaction system 300 can determine an initialization indicator using the user friction value and the goal value alignment. In particular embodiments, the low friction human-machine interaction system 300 can transmit a command (e.g., to a server computer) to perform an operation to terminate an interaction session with the artificial reality device when the user friction value is nearly zero.

In particular embodiments, the first machine learning model is applied to determine context representations associated with the response data using the response data from the plurality of on-board sensors. In particular embodiments, the second machine learning model is applied to determine goal representations associated with the plurality of user goals using the text descriptions of the plurality of user goals. In particular embodiments, the third machine learning model is applied to determine a probability distribution for the plurality of user goals using the context representations associated with the response data and the goal representations associated with the plurality of user goals.

Particular embodiments may repeat one or more steps of the method of FIG. 13, where appropriate. Although this disclosure describes and illustrates particular steps of the method of FIG. 13 as occurring in a particular order, this disclosure contemplates any suitable steps of the method of FIG. 13 occurring in any suitable order. Moreover, although this disclosure describes and illustrates an example method for determining a user friction value and a disambiguated user goal based on a semantic-based query for the user including the particular steps of the method of FIG. 13, this disclosure contemplates any suitable method for determining a user friction value and a disambiguated user goal based on a semantic-based query for the user including any suitable steps, which may include all, some, or none of the steps of the method of FIG. 13, where appropriate. Furthermore, although this disclosure describes and illustrates particular components, devices, or systems carrying out particular steps of the method of FIG. 13, this disclosure contemplates any suitable combination of any suitable components, devices, or systems carrying out any suitable steps of the method of FIG. 13.
(J1) A method performed, for example, by a computing system of an artificial reality device (e.g., headset 104, controller 106, HMD 110). The method includes assessing, using the artificial reality device, a semantic-based query for a user and response data from a plurality of on-board sensors. In some embodiments, the semantic-based query includes a plurality of user goals associated with an intention of the user. The method also includes assessing (e.g., using a server computer) a plurality of first probability values associated with the response data and a plurality of second probability values associated with the plurality of user goals. Additionally, the method includes assessing (e.g., using a server computer) a machine learning model to determine a user friction value and a disambiguated user goal using the plurality of first probability values associated with the response data and the plurality of second probability values associated with the plurality of user goals. Further, the method includes determining, using the machine learning model, the user friction value and the disambiguated user goal using the plurality of user goals and the plurality of probability values associated with the response data.
(J2) The method of (J1), further including, in response to determining the user friction value does not exceed a predetermined threshold, transmitting a command (e.g., to a server computer) to perform an operation to terminate an interaction session with the artificial reality device.
(J3) The method of (J2), further including, in response to determining the user friction value does not exceed the predetermined threshold, determining a goal value alignment by a survey conducted by the user after terminating the interaction session with the artificial reality device based on the intention of the user.
(J4) The method of any one of (J1) through (J3), where the plurality of second probability values associated with the user goals are determined using the plurality of first probability values associated with the response data based on Bayes' theorem.
(J5) The method of any one of (J1) through (J4), where the response data is determined from measurements of the plurality of on-board sensors of the artificial reality device, the plurality of on-board sensors comprising wristbands, artificial reality glasses, EMG, IMUs, camera, microphone, haptics, voice interface, and peripheral sensors.
(J6) The method of any one of (J1) through (J5), further including generating the machine learning model using an objective function which includes a relative entropy based on the plurality of first probability values associated with the response data and the plurality of second probability values associated with the user goals.
(J7) The method of any one of (J1) through (J6), further including determining an initialization indicator using the user friction value and the goal value alignment.
(J8) The method of any one of (J1) through (J7), further including generating a pareto front using the goal value alignment and the user friction value.
(K1) One or more non-transitory, computer-readable storage media embodying software that is operable when executed to assess, using an artificial reality device, a semantic-based query for a user and response data from a plurality of on-board sensors. In some embodiments, the semantic-based query includes a plurality of user goals associated with an intention of the user. The software is also operable when executed to assess (e.g., using a server computer) a plurality of first probability values associated with the response data and a plurality of second probability values associated with the plurality of user goals. Additionally, the software is operable when executed to assess (e.g., using a server computer) a machine learning model to determine a user friction value and a disambiguated user goal using the plurality of first probability values associated with the response data and the plurality of second probability values associated with the plurality of user goals. Further, the software is operable when executed to determine, using the machine learning model, the user friction value and the disambiguated user goal using the plurality of user goals and the plurality of probability values associated with the response data.
(K2) The one or more non-transitory, computer-readable media of (K1), where the software is further operable when executed to, in response to determining the user friction value does not exceed a predetermined threshold, transmit a command (e.g., to a server computer) to perform an operation to terminate an interaction session with the artificial reality device.
(K3) The one or more non-transitory, computer-readable media of either (K1) or (K2), where the software is further operable when executed to, in response to determining the user friction value does not exceed the predetermined threshold, determine a goal value alignment by a survey conducted by the user after terminating the interaction session with the artificial reality device based on the intention of the user.
(K4) The one or more non-transitory, computer-readable media of any one of (K1) through (K3), where the plurality of second probability values associated with the user goals are determined using the plurality of first probability values associated with the response data based on Bayes' theorem.
(K5) The one or more non-transitory, computer-readable media of any one of (K1) through (K4), where the response data is determined from measurements of the plurality of on-board sensors of the artificial reality device, the plurality of on-board sensors comprising wristbands, artificial reality glasses, electromyography EMG, IMUs, camera, microphone, haptics, voice interface, and peripheral sensors.
(K6) The one or more non-transitory, computer-readable media of any one of (K1) through (K5), where the software is further operable when executed to generate the machine learning model using an objective function which includes a relative entropy based on the plurality of first probability values associated with the response data and the plurality of second probability values associated with the user goals.
(K7) The one or more non-transitory, computer-readable media of any one of (K1) through (K6), where the software is further operable when executed to determine an initialization indicator using the user friction value and the goal value alignment.
(K8) The one or more non-transitory, computer-readable media of any one of (K1) through (K7), where the software is further operable when executed to generate a pareto front using the goal value alignment and the user friction value.
(L1) A system includes one or more processors (e.g., processor 1402) and one or more non-transitory, computer-readable media (e.g., memory 1404, storage 1406) coupled to one or more of the processors and comprising instructions operable when executed by one or more of the processors to cause the system to assess, using an artificial reality device, a semantic-based query for a user and response data from a plurality of on-board sensors. In some embodiments, the semantic-based query includes a plurality of user goals associated with an intention of the user. The instructions are also operable when executed to cause the system to assess (e.g., using a server computer) a plurality of first probability values associated with the response data and a plurality of second probability values associated with the plurality of user goals. Additionally, the instructions are operable when executed to cause the system to assess (e.g., using a server computer) a machine learning model to determine a user friction value and a disambiguated user goal using the plurality of first probability values associated with the response data and the plurality of second probability values associated with the plurality of user goals. Further, the instructions are operable when executed to cause the system to determine, using the machine learning model, the user friction value and the disambiguated user goal using the plurality of user goals and the plurality of probability values associated with the response data.
(L2) The system of (L1), wherein the instructions are further operable when executed by the one or more of the processors to cause the system to, in response to determining the user friction value does not exceed a predetermined threshold, transmit a command (e.g., to a server computer) to perform an operation to terminate an interaction session with the artificial reality device.
(L3) The system of either (L1) or (L2), where the instructions are further operable when executed by the one or more of the processors to cause the system to, in response to determining the user friction value does not exceed the predetermined threshold, determine a goal value alignment by a survey conducted by the user after terminating the interaction session with the artificial reality device based on the intention of the user.
(L4) The system of any one of (L1) through (L3), where the plurality of second probability values associated with the user goals are determined using the plurality of first probability values associated with the response data based on Bayes' theorem.

Below are additional details and embodiments that are intended to be combined with any other features described within this application. In some embodiments, differentiated technology modules power three main functionalities: (1) infer the user's goal, (2) present a dynamic UI to confirm the goal, and (3) take action to complete the corresponding task automatically.

As discussed above, the modules allow for human-computer interactions that empowers users to achieve their personalized goals with ultra-low friction. By shrinking the distance between human intent and action, wearable devices will be essential copilots that seamlessly integrate into users' daily routines, deliver real-time automated assistance toward personalized goals, and unlock proactive discovery of the world around us. While examples shown herein are specific, it is envisioned that such features can be embodied in different features across a variety of wearable products, all powered by the same core reusable, differentiated technology modules.

In some embodiments, the features described integrate tech modules within a single user-experience architecture aligned with a specific product form factor. In some embodiments, features across a spectrum of complexity are feasible, ranging from simple instantiations (e.g., dynamic AI-powered single-click shortcut) to more complete standalone operating system.

In some embodiments, one of the objectives of goal inference is to predict the user's goal (e.g., “focus on this conversation,” “share this moment”) using only contextual data generated by the AI device's perception stack. When the system can accurately predict the user's intended goal without any direct user intervention, it can dramatically reduce the effort needed from the user to communicate their intent into the device. And when goal inference is confident in its prediction, the system can proactively present the user with options to realize their goal with a single click, and—once trust is earned—be allowed to take action on the user's behalf without confirmation.

In some embodiments, one of the objective of the Goal Oriented Interface is to disambiguate the user's true underlying goal with minimal fiction, seeded by goal inference's prediction. While one version of the Goal Oriented Interface is a single-click shortcut, it can enable far richer goal disambiguation and interaction, rooted in a multimodal interaction language, AI that can compose contextually optimal UI elements, and interface concepts that ensure the user retains agency over AI prediction and automation. In some embodiments, the tech modules can include: an Eye identify module, an Optimal Query Generation module, and/or a Multimodal Generative UI Goal Realization module. Another objective of goal realization is to automatically invoke digital actions that realize the user's disambiguated goal. This allows the user to focus on what they want to do rather than the details of how to achieve it and enables real-time discoverability, as the Conductor can even invoke useful functionality that the user didn't know existed. Goal realization is currently focused on enabling automatic action in open-ended UI environments. In some embodiments, the tech modules include a goal interpreter module, an action compiler module, a conversations agent module.

In some embodiments, the system is a multimodal system that leverages multidevice models that can be fine-tuned for a variety of specialized downstream tasks to deliver both specialized tech modules, as well as a broader range of contextualized AI capabilities (e.g., embodied multimodal chatbot).

In some embodiments, the three main functionalities of the system are goal inference, providing a goal oriented interface, and goal realization. In some embodiments, goal inference maps available context to probability distribution over user goals. In some embodiments, the goal oriented interface disambiguates the user's true underlying goal with minimal friction via multimodal interaction. In some embodiments, goal realization automatically deploys digital actions that realizes the disambiguated goal.

In order to consistently produce high-value product features powered by the tech modules, the system utilize a process called User-Value Discovery Flywheel. This process is able to iteratively search through the possibility space and refine ideas into more concrete and compelling instantiations. At each phase, the system is improved by iterating through building, testing, and feedback, finding the proper balance between user value and technical feasibility.

In some embodiments, goal inference predicts the user's high-level goal using only egocentric-perception data. This capability significantly reduces the effort needed from the user to communicate their intent, and is the key to unlocking proactivity, as it allows the system to present the user options to achieve their goal automatically when the prediction is confident.

In some embodiments, the system maps available context to a probability distribution over user goals. In some embodiments, the goal inference can be instantiated for different instantiations of context and goals.

Three example models for goal inference include, (i) Socratic LLM, which converts perception data to text that is included in the LLM context window, (ii) Multimodal LLM, which converts perception data to token embeddings and is a specialized AnyMAL model, and (iii) Cortex models. In some embodiments, the dataset can contain around 20 hours of video across 18 participants, and 417 sessions, and contains rich in-situ annotations of goals and actions. In some embodiments, each one of these models can be done using different support sets that include one of a zero-shot support set, a population support set, and within-user support set.

In some embodiments, the results showed that the models achieve a friction reduction of ˜70% at 80% value alignment. In some embodiments, that the Socratic LLM currently outperforms the multimodal LLM approach.

In some embodiments, the system is equipped with an ability to reference objects in a low-friction manner. This module enables precise in-world referencing for scene-based query experiences to provide more precise queries with or without voice, such as “What species is this?” while referring to a plant. In some embodiments, it can also be used to launch goal inference (without proactivity), providing strong signal regarding interaction intent. In some embodiments, this module is focused on inferring the likelihood that users' intend to interact with entities in the world, which can be used to modulate sensors to optimize usage of power (e.g., turn on high resolution cameras when intent to interact with an entity is high) and to optimize storage of relevant entities.

In some embodiments, the system is configured to map egocentric video and gaze to a referenced object. In some embodiments, the models used are produced using (i) a nearest-neighbor proximity of gaze direction when pinch occurs to bounding box centers and (ii) a Bayesian approach with likelihoods based on visual saliency and gaze distribution per target.

In some embodiments, an optimal query generation (OQG) includes four guideposts for increasing the complexity and generalizability for our framework. All four complexity aspects impact modeling and play a significant role in identifying core benchmarks. As the complexity and backend investment increases in terms of these four key complexity aspects, so too does the flexibility and generality of the setting. The complexity regimes are in some embodiments: (CA1) spaces of goals, queries, and responses: finite, discrete, continuous, dynamic, as relevant, following guidance from the other modules. Expressivity of queries is fundamentally limited by the size of the response space (e.g., binary vs. categorical vs. higher bandwidth), (CA2) optimization: globally vs. locally/greedily optimal, and associated efficient and implementable algorithms, (CA3) tractability (of prior and likelihood): can evaluate and simulate from, can only evaluate up to a normalizing constant, can only simulate, and (CA4) likelihood: perfectly disambiguating (PD) or not PD responses.

In some embodiments, the system is equipped with the ability to generate visual and multimodal user interfaces, on demand, for highly contextual and individualized user goals. This capability unlocks open-set experiences without requiring each experience to be anticipated and designed for in advance. In some embodiments, enabling Generative UI is to imbue the AI system with a library of design patterns and principles to ensure predictability, consistency, and usability in generated user interfaces.

In some embodiments, goal interpreter is the goal realization module responsible for decomposing a high-level goal into a sequence of low-level digital action (ADGs) that can be carried about by the action compiler, one-by-one. It reasons, at a high level, over a library of digital tools (action space) to employ to realize a goal. In some embodiments, generic form of goal interpreter takes as input a goal [string], manually input by a user, or output from the goal inference module and is conditioned on (i) an action space, and [optionally] (ii) physical context and (iii) digital context. The output of goal inference is a set or sequence of low-level digital actions. GLINT output can be constrained to generate an action sequence that are elements of the action space, or open set where GLINT can be informed by the action space, but suggest other actions that it has knowledge of through pretraining.

Three models for Goal Interpreter are provided, these three models are (i) Socratic LLM, which converts perception data to text that is included in the LLM context window, multimodal LLM, which converts perception data to token embeddings and is a specialized AnyMAL model, and Cortex models. In some embodiments, each one of these models can be done using different support sets that include one of a zero-shot support set, a population support set, and within-user support set.

Action compiler is the last step of the goal realization module and it is responsible for carrying out the low-level actions inferred by the goal interpreter (ADGs) on a concrete digital embodiment (e.g. an dedicated OS, web browser, or REST APIs). There are at least two classes of models that can be used for action compiler: (i) plugin style (support for a limited set of APIs) and (ii) Visual Language Action Models (VLAMs) in the form of a general purpose UI navigating agent.

In some embodiments, the conversation agent reduces friction and effort incurred during conversations. In some embodiments, the conversation agent is able to provide features such as automatic note taking, action item generation, enhanced hearing, and multilingual translation.

The conversation agent in one use case enables the user to engage in a face-to-face conversation with another human without having to worry about tedious and distracting tasks, such as note-taking, summarization of a meeting, remembering action items, setting reminders and calendar invites, etc. In some embodiments, the agent can also work with direct user-system interactions, as well as proactive scenarios where the system proactively understands the situation and engages in supporting the user without the need for the user to directly activate the system.

The conversation agent, in some embodiments, leverages LLMs for goal inference within a conversation setting. In some embodiments, the system takes the transcript of a conversation into account and when queried (via pinch) the system responds with the top three inferred goals and associated action plans generated from conversational context. The top actions are generated through Goal Inference, and, in some embodiments, the actions are displayed on both the wristband interface and phone interface.

As discussed above, in some embodiments goal inference can use an LLaMA-2-70B-chat-hf language model. In some embodiments, the perception model can vary, either using the Socratic Modeling approach, which encodes visual representations as textual descriptions leveraging BLIP-2, or AnyMAL, which encodes visual representations as embeddings that share a latent space with the LLaMA tokenizer via the training of a projection layer.

In some embodiments, the context fed into the LLM for Goal Inference includes visual perception and the previous digital actions of the user. A proposed goal is retrieved from the most visually similar video clip in the support set (see Retrieval section below). If the support set is the empty set, this mode is referred to as “zero-shot.” The goal inference prompt is built using the set of goals, and the model's task is to rank order the set of goals from most to least likely.

In some embodiments, goal interpreter also uses the LLaMA-2-70B-chat-hf language model and the same perception models as goal inference. In some embodiments, the context for goal interpreter includes visual perception, previous digital actions of the user, and a list of canonical affordances. A proposed action sequence is retrieved from the most visually similar video clip in the subset of the support set where the labeled goal matches the query goal. In some embodiments, the goal of the user is provided in the prompt. In some embodiments, the task of the goal interpreter model is to produce the three most likely action sequences that satisfy the goal given the affordances, user context, and personalization context.

In some embodiments, the action compiler module treats the natural language actions produced by the goal interpreter model (for example: “show stock price of meta”) and translates them to structured action invocations, which are system executable ({“name”: “Finance.showStock”, “args”: {“company”: “ABC Corp.”}}). Like goal inference and goal interpreter, action compiler also utilizes the LLaMA-2-70B-chat-hf language model[i][j]. In some embodiments, the action compiler first employs similarity-based retrieval to narrow down the large space of available system actions and retrieves only the system actions relevant for the natural language action specification. It then populates a prompt with the retrieved system action templates and their descriptions and asks the LLM to choose the correct action template along with the required argument values, thereby generating a system action invocation. In some embodiments, the output of action compiler is a sequence of structured actions for each action sequence produced by goal interpreter. This allows the system to execute the actions in the digital environment.

In some embodiments, the support sets are often too big to input directly into the prompt for either goal inference or goal interpreter. In some embodiments, to sparsify the support set, an embedding-based retrieval mechanism is used to sparsify the input. This retrieval process utilizes EgoVLP to extract embeddings of 15-second duration video clips, each anchored to an annotation. This allows for the computation of pairwise similarity between all clip embeddings. For a given query clip, all clips in the support set can be rank-ordered from most to least similar. Since each clip is associated with a goal and action sequence, the top K most similar goals and action sequences can be retrieved for a given query clip.

In some embodiments, training data for any of the machine learning models discussed herein contains numerous (e.g., 300, 400, 500) sessions recorded by different (e.g., 10, 20, 30) individuals (e.g., comprising 10, 20, 30 hours of video). In some embodiments, these sessions are recorded using an augmented reality device (e.g., HMD 110, artificial reality device 1700), with interaction tracking and/or goal annotation through a corresponding mobile application.

In some embodiments, this training data is recorded by individuals instructed to record multiple sessions for multiple (e.g., 5, 10, 15) different scenarios (e.g., morning snack scenario, cooking food, stain removal, leaving home, exercise routine, focused work routine). In some embodiments, some of the scenarios require the participant to perform a sequence of actions that support a single high level goal. Given that one of the primary modeling tasks is to infer a user's goal, the scenarios may be selected to span different home environments such that multiple scenarios would take place in the same location, which can make it difficult or impossible to predict a user's goal based solely on the user's surroundings.

In some embodiments, a system is configured to infer the user's goal and then predict a suitable sequence of actions to achieve that goal. This point in time marks the end of the “context window,” and it is generally triggered when the user clicks an app and enters the annotation screen in the mobile application (e.g., annotating the window as relevant to a particular goal). Given a context window, the system can determine which subsequent action annotations correspond to the context. For example, for all scenarios other than “exercise routine,” the system can assume that there is only one high level goal being performed as scripted and so all annotated actions are bundled together and associated with the first context. In some cases, gaps are observed where the user interacts with their environment in between actions. Normally, these interactions could be considered new context windows, but to standardize ground truth action sequences, actions can be bundled across these potential context windows (observing that given the scripting, it would have been valid if the user did all of the actions at once without any gaps). As another example, for the “exercise routine,” where two separate action sequences are expected (e.g., get ready for exercise routine and finish exercise routine), app logs can be utilized to infer when the user has completed their first goal and then new context window can begin, with the new window generally including the time period where the user is actually exercising.

In some embodiments, the system performs alignment on the structured action space, yielding a measurement of the utility of realizable system actions.

In some embodiments, training data and corresponding benchmarks are based on multi-action prediction. Additionally, in some embodiments, the system is configured to consider more than just the “zero-shot” case. For example, the system can be configured to consider user- and population-based retrieval.

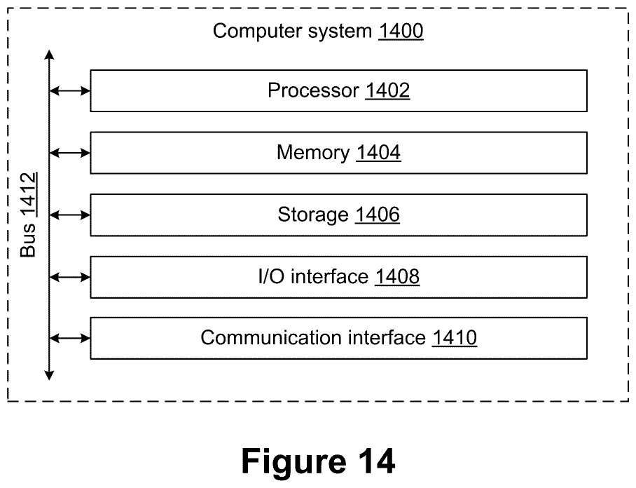

FIG. 14 illustrates an example computer system 1400. In particular embodiments, one or more computer systems 1400 perform one or more steps of one or more methods described or illustrated herein. In particular embodiments, one or more computer systems 1400 provide functionality described or illustrated herein. In particular embodiments, software running on one or more computer systems 1400 performs one or more steps of one or more methods described or illustrated herein or provides functionality described or illustrated herein. Particular embodiments include one or more portions of one or more computer systems 1400. Herein, reference to a computer system may encompass a computing device, and vice versa, where appropriate. Moreover, reference to a computer system may encompass one or more computer systems, where appropriate.

This disclosure contemplates any suitable number of computer systems 1400. This disclosure contemplates computer system 1400 taking any suitable physical form. As example and not by way of limitation, computer system 1400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1400 may include one or more computer systems 1400; be unitary or distributed; span multiple locations; span multiple machines; span multiple data centers; or reside in a cloud, which may include one or more cloud components in one or more networks. Where appropriate, one or more computer systems 1400 may perform without substantial spatial or temporal limitation one or more steps of one or more methods described or illustrated herein. As an example and not by way of limitation, one or more computer systems 1400 may perform in real time or in batch mode one or more steps of one or more methods described or illustrated herein. One or more computer systems 1400 may perform at different times or at different locations one or more steps of one or more methods described or illustrated herein, where appropriate.

In particular embodiments, computer system 1400 includes a processor 1402, memory 1404, storage 1406, an input/output (I/O) interface 1408, a communication interface 1410, and a bus 1412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1402 includes hardware for executing instructions, such as those making up a computer program. As an example and not by way of limitation, to execute instructions, processor 1402 may retrieve (or fetch) the instructions from an internal register, an internal cache, memory 1404, or storage 1406; decode and execute them; and then write one or more results to an internal register, an internal cache, memory 1404, or storage 1406. In particular embodiments, processor 1402 may include one or more internal caches for data, instructions, or addresses. This disclosure contemplates processor 1402 including any suitable number of any suitable internal caches, where appropriate. As an example and not by way of limitation, processor 1402 may include one or more instruction caches, one or more data caches, and one or more translation lookaside buffers (TLBs). Instructions in the instruction caches may be copies of instructions in memory 1404 or storage 1406, and the instruction caches may speed up retrieval of those instructions by processor 1402. Data in the data caches may be copies of data in memory 1404 or storage 1406 for instructions executing at processor 1402 to operate on; the results of previous instructions executed at processor 1402 for access by subsequent instructions executing at processor 1402 or for writing to memory 1404 or storage 1406; or other suitable data. The data caches may speed up read or write operations by processor 1402. The TLBs may speed up virtual-address translation for processor 1402. In particular embodiments, processor 1402 may include one or more internal registers for data, instructions, or addresses. This disclosure contemplates processor 1402 including any suitable number of any suitable internal registers, where appropriate. Where appropriate, processor 1402 may include one or more arithmetic logic units (ALUs); be a multi-core processor; or include one or more processors 1402. Although this disclosure describes and illustrates a particular processor, this disclosure contemplates any suitable processor.

In particular embodiments, memory 1404 includes main memory for storing instructions for processor 1402 to execute or data for processor 1402 to operate on. As an example and not by way of limitation, computer system 1400 may load instructions from storage 1406 or another source (such as, for example, another computer system 1400) to memory 1404. Processor 1402 may then load the instructions from memory 1404 to an internal register or internal cache. To execute the instructions, processor 1402 may retrieve the instructions from the internal register or internal cache and decode them. During or after execution of the instructions, processor 1402 may write one or more results (which may be intermediate or final results) to the internal register or internal cache. Processor 1402 may then write one or more of those results to memory 1404. In particular embodiments, processor 1402 executes only instructions in one or more internal registers or internal caches or in memory 1404 (as opposed to storage 1406 or elsewhere) and operates only on data in one or more internal registers or internal caches or in memory 1404 (as opposed to storage 1406 or elsewhere). One or more memory buses (which may each include an address bus and a data bus) may couple processor 1402 to memory 1404. Bus 1412 may include one or more memory buses, as described below. In particular embodiments, one or more memory management units (MMUs) reside between processor 1402 and memory 1404 and facilitate accesses to memory 1404 requested by processor 1402. In particular embodiments, memory 1404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1404 may include one or more memories 1404, where appropriate. Although this disclosure describes and illustrates particular memory, this disclosure contemplates any suitable memory.

In particular embodiments, storage 1406 includes mass storage for data or instructions. As an example and not by way of limitation, storage 1406 may include a hard disk drive (HDD), a floppy disk drive, flash memory, an optical disc, a magneto-optical disc, magnetic tape, or a Universal Serial Bus (USB) drive or a combination of two or more of these. Storage 1406 may include removable or non-removable (or fixed) media, where appropriate. Storage 1406 may be internal or external to computer system 1400, where appropriate. In particular embodiments, storage 1406 is non-volatile, solid-state memory. In particular embodiments, storage 1406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1406 taking any suitable physical form. Storage 1406 may include one or more storage control units facilitating communication between processor 1402 and storage 1406, where appropriate. Where appropriate, storage 1406 may include one or more storages 1406. Although this disclosure describes and illustrates particular storage, this disclosure contemplates any suitable storage.

In particular embodiments, I/O interface 1408 includes hardware, software, or both, providing one or more interfaces for communication between computer system 1400 and one or more I/O devices. Computer system 1400 may include one or more of these I/O devices, where appropriate. One or more of these I/O devices may enable communication between a person and computer system 1400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1408 for them. Where appropriate, I/O interface 1408 may include one or more device or software drivers enabling processor 1402 to drive one or more of these I/O devices. I/O interface 1408 may include one or more I/O interfaces 1408, where appropriate. Although this disclosure describes and illustrates a particular I/O interface, this disclosure contemplates any suitable I/O interface.

In particular embodiments, communication interface 1410 includes hardware, software, or both providing one or more interfaces for communication (such as, for example, packet-based communication) between computer system 1400 and one or more other computer systems 1400 or one or more networks. As an example and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1410 for it. As an example and not by way of limitation, computer system 1400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1400 may include any suitable communication interface 1410 for any of these networks, where appropriate. Communication interface 1410 may include one or more communication interfaces 1410, where appropriate. Although this disclosure describes and illustrates a particular communication interface, this disclosure contemplates any suitable communication interface.

In particular embodiments, bus 1412 includes hardware, software, or both coupling components of computer system 1400 to each other. As an example and not by way of limitation, bus 1412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1412 may include one or more buses 1412, where appropriate. Although this disclosure describes and illustrates a particular bus, this disclosure contemplates any suitable bus or interconnect.

Herein, a non-transitory, computer-readable storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable non-transitory, computer-readable storage media, or any suitable combination of two or more of these, where appropriate. A non-transitory, computer-readable storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The devices described above are further detailed below, including systems, wrist-wearable devices, and headset devices. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 1600, a head-wearable device, an HIPD 1800, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogramhy (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory, computer-readable storage media are physical devices or storage medium that can be used to store electronic data in a non-transitory form (e.g., such that the data is stored permanently until it is intentionally deleted or modified).

### Example Artificial Reality Systems

The following paragraphs regard example artificial reality systems 1500a-1500c, which are similar to the artificial reality systems 100A and 100B discussed above with respect to FIGS. 1A and 1B. The artificial reality systems heretofore discussed include elements similar to those described above. Accordingly, the elements discussed above and the discussion corresponding thereto is applicable to elements heretofore discussed insofar as those elements correspond in form or function (e.g., controller 106 and HIPD 1800).

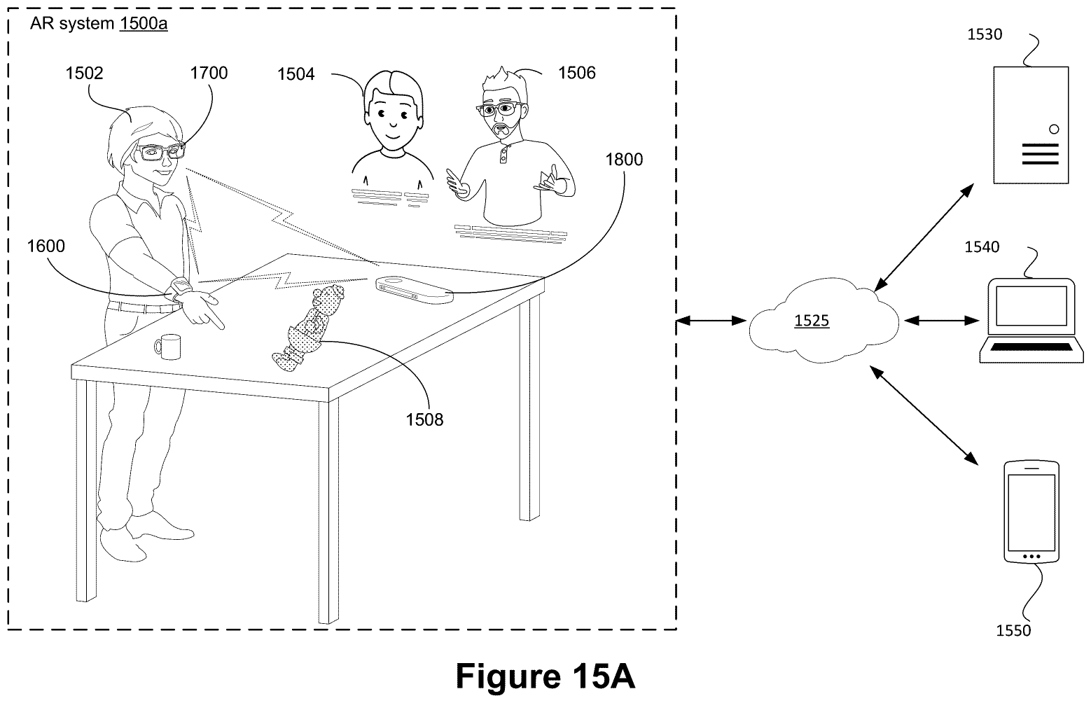

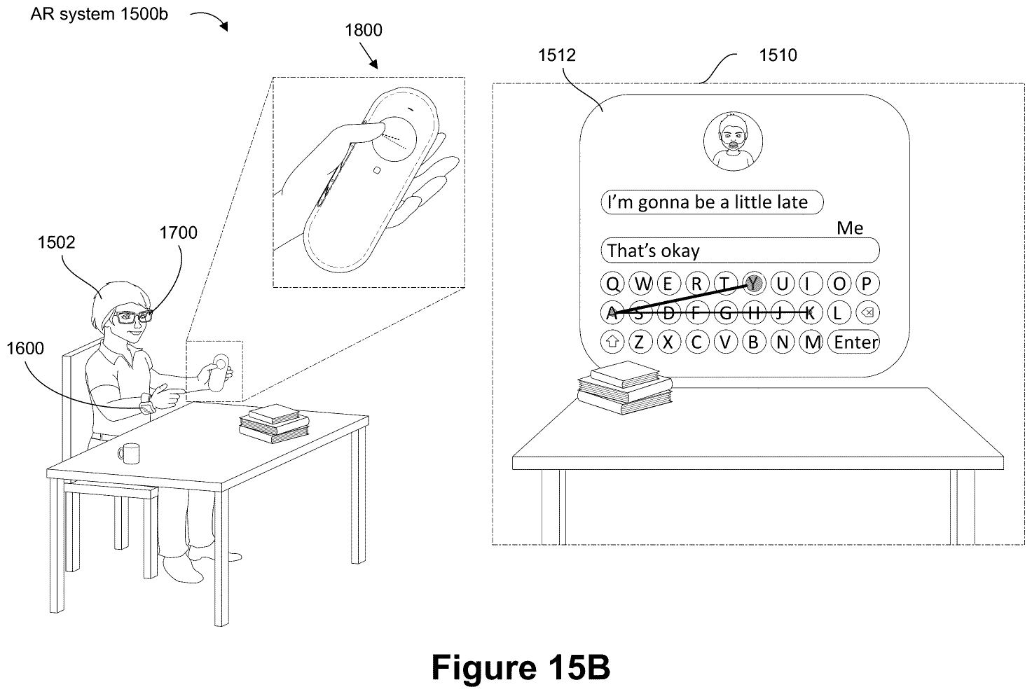

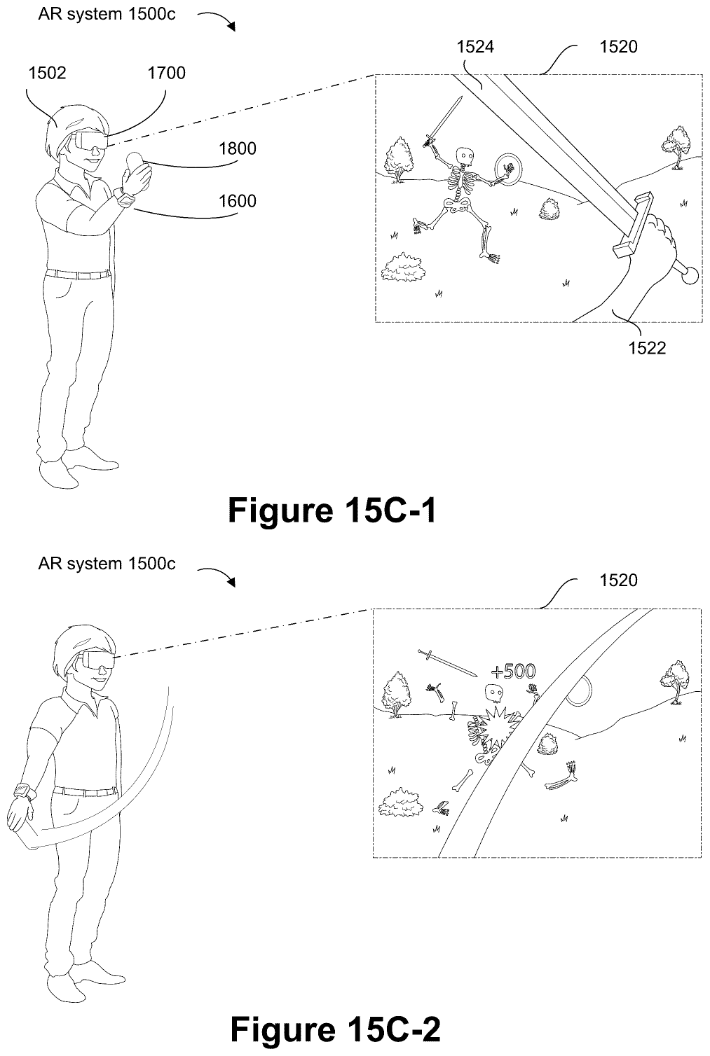

FIGS. 15A 15B, 15C-1, and 15C-2 illustrate example artificial-reality systems, in accordance with some embodiments. FIG. 15A shows a first artificial reality system 1500a and first example user interactions using a wrist-wearable device 1600, a head-wearable device (e.g., artificial reality device 1700), and/or a handheld intermediary processing device (HIPD) 1800. FIG. 15B shows a second artificial reality system 1500b and second example user interactions using a wrist-wearable device 1600, artificial reality device 1700, and/or an HIPD 1800. FIGS. 15C-1 and 15C-2 show a third artificial reality system 1500c and third example user interactions using a wrist-wearable device 1600, a head-wearable device (e.g., virtual-reality (VR) device 1710), and/or an HIPD 1800. As the skilled artisan will appreciate upon reading the descriptions provided herein, the above-example artificial reality systems (described in detail below) can perform various functions and/or operations.

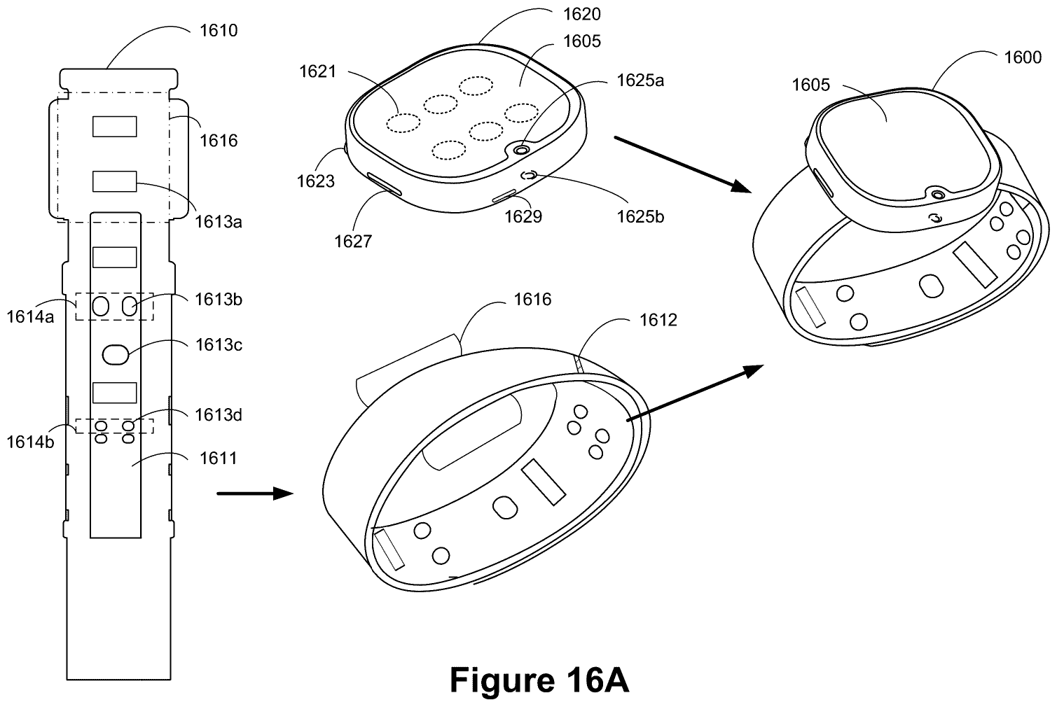

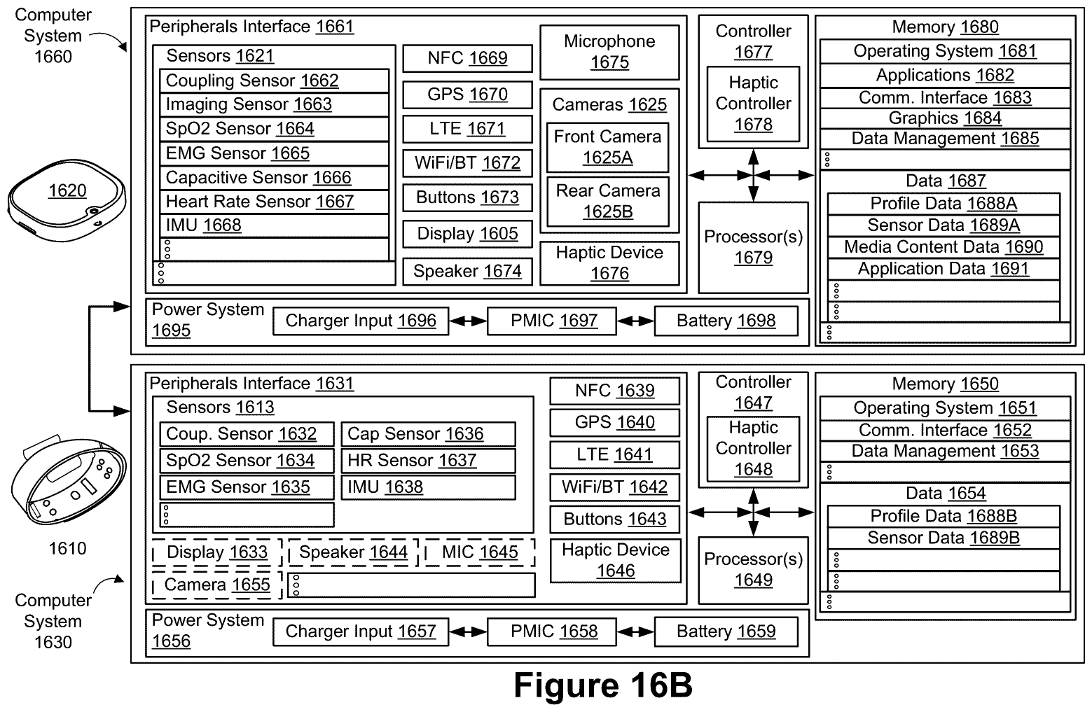

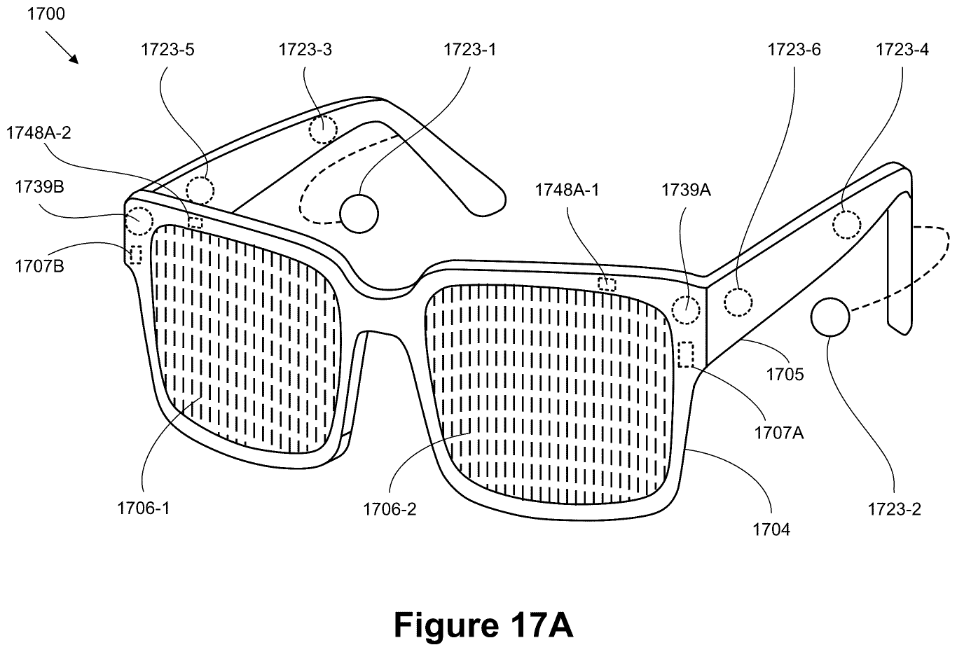

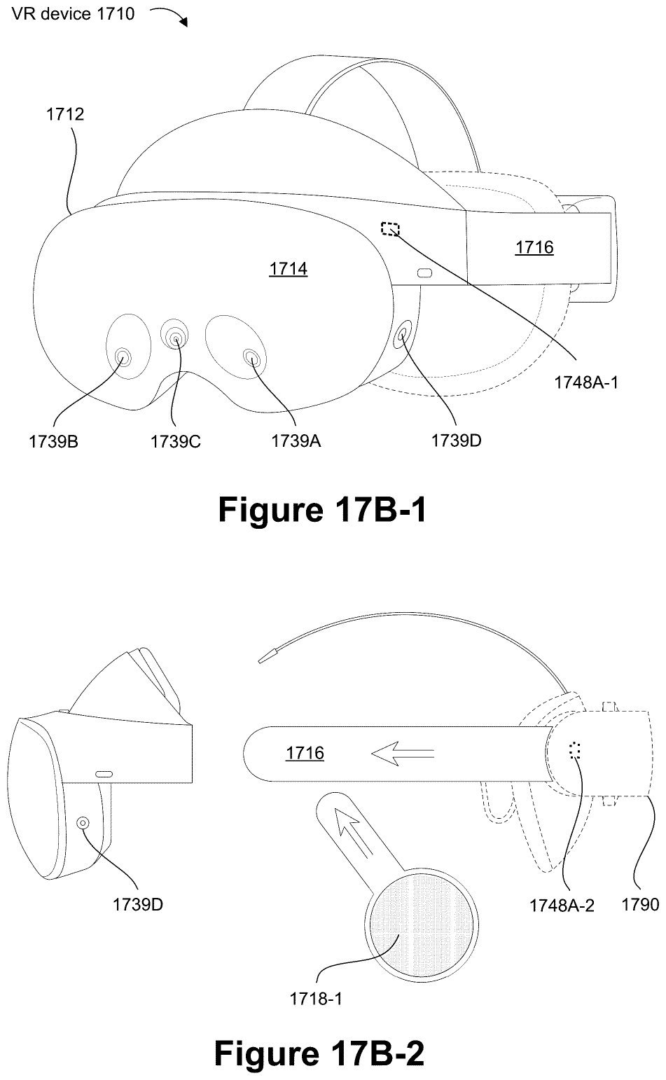

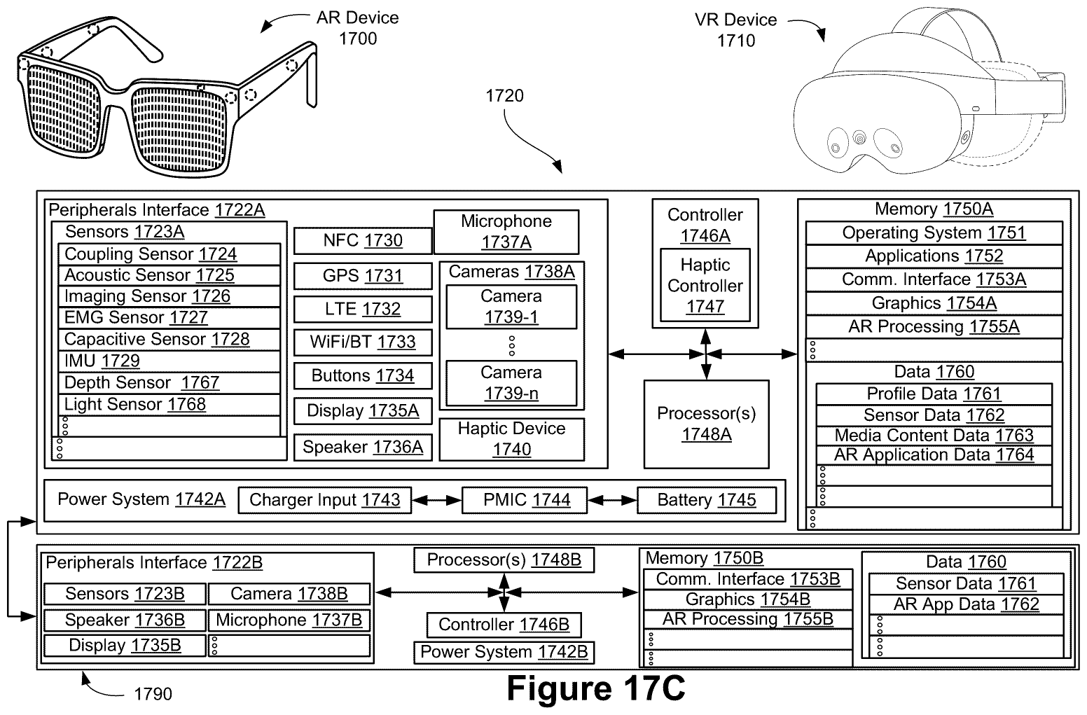

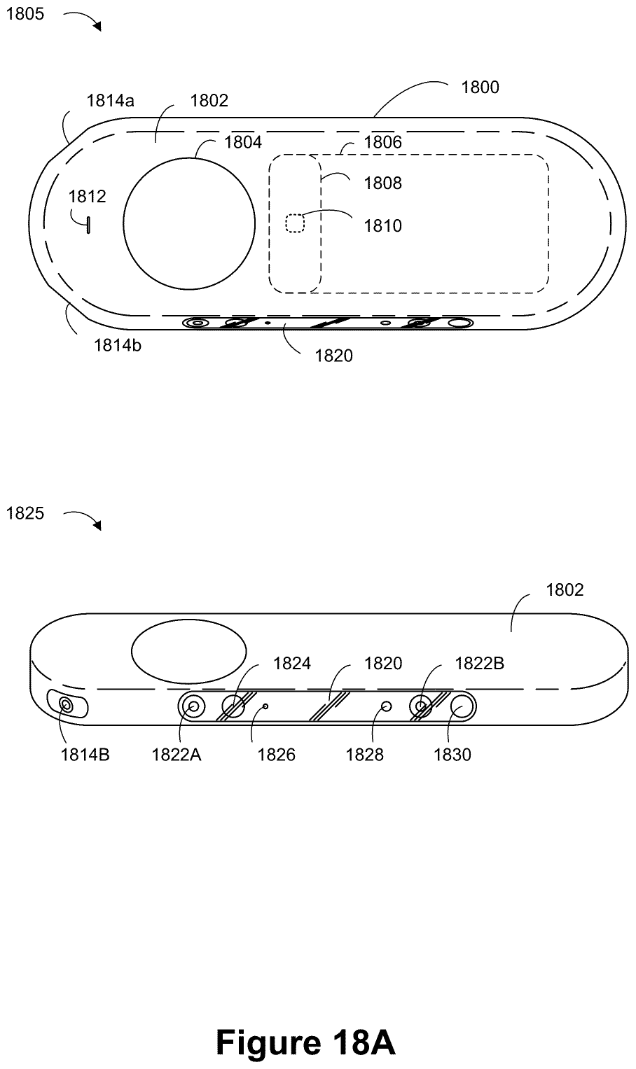

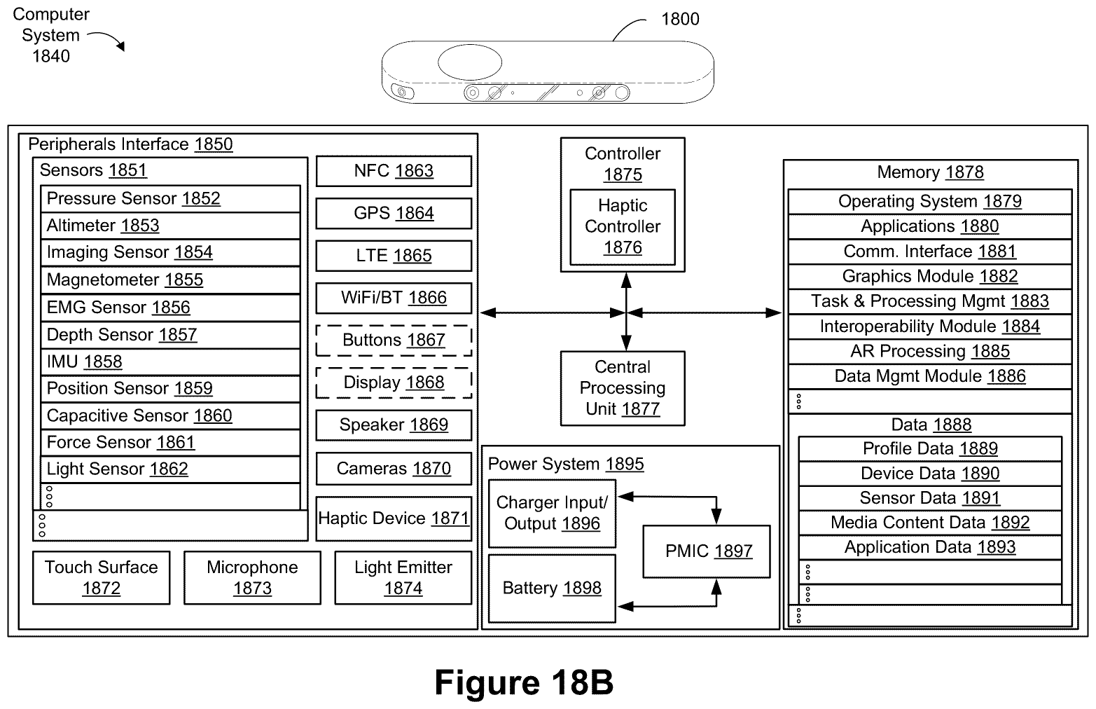

The wrist-wearable device 1600 and its constituent components are described below in reference to FIGS. 16A-16B, the head-wearable devices and their constituent components are described below in reference to FIGS. 17A-17D, and the HIPD 1800 and its constituent components are described below in reference to FIGS. 18A-18B. The wrist-wearable device 1600, the head-wearable devices, and/or the HIPD 1800 can communicatively couple via a network 1525 (e.g., cellular, near field, Wi-Fi, personal area network, wireless LAN, etc.). Additionally, the wrist-wearable device 1600, the head-wearable devices, and/or the HIPD 1800 can also communicatively couple with one or more servers 1530, computers 1540 (e.g., laptops, computers, etc.), mobile devices 1550 (e.g., smartphones, tablets, etc.), and/or other electronic devices via the network 1525 (e.g., cellular, near field, Wi-Fi, personal area network, wireless LAN, etc.).

Turning to FIG. 15A, a user 1502 is shown wearing the wrist-wearable device 1600 and the artificial reality device 1700, and having the HIPD 1800 on their desk. The wrist-wearable device 1600, the artificial reality device 1700, and the HIPD 1800 facilitate user interaction with an artificial reality environment. In particular, as shown by the first artificial reality system 1500a, the wrist-wearable device 1600, the artificial reality device 1700, and/or the HIPD 1800 cause presentation of one or more avatars 1504, digital representations of contacts 1506, and virtual objects 1508. As discussed below, the user 1502 can interact with the one or more avatars 1504, digital representations of the contacts 1506, and virtual objects 1508 via the wrist-wearable device 1600, the artificial reality device 1700, and/or the HIPD 1800.

The user 1502 can use any of the wrist-wearable device 1600, the artificial reality device 1700, and/or the HIPD 1800 to provide user inputs. For example, the user 1502 can perform one or more hand gestures that are detected by the wrist-wearable device 1600 (e.g., using one or more EMG sensors and/or IMUs, described below in reference to FIGS. 16A-16B) and/or artificial reality device 1700 (e.g., using one or more image sensors or cameras, described below in reference to FIGS. 17A-17B) to provide a user input. Alternatively, or additionally, the user 1502 can provide a user input via one or more touch surfaces of the wrist-wearable device 1600, the artificial reality device 1700, and/or the HIPD 1800, and/or voice commands captured by a microphone of the wrist-wearable device 1600, the artificial reality device 1700, and/or the HIPD 1800. In some embodiments, the wrist-wearable device 1600, the artificial reality device 1700, and/or the HIPD 1800 include a digital assistant to help the user in providing a user input (e.g., completing a sequence of operations, suggesting different operations or commands, providing reminders, confirming a command). In some embodiments, the user 1502 can provide a user input via one or more facial gestures and/or facial expressions. For example, cameras of the wrist-wearable device 1600, the artificial reality device 1700, and/or the HIPD 1800 can track the user 1502's eyes for navigating a user interface.

The wrist-wearable device 1600, the artificial reality device 1700, and/or the HIPD 1800 can operate alone or in conjunction to allow the user 1502 to interact with the artificial reality environment. In some embodiments, the HIPD 1800 is configured to operate as a central hub or control center for the wrist-wearable device 1600, the artificial reality device 1700, and/or another communicatively coupled device. For example, the user 1502 can provide an input to interact with the artificial reality environment at any of the wrist-wearable device 1600, the artificial reality device 1700, and/or the HIPD 1800, and the HIPD 1800 can identify one or more back-end and front-end tasks to cause the performance of the requested interaction and distribute instructions to cause the performance of the one or more back-end and front-end tasks at the wrist-wearable device 1600, the artificial reality device 1700, and/or the HIPD 1800. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 18A-18B, the HIPD 1800 can perform the back-end tasks and provide the wrist-wearable device 1600 and/or the artificial reality device 1700 operational data corresponding to the performed back-end tasks such that the wrist-wearable device 1600 and/or the artificial reality device 1700 can perform the front-end tasks. In this way, the HIPD 1800, which has more computational resources and greater thermal headroom than the wrist-wearable device 1600 and/or the artificial reality device 1700, performs computationally intensive tasks and reduces the computer resource utilization and/or power usage of the wrist-wearable device 1600 and/or the artificial reality device 1700.

In the example shown by the first artificial reality system 1500a, the HIPD 1800 identifies one or more back-end tasks and front-end tasks associated with a user request to initiate an artificial reality video call with one or more other users (represented by the avatar 1504 and the digital representation of the contact 1506) and distributes instructions to cause the performance of the one or more back-end tasks and front-end tasks. In particular, the HIPD 1800 performs back-end tasks for processing and/or rendering image data (and other data) associated with the artificial reality video call and provides operational data associated with the performed back-end tasks to the artificial reality device 1700 such that the artificial reality device 1700 performs front-end tasks for presenting the artificial reality video call (e.g., presenting the avatar 1504 and the digital representation of the contact 1506).

In some embodiments, the HIPD 1800 can operate as a focal or anchor point for causing the presentation of information. This allows the user 1502 to be generally aware of where information is presented. For example, as shown in the first artificial reality system 1500a, the avatar 1504 and the digital representation of the contact 1506 are presented above the HIPD 1800. In particular, the HIPD 1800 and the artificial reality device 1700 operate in conjunction to determine a location for presenting the avatar 1504 and the digital representation of the contact 1506. In some embodiments, information can be presented within a predetermined distance from the HIPD 1800 (e.g., within five meters). For example, as shown in the first artificial reality system 1500a, virtual object 1508 is presented on the desk some distance from the HIPD 1800. Similar to the above example, the HIPD 1800 and the artificial reality device 1700 can operate in conjunction to determine a location for presenting the virtual object 1508. Alternatively, in some embodiments, presentation of information is not bound by the HIPD 1800. More specifically, the avatar 1504, the digital representation of the contact 1506, and the virtual object 1508 do not have to be presented within a predetermined distance of the HIPD 1800.

User inputs provided at the wrist-wearable device 1600, the artificial reality device 1700, and/or the HIPD 1800 are coordinated such that the user can use any device to initiate, continue, and/or complete an operation. For example, the user 1502 can provide a user input to the artificial reality device 1700 to cause the artificial reality device 1700 to present the virtual object 1508 and, while the virtual object 1508 is presented by the artificial reality device 1700, the user 1502 can provide one or more hand gestures via the wrist-wearable device 1600 to interact and/or manipulate the virtual object 1508.

FIG. 15B shows the user 1502 wearing the wrist-wearable device 1600 and the artificial reality device 1700, and holding the HIPD 1800. In the second artificial reality system 1500b, the wrist-wearable device 1600, the artificial reality device 1700, and/or the HIPD 1800 are used to receive and/or provide one or more messages to a contact of the user 1502. In particular, the wrist-wearable device 1600, the artificial reality device 1700, and/or the HIPD 1800 detect and coordinate one or more user inputs to initiate a messaging application and prepare a response to a received message via the messaging application.

In some embodiments, the user 1502 initiates, via a user input, an application on the wrist-wearable device 1600, the artificial reality device 1700, and/or the HIPD 1800 that causes the application to initiate on at least one device. For example, in the second artificial reality system 1500b the user 1502 performs a hand gesture associated with a command for initiating a messaging application (represented by messaging user interface 1512); the wrist-wearable device 1600 detects the hand gesture; and, based on a determination that the user 1502 is wearing artificial reality device 1700, causes the artificial reality device 1700 to present a messaging user interface 1512 of the messaging application. The artificial reality device 1700 can present the messaging user interface 1512 to the user 1502 via its display (e.g., as shown by user 1502's field of view 1510). In some embodiments, the application is initiated and can be run on the device (e.g., the wrist-wearable device 1600, the artificial reality device 1700, and/or the HIPD 1800) that detects the user input to initiate the application, and the device provides another device operational data to cause the presentation of the messaging application. For example, the wrist-wearable device 1600 can detect the user input to initiate a messaging application, initiate and run the messaging application, and provide operational data to the artificial reality device 1700 and/or the HIPD 1800 to cause presentation of the messaging application. Alternatively, the application can be initiated and run at a device other than the device that detected the user input. For example, the wrist-wearable device 1600 can detect the hand gesture associated with initiating the messaging application and cause the HIPD 1800 to run the messaging application and coordinate the presentation of the messaging application.

Further, the user 1502 can provide a user input provided at the wrist-wearable device 1600, the artificial reality device 1700, and/or the HIPD 1800 to continue and/or complete an operation initiated at another device. For example, after initiating the messaging application via the wrist-wearable device 1600 and while the artificial reality device 1700 presents the messaging user interface 1512, the user 1502 can provide an input at the HIPD 1800 to prepare a response (e.g., shown by the swipe gesture performed on the HIPD 1800). The user 1502's gestures performed on the HIPD 1800 can be provided and/or displayed on another device. For example, the user 1502's swipe gestures performed on the HIPD 1800 are displayed on a virtual keyboard of the messaging user interface 1512 displayed by the artificial reality device 1700.

In some embodiments, the wrist-wearable device 1600, the artificial reality device 1700, the HIPD 1800, and/or other communicatively coupled devices can present one or more notifications to the user 1502. The notification can be an indication of a new message, an incoming call, an application update, a status update, etc. The user 1502 can select the notification via the wrist-wearable device 1600, the artificial reality device 1700, or the HIPD 1800 and cause presentation of an application or operation associated with the notification on at least one device. For example, the user 1502 can receive a notification that a message was received at the wrist-wearable device 1600, the artificial reality device 1700, the HIPD 1800, and/or other communicatively coupled device and provide a user input at the wrist-wearable device 1600, the artificial reality device 1700, and/or the HIPD 1800 to review the notification, and the device detecting the user input can cause an application associated with the notification to be initiated and/or presented at the wrist-wearable device 1600, the artificial reality device 1700, and/or the HIPD 1800.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the artificial reality device 1700 can present to the user 1502 game application data and the HIPD 1800 can use a controller to provide inputs to the game. Similarly, the user 1502 can use the wrist-wearable device 1600 to initiate a camera of the artificial reality device 1700, and the user can use the wrist-wearable device 1600, the artificial reality device 1700, and/or the HIPD 1800 to manipulate the image capture (e.g., zoom in or out, apply filters, etc.) and capture image data.

Turning to FIGS. 15C-1 and 15C-2, the user 1502 is shown wearing the wrist-wearable device 1600 and a VR device 1710, and holding the HIPD 1800. In the third artificial reality system 1500c, the wrist-wearable device 1600, the VR device 1710, and/or the HIPD 1800 are used to interact within an artificial reality environment, such as a VR game or other artificial reality application. While the VR device 1710 present a representation of a VR game (e.g., first artificial reality game environment 1520) to the user 1502, the wrist-wearable device 1600, the VR device 1710, and/or the HIPD 1800 detect and coordinate one or more user inputs to allow the user 1502 to interact with the VR game.

In some embodiments, the user 1502 can provide a user input via the wrist-wearable device 1600, the VR device 1710, and/or the HIPD 1800 that causes an action in a corresponding artificial reality environment. For example, the user 1502 in the third artificial reality system 1500c (shown in FIG. 15C-1) raises the HIPD 1800 to prepare for a swing in the first artificial reality game environment 1520. The VR device 1710, responsive to the user 1502 raising the HIPD 1800, causes the artificial reality representation of the user 1522 to perform a similar action (e.g., raise a virtual object, such as a virtual sword 1524). In some embodiments, each device uses respective sensor data and/or image data to detect the user input and provide an accurate representation of the user 1502's motion. For example, image sensors 1854 (e.g., SLAM cameras or other cameras discussed below in FIGS. 18A and 18B) of the HIPD 1800 can be used to detect a position of the 1800 relative to the user 1502's body such that the virtual object can be positioned appropriately within the first artificial reality game environment 1520; sensor data from the wrist-wearable device 1600 can be used to detect a velocity at which the user 1502 raises the HIPD 1800 such that the artificial reality representation of the user 1522 and the virtual sword 1524 are synchronized with the user 1502's movements; and image sensors 1726 (FIGS. 17A-17C) of the VR device 1710 can be used to represent the user 1502's body, boundary conditions, or real-world objects within the first artificial reality game environment 1520.

In FIG. 15C-2, the user 1502 performs a downward swing while holding the HIPD 1800. The user 1502's downward swing is detected by the wrist-wearable device 1600, the VR device 1710, and/or the HIPD 1800 and a corresponding action is performed in the first artificial reality game environment 1520. In some embodiments, the data captured by each device is used to improve the user's experience within the artificial reality environment. For example, sensor data of the wrist-wearable device 1600 can be used to determine a speed and/or force at which the downward swing is performed and image sensors of the HIPD 1800 and/or the VR device 1710 can be used to determine a location of the swing and how it should be represented in the first artificial reality game environment 1520, which, in turn, can be used as inputs for the artificial reality environment (e.g., game mechanics, which can use detected speed, force, locations, and/or aspects of the user 1502's actions to classify a user's inputs (e.g., user performs a light strike, hard strike, critical strike, glancing strike, miss) or calculate an output (e.g., amount of damage)).

While the wrist-wearable device 1600, the VR device 1710, and/or the HIPD 1800 are described as detecting user inputs, in some embodiments, user inputs are detected at a single device (with the single device being responsible for distributing signals to the other devices for performing the user input). For example, the HIPD 1800 can operate an application for generating the first artificial reality game environment 1520 and provide the VR device 1710 with corresponding data for causing the presentation of the first artificial reality game environment 1520, as well as detect the 1502's movements (while holding the HIPD 1800) to cause the performance of corresponding actions within the first artificial reality game environment 1520. Additionally or alternatively, in some embodiments, operational data (e.g., sensor data, image data, application data, device data, and/or other data) of one or more devices is provide to a single device (e.g., the HIPD 1800) to process the operational data and cause respective devices to perform an action associated with processed operational data.

Having discussed example artificial reality systems, devices for interacting with such artificial reality systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 16A and 16B illustrate an example wrist-wearable device 1600, in accordance with some embodiments. FIG. 16A illustrates components of the wrist-wearable device 1600, which can be used individually or in combination, including combinations that include other electronic devices and/or electronic components.

FIG. 16A shows a wearable band 1610 and a watch body 1620 (or capsule) being coupled, as discussed below, to form the wrist-wearable device 1600. The wrist-wearable device 1600 can perform various functions and/or operations associated with navigating through user interfaces and selectively opening applications, as well as the functions and/or operations described above.

As will be described in more detail below, operations executed by the wrist-wearable device 1600 can include (i) presenting content to a user (e.g., displaying visual content via a display 1605); (ii) detecting (e.g., sensing) user input (e.g., sensing a touch on peripheral button 1623 and/or at a touch screen of the display 1605, a hand gesture detected by sensors (e.g., biopotential sensors)); (iii) sensing biometric data via one or more sensors 1613 (e.g., neuromuscular signals, heart rate, temperature, sleep, etc.); messaging (e.g., text, speech, video, etc.); image capture via one or more imaging devices or cameras 1625; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 1620, independently in the wearable band 1610, and/or via an electronic communication between the watch body 1620 and the wearable band 1610. In some embodiments, functions can be executed on the wrist-wearable device 1600 while an artificial reality environment is being presented (e.g., via one of the artificial reality systems 1500a to 1500d). As the skilled artisan will appreciate upon reading the descriptions provided herein, the novel wearable devices described herein can be used with other types of artificial reality environments.

The wearable band 1610 can be configured to be worn by a user such that an inner (or inside) surface of the wearable structure 1611 of the wearable band 1610 is in contact with the user's skin. When worn by a user, sensors 1613 contact the user's skin. The sensors 1613 can sense biometric data such as a user's heart rate, saturated oxygen level, temperature, sweat level, neuromuscular signal sensors, or a combination thereof. The sensors 1613 can also sense data about a user's environment, including a user's motion, altitude, location, orientation, gait, acceleration, position, or a combination thereof. In some embodiments, the sensors 1613 are configured to track a position and/or motion of the wearable band 1610. The one or more sensors 1613 can include any of the sensors defined above and/or discussed below with respect to FIG. 16B.

The one or more sensors 1613 can be distributed on an inside and/or an outside surface of the wearable band 1610. In some embodiments, the one or more sensors 1613 are uniformly spaced along the wearable band 1610. Alternatively, in some embodiments, the one or more sensors 1613 are positioned at distinct points along the wearable band 1610. As shown in FIG. 16A, the one or more sensors 1613 can be the same or distinct. For example, in some embodiments, the one or more sensors 1613 can be shaped as a pill (e.g., sensor 1613a), an oval, a circle a square, an oblong (e.g., sensor 1613c) and/or any other shape that maintains contact with the user's skin (e.g., such that neuromuscular signal and/or other biometric data can be accurately measured at the user's skin). In some embodiments, the one or more sensors 1613 are aligned to form pairs of sensors (e.g., for sensing neuromuscular signals based on differential sensing within each respective sensor). For example, sensor 1613b is aligned with an adjacent sensor to form sensor pair 1614a and sensor 1613d is aligned with an adjacent sensor to form sensor pair 1614b. In some embodiments, the wearable band 1610 does not have a sensor pair. Alternatively, in some embodiments, the wearable band 1610 has a predetermined number of sensor pairs (one pair of sensors, three pairs of sensors, four pairs of sensors, six pairs of sensors, sixteen pairs of sensors, etc.).

The wearable band 1610 can include any suitable number of sensors 1613. In some embodiments, the number and arrangements of sensors 1613 depend on the particular application for which the wearable band 1610 is used. For instance, a wearable band 1610 configured as an armband, wristband, or chest-band may include a plurality of sensors 1613 with different number of sensors 1613 and different arrangement for each use case, such as medical use cases, compared to gaming or general day-to-day use cases.

In accordance with some embodiments, the wearable band 1610 further includes an electrical ground electrode and a shielding electrode. The electrical ground and shielding electrodes, like the sensors 1613, can be distributed on the inside surface of the wearable band 1610 such that they contact a portion of the user's skin. For example, the electrical ground and shielding electrodes can be at an inside surface of coupling mechanism 1616 or an inside surface of a wearable structure 1611. The electrical ground and shielding electrodes can be formed and/or use the same components as the sensors 1613. In some embodiments, the wearable band 1610 includes more than one electrical ground electrode and more than one shielding electrode.

The sensors 1613 can be formed as part of the wearable structure 1611 of the wearable band 1610. In some embodiments, the sensors 1613 are flush or substantially flush with the wearable structure 1611 such that they do not extend beyond the surface of the wearable structure 1611. While flush with the wearable structure 1611, the sensors 1613 are still configured to contact the user's skin (e.g., via a skin-contacting surface). Alternatively, in some embodiments, the sensors 1613 extend beyond the wearable structure 1611 a predetermined distance (e.g., 0.1 mm to 2 mm) to make contact and depress into the user's skin. In some embodiments, the sensors 1613 are coupled to an actuator (not shown) configured to adjust an extension height (e.g., a distance from the surface of the wearable structure 1611) of the sensors 1613 such that the sensors 1613 make contact and depress into the user's skin. In some embodiments, the actuators adjust the extension height between 0.01 mm to 1.2 mm. This allows the user to customize the positioning of the sensors 1613 to improve the overall comfort of the wearable band 1610 when worn while still allowing the sensors 1613 to contact the user's skin. In some embodiments, the sensors 1613 are indistinguishable from the wearable structure 1611 when worn by the user.

The wearable structure 1611 can be formed of an elastic material, elastomers, etc., configured to be stretched and fitted to be worn by the user. In some embodiments, the wearable structure 1611 is a textile or woven fabric. As described above, the sensors 1613 can be formed as part of a wearable structure 1611. For example, the sensors 1613 can be molded into the wearable structure 1611 or be integrated into a woven fabric (e.g., the sensors 1613 can be sewn into the fabric and mimic the pliability of fabric (e.g., the sensors 1613 can be constructed from a series of woven strands of fabric)).

The wearable structure 1611 can include flexible electronic connectors that interconnect the sensors 1613, the electronic circuitry, and/or other electronic components (described below in reference to FIG. 16B) that are enclosed in the wearable band 1610. In some embodiments, the flexible electronic connectors are configured to interconnect the sensors 1613, the electronic circuitry, and/or other electronic components of the wearable band 1610 with respective sensors and/or other electronic components of another electronic device (e.g., watch body 1620). The flexible electronic connectors are configured to move with the wearable structure 1611 such that the user adjustment to the wearable structure 1611 (e.g., resizing, pulling, folding, etc.) does not stress or strain the electrical coupling of components of the wearable band 1610.

As described above, the wearable band 1610 is configured to be worn by a user. In particular, the wearable band 1610 can be shaped or otherwise manipulated to be worn by a user. For example, the wearable band 1610 can be shaped to have a substantially circular shape such that it can be configured to be worn on the user's lower arm or wrist. Alternatively, the wearable band 1610 can be shaped to be worn on another body part of the user, such as the user's upper arm (e.g., around a bicep), forearm, chest, legs, etc. The wearable band 1610 can include a retaining mechanism 1612 (e.g., a buckle, a hook and loop fastener, etc.) for securing the wearable band 1610 to the user's wrist or other body part. While the wearable band 1610 is worn by the user, the sensors 1613 sense data (referred to as sensor data) from the user's skin. In particular, the sensors 1613 of the wearable band 1610 obtain (e.g., sense and record) neuromuscular signals.

The sensed data (e.g., sensed neuromuscular signals) can be used to detect and/or determine the user's intention to perform certain motor actions. In particular, the sensors 1613 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 1605 of the wrist-wearable device 1600 and/or can be transmitted to a device responsible for rendering an artificial-reality environment (e.g., an HMD) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 1613 can be used to provide a user with an enhanced interaction with a physical object (e.g., devices communicatively coupled with the wearable band 1610) and/or a virtual object in an artificial-reality application generated by an artificial-reality system (e.g., user interface objects presented on the display 1605 or another computing device (e.g., a smartphone)).

In some embodiments, the wearable band 1610 includes one or more haptic devices 1646 (FIG. 16B; e.g., a vibratory haptic actuator) that are configured to provide haptic feedback (e.g., a cutaneous and/or kinesthetic sensation, etc.) to the user's skin. The sensors 1613, and/or the haptic devices 1646 can be configured to operate in conjunction with multiple applications including, without limitation, health monitoring, social media, games, and artificial reality (e.g., the applications associated with artificial reality).

The wearable band 1610 can also include coupling mechanism 1616 (e.g., a cradle or a shape of the coupling mechanism can correspond to shape of the watch body 1620 of the wrist-wearable device 1600) for detachably coupling a capsule (e.g., a computing unit) or watch body 1620 (via a coupling surface of the watch body 1620) to the wearable band 1610. In particular, the coupling mechanism 1616 can be configured to receive a coupling surface proximate to the bottom side of the watch body 1620 (e.g., a side opposite to a front side of the watch body 1620 where the display 1605 is located), such that a user can push the watch body 1620 downward into the coupling mechanism 1616 to attach the watch body 1620 to the coupling mechanism 1616. In some embodiments, the coupling mechanism 1616 can be configured to receive a top side of the watch body 1620 (e.g., a side proximate to the front side of the watch body 1620 where the display 1605 is located) that is pushed upward into the cradle, as opposed to being pushed downward into the coupling mechanism 1616. In some embodiments, the coupling mechanism 1616 is an integrated component of the wearable band 1610 such that the wearable band 1610 and the coupling mechanism 1616 are a single unitary structure. In some embodiments, the coupling mechanism 1616 is a type of frame or shell that allows the watch body 1620 coupling surface to be retained within or on the wearable band 1610 coupling mechanism 1616 (e.g., a cradle, a tracker band, a support base, a clasp, etc.).

The coupling mechanism 1616 can allow for the watch body 1620 to be detachably coupled to the wearable band 1610 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1620 to the wearable band 1610 and to decouple the watch body 1620 from the wearable band 1610. For example, a user can twist, slide, turn, push, pull, or rotate the watch body 1620 relative to the wearable band 1610, or a combination thereof, to attach the watch body 1620 to the wearable band 1610 and to detach the watch body 1620 from the wearable band 1610. Alternatively, as discussed below, in some embodiments, the watch body 1620 can be decoupled from the wearable band 1610 by actuation of the release mechanism 1629.

The wearable band 1610 can be coupled with a watch body 1620 to increase the functionality of the wearable band 1610 (e.g., converting the wearable band 1610 into a wrist-wearable device 1600, adding an additional computing unit and/or battery to increase computational resources and/or a battery life of the wearable band 1610, adding additional sensors to improve sensed data, etc.). As described above, the wearable band 1610 (and the coupling mechanism 1616) is configured to operate independently (e.g., execute functions independently) from watch body 1620. For example, the coupling mechanism 1616 can include one or more sensors 1613 that contact a user's skin when the wearable band 1610 is worn by the user and provide sensor data for determining control commands.

A user can detach the watch body 1620 (or capsule) from the wearable band 1610 in order to reduce the encumbrance of the wrist-wearable device 1600 to the user. For embodiments in which the watch body 1620 is removable, the watch body 1620 can be referred to as a removable structure, such that in these embodiments the wrist-wearable device 1600 includes a wearable portion (e.g., the wearable band 1610) and a removable structure (the watch body 1620).

Turning to the watch body 1620, the watch body 1620 can have a substantially rectangular or circular shape. The watch body 1620 is configured to be worn by the user on their wrist or on another body part. More specifically, the watch body 1620 is sized to be easily carried by the user, attached on a portion of the user's clothing, and/or coupled to the wearable band 1610 (forming the wrist-wearable device 1600). As described above, the watch body 1620 can have a shape corresponding to the coupling mechanism 1616 of the wearable band 1610. In some embodiments, the watch body 1620 includes a single release mechanism 1629 or multiple release mechanisms (e.g., two release mechanisms 1629 positioned on opposing sides of the watch body 1620, such as spring-loaded buttons) for decoupling the watch body 1620 and the wearable band 1610. The release mechanism 1629 can include, without limitation, a button, a knob, a plunger, a handle, a lever, a fastener, a clasp, a dial, a latch, or a combination thereof.

A user can actuate the release mechanism 1629 by pushing, turning, lifting, depressing, shifting, or performing other actions on the release mechanism 1629. Actuation of the release mechanism 1629 can release (e.g., decouple) the watch body 1620 from the coupling mechanism 1616 of the wearable band 1610, allowing the user to use the watch body 1620 independently from wearable band 1610, and vice versa. For example, decoupling the watch body 1620 from the wearable band 1610 can allow the user to capture images using rear-facing camera 1625B. Although the coupling mechanism 1616 is shown positioned at a corner of watch body 1620, the release mechanism 1629 can be positioned anywhere on watch body 1620 that is convenient for the user to actuate. In addition, in some embodiments, the wearable band 1610 can also include a respective release mechanism for decoupling the watch body 1620 from the coupling mechanism 1616. In some embodiments, the release mechanism 1629 is optional and the watch body 1620 can be decoupled from the coupling mechanism 1616 as described above (e.g., via twisting, rotating, etc.).

The watch body 1620 can include one or more peripheral buttons 1623 and 1627 for performing various operations at the watch body 1620. For example, the peripheral buttons 1623 and 1627 can be used to turn on or wake (e.g., transition from a sleep state to an active state) the display 1605, unlock the watch body 1620, increase or decrease a volume, increase or decrease brightness, interact with one or more applications, interact with one or more user interfaces, etc. Additionally, or alternatively, in some embodiments, the display 1605 operates as a touch screen and allows the user to provide one or more inputs for interacting with the watch body 1620.

In some embodiments, the watch body 1620 includes one or more sensors 1621. The sensors 1621 of the watch body 1620 can be the same or distinct from the sensors 1613 of the wearable band 1610. The sensors 1621 of the watch body 1620 can be distributed on an inside and/or an outside surface of the watch body 1620. In some embodiments, the sensors 1621 are configured to contact a user's skin when the watch body 1620 is worn by the user. For example, the sensors 1621 can be placed on the bottom side of the watch body 1620 and the coupling mechanism 1616 can be a cradle with an opening that allows the bottom side of the watch body 1620 to directly contact the user's skin. Alternatively, in some embodiments, the watch body 1620 does not include sensors that are configured to contact the user's skin (e.g., including sensors internal and/or external to the watch body 1620 that configured to sense data of the watch body 1620 and the watch body 1620's surrounding environment). In some embodiments, the sensors 1613 are configured to track a position and/or motion of the watch body 1620.

The watch body 1620 and the wearable band 1610 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 1620 and the wearable band 1610 can share data sensed by the sensors 1613 and 1621, as well as application- and device-specific information (e.g., active and/or available applications), output devices (e.g., display, speakers, etc.), input devices (e.g., touch screen, microphone, imaging sensors, etc.).

In some embodiments, the watch body 1620 can include, without limitation, a front-facing camera 1625A and/or a rear-facing camera 1625B, sensors 1621 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1663; FIG. 16B), a touch sensor, a sweat sensor, etc.). In some embodiments, the watch body 1620 can include one or more haptic devices 1676 (FIG. 16B; a vibratory haptic actuator) that is configured to provide haptic feedback (e.g., a cutaneous and/or kinesthetic sensation, etc.) to the user. The sensors 1621 and/or the haptic device 1676 can also be configured to operate in conjunction with multiple applications including, without limitation, health-monitoring applications, social media applications, game applications, and artificial-reality applications (e.g., the applications associated with artificial reality).

As described above, the watch body 1620 and the wearable band 1610, when coupled, can form the wrist-wearable device 1600. When coupled, the watch body 1620 and wearable band 1610 operate as a single device to execute functions (operations, detections, communications, etc.) described herein. In some embodiments, each device is provided with particular instructions for performing the one or more operations of the wrist-wearable device 1600. For example, in accordance with a determination that the watch body 1620 does not include neuromuscular signal sensors, the wearable band 1610 can include alternative instructions for performing associated instructions (e.g., providing sensed neuromuscular signal data to the watch body 1620 via a different electronic device). Operations of the wrist-wearable device 1600 can be performed by the watch body 1620 alone or in conjunction with the wearable band 1610 (e.g., via respective processors and/or hardware components) and vice versa. In some embodiments, operations of the wrist-wearable device 1600, the watch body 1620, and/or the wearable band 1610 can be performed in conjunction with one or more processors and/or hardware components of another communicatively coupled device (e.g., the HIPD 1800; FIGS. 18A-18B).

As described below with reference to the block diagram of FIG. 16B, the wearable band 1610 and/or the watch body 1620 can each include independent resources required to independently execute functions. For example, the wearable band 1610 and/or the watch body 1620 can each include a power source (e.g., a battery), a memory, data storage, a processor (e.g., a central processing unit (CPU)), communications, a light source, and/or input/output devices.

FIG. 16B shows block diagrams of a computing system 1630 corresponding to the wearable band 1610, and a computing system 1660 corresponding to the watch body 1620, according to some embodiments. A computing system of the wrist-wearable device 1600 includes a combination of components of the wearable band computing system 1630 and the watch body computing system 1660, in accordance with some embodiments.

The watch body 1620 and/or the wearable band 1610 can include one or more components shown in watch body computing system 1660. In some embodiments, a single integrated circuit includes all or a substantial portion of the components of the watch body computing system 1660 are included in a single integrated circuit. Alternatively, in some embodiments, components of the watch body computing system 1660 are included in a plurality of integrated circuits that are communicatively coupled. In some embodiments, the watch body computing system 1660 is configured to couple (e.g., via a wired or wireless connection) with the wearable band computing system 1630, which allows the computing systems to share components, distribute tasks, and/or perform other operations described herein (individually or as a single device).

The watch body computing system 1660 can include one or more processors 1679, a controller 1677, a peripherals interface 1661, a power system 1695, and memory (e.g., a memory 1680), each of which are defined above and described in more detail below.

The power system 1695 can include a charger input 1696, a power-management integrated circuit (PMIC) 1697, and a battery 1698, each are which are defined above. In some embodiments, a watch body 1620 and a wearable band 1610 can have respective charger inputs (e.g., charger input 1696 and 1657), respective batteries (e.g., battery 1698 and 1659), and can share power with each other (e.g., the watch body 1620 can power and/or charge the wearable band 1610, and vice versa). Although watch body 1620 and/or the wearable band 1610 can include respective charger inputs, a single charger input can charge both devices when coupled. The watch body 1620 and the wearable band 1610 can receive a charge using a variety of techniques. In some embodiments, the watch body 1620 and the wearable band 1610 can use a wired charging assembly (e.g., power cords) to receive the charge. Alternatively, or in addition, the watch body 1620 and/or the wearable band 1610 can be configured for wireless charging. For example, a portable charging device can be designed to mate with a portion of watch body 1620 and/or wearable band 1610 and wirelessly deliver usable power to a battery of watch body 1620 and/or wearable band 1610. The watch body 1620 and the wearable band 1610 can have independent power systems (e.g., power system 1695 and 1656) to enable each to operate independently. The watch body 1620 and wearable band 1610 can also share power (e.g., one can charge the other) via respective PMICs (e.g., PMICs 1697 and 1658) that can share power over power and ground conductors and/or over wireless charging antennas.

In some embodiments, the peripherals interface 1661 can include one or more sensors 1621, many of which listed below are defined above. The sensors 1621 can include one or more coupling sensors 1662 for detecting when the watch body 1620 is coupled with another electronic device (e.g., a wearable band 1610). The sensors 1621 can include imaging sensors 1663 (one or more of the cameras 1625 and/or separate imaging sensors 1663 (e.g., thermal-imaging sensors)). In some embodiments, the sensors 1621 include one or more SpO2 sensors 1664. In some embodiments, the sensors 1621 include one or more biopotential-signal sensors (e.g., EMG sensors 1665, which may be disposed on a user-facing portion of the watch body 1620 and/or the wearable band 1610). In some embodiments, the sensors 1621 include one or more capacitive sensors 1666. In some embodiments, the sensors 1621 include one or more heart rate sensors 1667. In some embodiments, the sensors 1621 include one or more IMUs 1668. In some embodiments, one or more IMUs 1668 can be configured to detect movement of a user's hand or other location that the watch body 1620 is placed or held.

In some embodiments, the peripherals interface 1661 includes an NFC component 1669, a global-position system (GPS) component 1670, a long-term evolution (LTE) component 1671, and/or a Wi-Fi and/or Bluetooth communication component 1672. In some embodiments, the peripherals interface 1661 includes one or more buttons 1673 (e.g., the peripheral buttons 1623 and 1627 in FIG. 16A), which, when selected by a user, cause operations to be performed at the watch body 1620. In some embodiments, the peripherals interface 1661 includes one or more indicators, such as a light emitting diode (LED), to provide a user with visual indicators (e.g., message received, low battery, an active microphone, and/or a camera, etc.).

The watch body 1620 can include at least one display 1605 for displaying visual representations of information or data to the user, including user-interface elements and/or three-dimensional (3D) virtual objects. The display can also include a touch screen for inputting user inputs, such as touch gestures, swipe gestures, and the like. The watch body 1620 can include at least one speaker 1674 and at least one microphone 1675 for providing audio signals to the user and receiving audio input from the user. The user can provide user inputs through the microphone 1675 and can also receive audio output from the speaker 1674 as part of a haptic event provided by the haptic controller 1678. The watch body 1620 can include at least one camera 1625, including a front-facing camera 1625A and a rear-facing camera 1625B. The cameras 1625 can include ultra-wide-angle cameras, wide-angle cameras, fish-eye cameras, spherical cameras, telephoto cameras, a depth-sensing cameras, or other types of cameras.

The watch body computing system 1660 can include one or more haptic controllers 1678 and associated componentry (e.g., haptic devices 1676) for providing haptic events at the watch body 1620 (e.g., a vibrating sensation or audio output in response to an event at the watch body 1620). The haptic controllers 1678 can communicate with one or more haptic devices 1676, such as electroacoustic devices, including a speaker of the one or more speakers 1674 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 1678 can provide haptic events to respective haptic actuators that are capable of being sensed by a user of the watch body 1620. In some embodiments, the one or more haptic controllers 1678 can receive input signals from an application of the applications 1682.

In some embodiments, the computer system 1630 and/or the computer system 1660 can include memory 1680, which can be controlled by a memory controller of the one or more controllers 1677 and/or one or more processors 1679. In some embodiments, software components stored in the memory 1680 include one or more applications 1682 configured to perform operations at the watch body 1620. In some embodiments, the one or more applications 1682 include games, word processors, messaging applications, calling applications, web browsers, social media applications, media streaming applications, financial applications, calendars, clocks, etc. In some embodiments, software components stored in the memory 1680 include one or more communication interface modules 1683 as defined above. In some embodiments, software components stored in the memory 1680 include one or more graphics modules 1684 for rendering, encoding, and/or decoding audio and/or visual data; and one or more data management modules 1685 for collecting, organizing, and/or providing access to the data 1687 stored in memory 1680. In some embodiments, one or more of applications 1682 and/or one or more modules can work in conjunction with one another to perform various tasks at the watch body 1620.

In some embodiments, software components stored in the memory 1680 can include one or more operating systems 1681 (e.g., a Linux-based operating system, an Android operating system, etc.). The memory 1680 can also include data 1687. The data 1687 can include profile data 1688A, sensor data 1689A, media content data 1690, and application data 1691.

It should be appreciated that the watch body computing system 1660 is an example of a computing system within the watch body 1620, and that the watch body 1620 can have more or fewer components than shown in the watch body computing system 1660, combine two or more components, and/or have a different configuration and/or arrangement of the components. The various components shown in watch body computing system 1660 are implemented in hardware, software, firmware, or a combination thereof, including one or more signal processing and/or application-specific integrated circuits.

Turning to the wearable band computing system 1630, one or more components that can be included in the wearable band 1610 are shown. The wearable band computing system 1630 can include more or fewer components than shown in the watch body computing system 1660, combine two or more components, and/or have a different configuration and/or arrangement of some or all of the components. In some embodiments, all, or a substantial portion of the components of the wearable band computing system 1630 are included in a single integrated circuit. Alternatively, in some embodiments, components of the wearable band computing system 1630 are included in a plurality of integrated circuits that are communicatively coupled. As described above, in some embodiments, the wearable band computing system 1630 is configured to couple (e.g., via a wired or wireless connection) with the watch body computing system 1660, which allows the computing systems to share components, distribute tasks, and/or perform other operations described herein (individually or as a single device).

The wearable band computing system 1630, similar to the watch body computing system 1660, can include one or more processors 1649, one or more controllers 1647 (including one or more haptics controller 1648), a peripherals interface 1631 that can include one or more sensors 1613 and other peripheral devices, power source (e.g., a power system 1656), and memory (e.g., a memory 1650) that includes an operating system (e.g., an operating system 1651), data (e.g., data 1654 including profile data 1688B, sensor data 1689B, etc.), and one or more modules (e.g., a communications interface module 1652, a data management module 1653, etc.).

The one or more sensors 1613 can be analogous to sensors 1621 of the computer system 1660 in light of the definitions above. For example, sensors 1613 can include one or more coupling sensors 1632, one or more SpO2 sensors 1634, one or more EMG sensors 1635, one or more capacitive sensors 1636, one or more heart rate sensors 1637, and one or more IMU sensors 1638.

The peripherals interface 1631 can also include other components analogous to those included in the peripheral interface 1661 of the computer system 1660, including an NFC component 1639, a GPS component 1640, an LTE component 1641, a Wi-Fi and/or Bluetooth communication component 1642, and/or one or more haptic devices 1676 as described above in reference to peripherals interface 1661. In some embodiments, the peripherals interface 1631 includes one or more buttons 1643, a display 1633, a speaker 1644, a microphone 1645, and a camera 1655. In some embodiments, the peripherals interface 1631 includes one or more indicators, such as an LED.

It should be appreciated that the wearable band computing system 1630 is an example of a computing system within the wearable band 1610, and that the wearable band 1610 can have more or fewer components than shown in the wearable band computing system 1630, combine two or more components, and/or have a different configuration and/or arrangement of the components. The various components shown in wearable band computing system 1630 can be implemented in one or a combination of hardware, software, and firmware, including one or more signal processing and/or application-specific integrated circuits.

The wrist-wearable device 1600 with respect to FIG. 16A is an example of the wearable band 1610 and the watch body 1620 coupled, so the wrist-wearable device 1600 will be understood to include the components shown and described for the wearable band computing system 1630 and the watch body computing system 1660. In some embodiments, wrist-wearable device 1600 has a split architecture (e.g., a split mechanical architecture or a split electrical architecture) between the watch body 1620 and the wearable band 1610. In other words, all of the components shown in the wearable band computing system 1630 and the watch body computing system 1660 can be housed or otherwise disposed in a combined watch device 1600, or within individual components of the watch body 1620, wearable band 1610, and/or portions thereof (e.g., a coupling mechanism 1616 of the wearable band 1610).

The techniques described above can be used with any device for sensing neuromuscular signals, including the arm-wearable devices of FIG. 16A-16B, but could also be used with other types of wearable devices for sensing neuromuscular signals (such as body-wearable or head-wearable devices that might have neuromuscular sensors closer to the brain or spinal column).

In some embodiments, a wrist-wearable device 1600 can be used in conjunction with a head-wearable device described below (e.g., artificial reality device 1700 and VR device 1710) and/or an HIPD 1800, and the wrist-wearable device 1600 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such artificial reality device 1700 and VR device 1710.

### Example Head-Wearable Devices

FIGS. 17A, 17B-1, 17B-2, and 17C show example head-wearable devices, in accordance with some embodiments. Head-wearable devices can include, but are not limited to, artificial reality devices 1710 (e.g., artificial reality or smart eyewear devices, such as smart glasses, smart monocles, smart contacts, etc.), VR devices 1710 (e.g., VR headsets, HMDs, etc.), or other ocularly coupled devices. The artificial reality devices 1700 and the VR devices 1710 can perform various functions and/or operations associated with navigating through user interfaces and selectively opening applications, as well as the functions and/or operations described above.

In some embodiments, an artificial reality system (e.g., artificial reality systems 1500a-1500d; FIGS. 15A-15C-2) includes an artificial reality device 1700 (as shown in FIG. 17A) and/or VR device 1710 (as shown in FIGS. 17B-1-2). In some embodiments, the artificial reality device 1700 and the VR device 1710 can include one or more analogous components (e.g., components for presenting interactive artificial-reality environments, such as processors, memory, and/or presentation devices, including one or more displays and/or one or more waveguides), some of which are described in more detail with respect to FIG. 17C. The head-wearable devices can use display projectors (e.g., display projector assemblies 1707A and 1707B) and/or waveguides for projecting representations of data to a user. Some embodiments of head-wearable devices do not include displays.

FIG. 17A shows an example visual depiction of the artificial reality device 1700 (e.g., which may also be described herein as augmented-reality glasses and/or smart glasses). The artificial reality device 1700 can work in conjunction with additional electronic components that are not shown in FIGS. 17A, such as a wearable accessory device and/or an intermediary processing device, in electronic communication or otherwise configured to be used in conjunction with the artificial reality device 1700. In some embodiments, the wearable accessory device and/or the intermediary processing device may be configured to couple with the artificial reality device 1700 via a coupling mechanism in electronic communication with a coupling sensor 1724, where the coupling sensor 1724 can detect when an electronic device becomes physically or electronically coupled with the artificial reality device 1700. In some embodiments, the artificial reality device 1700 can be configured to couple to a housing (e.g., a portion of frame 1704 or temple arms 1705), which may include one or more additional coupling mechanisms configured to couple with additional accessory devices. The components shown in FIG. 17A can be implemented in hardware, software, firmware, or a combination thereof, including one or more signal-processing components and/or application-specific integrated circuits (ASICs).

The artificial reality device 1700 includes mechanical glasses components, including a frame 1704 configured to hold one or more lenses (e.g., one or both lenses 1706-1 and 1706-2). One of ordinary skill in the art will appreciate that the artificial reality device 1700 can include additional mechanical components, such as hinges configured to allow portions of the frame 1704 of the artificial reality device 1700 to be folded and unfolded, a bridge configured to span the gap between the lenses 1706-1 and 1706-2 and rest on the user's nose, nose pads configured to rest on the bridge of the nose and provide support for the artificial reality device 1700, earpieces configured to rest on the user's ears and provide additional support for the artificial reality device 1700, temple arms 1705 configured to extend from the hinges to the earpieces of the artificial reality device 1700, and the like. One of ordinary skill in the art will further appreciate that some examples of the artificial reality device 1700 can include none of the mechanical components described herein. For example, smart contact lenses configured to present artificial-reality to users may not include any components of the artificial reality device 1700.

The lenses 1706-1 and 1706-2 can be individual displays or display devices (e.g., a waveguide for projected representations). The lenses 1706-1 and 1706-2 may act together or independently to present an image or series of images to a user. In some embodiments, the lenses 1706-1 and 1706-2 can operate in conjunction with one or more display projector assemblies 1707A and 1707B to present image data to a user. While the artificial reality device 1700 includes two displays, embodiments of this disclosure may be implemented in artificial reality devices with a single near-eye display (NED) or more than two NEDs.

The artificial reality device 1700 includes electronic components, many of which will be described in more detail below with respect to FIG. 17C. Some example electronic components are illustrated in FIG. 17A, including sensors 1723-1, 1723-2, 1723-3, 1723-4, 1723-5, and 1723-6, which can be distributed along a substantial portion of the frame 1704 of the artificial reality device 1700. The different types of sensors are described below in reference to FIG. 17C. The artificial reality device 1700 also includes a left camera 1739A and a right camera 1739B, which are located on different sides of the frame 1704. And the eyewear device includes one or more processors 1748A and 1748B (e.g., an integral microprocessor, such as an ASIC) that is embedded into a portion of the frame 1704.

FIGS. 17B-1 and 17B-2 show an example visual depiction of the VR device 1710 (e.g., an HMD 1712, also referred to herein as an artificial-reality headset, a head-wearable device, a VR headset, etc.). The HMD 1712 includes a front body 1714 and a frame 1716 (e.g., a strap or band) shaped to fit around a user's head. In some embodiments, the front body 1714 and/or the frame 1716 includes one or more electronic elements for facilitating presentation of and/or interactions with an artificial reality system (e.g., displays, processors (e.g., processor 1748A-1), IMUs, tracking emitter or detectors, sensors, etc.). In some embodiments, the HMD 1712 includes output audio transducers (e.g., an audio transducer 1718-1), as shown in FIG. 17B-2. In some embodiments, one or more components, such as the output audio transducer(s) 1718-1 and the frame 1716, can be configured to attach and detach (e.g., are detachably attachable) to the HMD 1712 (e.g., a portion or all of the frame 1716, and/or the output audio transducer 1718-1), as shown in FIG. 17B-2. In some embodiments, coupling a detachable component to the HMD 1712 causes the detachable component to come into electronic communication with the HMD 1712. The VR device 1710 includes electronic components, many of which will be described in more detail below with respect to FIG. 17C

FIG. 17B-1 to 17B-2 also show that the VR device 1710 one or more cameras, such as the left camera 1739A and the right camera 1739B, which can be analogous to the left and right cameras on the frame 1704 of the artificial reality device 1700. In some embodiments, the VR device 1710 includes one or more additional cameras (e.g., cameras 1739C and 1739D), which can be configured to augment image data obtained by the cameras 1739A and 1739B by providing more information. For example, the camera 1739C can be used to supply color information that is not discerned by cameras 1739A and 1739B. In some embodiments, one or more of the cameras 1739A to 1739D can include an optional IR cut filter configured to remove IR light from being received at the respective camera sensors.

The VR device 1710 can include a housing 1790 storing one or more components of the VR device 1710 and/or additional components of the VR device 1710. The housing 1790 can be a modular electronic device configured to couple with the VR device 1710 (or an artificial reality device 1700) and supplement and/or extend the capabilities of the VR device 1710 (or an artificial reality device 1700). For example, the housing 1790 can include additional sensors, cameras, power sources, processors (e.g., processor 1748A-2), etc. to improve and/or increase the functionality of the VR device 1710. Examples of the different components included in the housing 1790 are described below in reference to FIG. 17C.

Alternatively or in addition, in some embodiments, the head-wearable device, such as the VR device 1710 and/or the artificial reality device 1700), includes, or is communicatively coupled to, another external device (e.g., a paired device), such as an HIPD 18 (discussed below in reference to FIGS. 18A-18B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 1800, an optional neckband, and/or wearable accessory device) with the head-wearable devices (e.g., an artificial reality device 1700 and/or VR device 1710) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 1800) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 1800, can process information generated by one or more sensors of its sensors and/or information provided by other communicatively coupled devices. For example, a head-wearable device can include an IMU, and the intermediary processing device (neckband and/or an HIPD 1800) can compute all inertial and spatial calculations from the IMUs located on the head-wearable device. Additional examples of processing performed by a communicatively coupled device, such as the HIPD 1800, are provided below in reference to FIGS. 18A and 18B.

Artificial-reality systems may include a variety of types of visual feedback mechanisms. For example, display devices in the artificial reality devices 1700 and/or the VR devices 1710 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the artificial reality device 1700 and/or the VR device 1710 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some artificial reality systems may, instead of blending an artificial reality with actual reality, substantially replace one or more of a user's sensory perceptions of the real world with a virtual experience.

While the example head-wearable devices are respectively described herein as the artificial reality device 1700 and the VR device 1710, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the artificial reality device 1700 and/or the VR device 1710 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 1600, an HIPD 1800, etc.), and/or other devices described herein.

FIG. 17C illustrates a computing system 1720 and an optional housing 1790, each of which show components that can be included in a head-wearable device (e.g., the artificial reality device 1700 and/or the VR device 1710). In some embodiments, more or less components can be included in the optional housing 1790 depending on practical restraints of the respective head-wearable device being described. Additionally or alternatively, the optional housing 1790 can include additional components to expand and/or augment the functionality of a head-wearable device.

In some embodiments, the computing system 1720 and/or the optional housing 1790 can include one or more peripheral interfaces 1722A and 1722B, one or more power systems 1742A and 1742B (including charger input 1743, PMIC 1744, and battery 1745), one or more controllers 1746A 1746B (including one or more haptic controllers 1747), one or more processors 1748A and 1748B (as defined above, including any of the examples provided), and memory 1750A and 1750B, which can all be in electronic communication with each other. For example, the one or more processors 1748A and/or 1748B can be configured to execute instructions stored in the memory 1750A and/or 1750B, which can cause a controller of the one or more controllers 1746A and/or 1746B to cause operations to be performed at one or more peripheral devices of the peripherals interfaces 1722A and/or 1722B. In some embodiments, each operation described can occur based on electrical power provided by the power system 1742A and/or 1742B.

In some embodiments, the peripherals interface 1722A can include one or more devices configured to be part of the computing system 1720, many of which have been defined above and/or described with respect to wrist-wearable devices shown in FIGS. 16A and 16B. For example, the peripherals interface can include one or more sensors 1723A. Some example sensors include: one or more coupling sensors 1724, one or more acoustic sensors 1725, one or more imaging sensors 1726, one or more EMG sensors 1727, one or more capacitive sensors 1728, and/or one or more IMUs 1729. In some embodiments, the sensors 1723A further include depth sensors 1767, light sensors 1768 and/or any other types of sensors defined above or described with respect to any other embodiments discussed herein.

In some embodiments, the peripherals interface can include one or more additional peripheral devices, including one or more NFC devices 1730, one or more GPS devices 1731, one or more LTE devices 1732, one or more WiFi and/or Bluetooth devices 1733, one or more buttons 1734 (e.g., including buttons that are slidable or otherwise adjustable), one or more displays 1735A, one or more speakers 1736A, one or more microphones 1737A, one or more cameras 1738A (e.g., including the a first camera 1739-1 through nth camera 1739-n, which are analogous to the left camera 1739A and/or the right camera 1739B), one or more haptic devices 1740; and/or any other types of peripheral devices defined above or described with respect to any other embodiments discussed herein.

The head-wearable devices can include a variety of types of visual feedback mechanisms (e.g., presentation devices). For example, display devices in the artificial reality device 1700 and/or the VR device 1710 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 1735A can be coupled to each of the lenses 1706-1 and 1706-2 of the artificial reality device 1700. The displays 1735A coupled to each of the lenses 1706-1 and 1706-2 can act together or independently to present an image or series of images to a user. In some embodiments, the artificial reality device 1700 and/or the VR device 1710 includes a single display 1735A (e.g., a near-eye display) or more than two displays 1735A.

In some embodiments, a first set of one or more displays 1735A can be used to present an augmented-reality environment, and a second set of one or more display devices 1735A can be used to present a virtual-reality environment. In some embodiments, one or more waveguides are used in conjunction with presenting artificial-reality content to the user of the artificial reality device 1700 and/or the VR device 1710 (e.g., as a means of delivering light from a display projector assembly and/or one or more displays 1735A to the user's eyes). In some embodiments, one or more waveguides are fully or partially integrated into the artificial reality device 1700 and/or the VR device 1710. Additionally, or alternatively to display screens, some artificial-reality systems include one or more projection systems. For example, display devices in the artificial reality device 1700 and/or the VR device 1710 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 1735A.

In some embodiments of the head-wearable devices, ambient light and/or a real-world live view (e.g., a live feed of the surrounding environment that a user would normally see) can be passed through a display element of a respective head-wearable device presenting aspects of the artificial reality system. In some embodiments, ambient light and/or the real-world live view can be passed through a portion less than all, of an artificial reality environment presented within a user's field of view (e.g., a portion of the artificial reality environment co-located with a physical object in the user's real-world environment that is within a designated boundary (e.g., a guardian boundary) configured to be used by the user while they are interacting with the artificial reality environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 1735A for presenting information to users. For example, an external display 1735A can be used to show a current battery level, network activity (e.g., connected, disconnected, etc.), current activity (e.g., playing a game, in a call, in a meeting, watching a movie, etc.), and/or other relevant information. In some embodiments, the external displays 1735A can be used to communicate with others. For example, a user of the head-wearable device can cause the external displays 1735A to present a do not disturb notification. The external displays 1735A can also be used by the user to share any information captured by the one or more components of the peripherals interface 1722A and/or generated by head-wearable device (e.g., during operation and/or performance of one or more applications).

The memory 1750A can include instructions and/or data executable by one or more processors 1748A (and/or processors 1748B of the housing 1790) and/or a memory controller of the one or more controllers 1746A (and/or controller 1746B of the housing 1790). The memory 1750A can include one or more operating systems 1751; one or more applications 1752; one or more communication interface modules 1753A; one or more graphics modules 1754A; one or more artificial reality processing modules 1755A; and/or any other types of modules or components defined above or described with respect to any other embodiments discussed herein.

The data 1760 stored in memory 1750A can be used in conjunction with one or more of the applications and/or programs discussed above. The data 1760 can include profile data 1761; sensor data 1762; media content data 1763; artificial reality application data 1764; and/or any other types of data defined above or described with respect to any other embodiments discussed herein.

In some embodiments, the controller 1746A of the head-wearable devices processes information generated by the sensors 1723A on the head-wearable devices and/or another component of the head-wearable devices and/or communicatively coupled with the head-wearable devices (e.g., components of the housing 1790, such as components of peripherals interface 1722B). For example, the controller 1746A can process information from the acoustic sensors 1725 and/or image sensors 1726. For each detected sound, the controller 1746A can perform a direction of arrival (DOA) estimation to estimate a direction from which the detected sound arrived at a head-wearable device. As one or more of the acoustic sensors 1725 detects sounds, the controller 1746A can populate an audio data set with the information (e.g., represented by sensor data 1762).

In some embodiments, a physical electronic connector can convey information between the head-wearable devices and another electronic device, and/or between one or more processors 1748A of the head-wearable devices and the controller 1746A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 1800) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the artificial reality device 1700 and/or the VR device 1710 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in artificial reality environment), among a variety of other functions. For example, FIGS. 17B-1 and 17B-2 show the VR device 1710 having cameras 1739A-1739D, which can be used to provide depth information for creating a voxel field and a two-dimensional mesh to provide object information to the user to avoid collisions.

The optional housing 1790 can include analogous components to those describe above with respect to the computing system 1720. For example, the optional housing 1790 can include a respective peripherals interface 1722B including more or less components to those described above with respect to the peripherals interface 1722A. As described above, the components of the optional housing 1790 can be used augment and/or expand on the functionality of the head-wearable devices. For example, the optional housing 1790 can include respective sensors 1723B, speakers 1736B, displays 1735B, microphones 1737B, cameras 1738B, and/or other components to capture and/or present data. Similarly, the optional housing 1790 can include one or more processors 1748B, controllers 1746B, and/or memory 1750B (including respective communication interface modules 1753B; one or more graphics modules 1754B; one or more artificial reality processing modules 1755B, etc.) that can be used individually and/or in conjunction with the components of the computing system 1720.

The techniques described above in FIGS. 17A-17C can be used with different head-wearable devices. In some embodiments, the head-wearable devices (e.g., the artificial reality device 1700 and/or the VR device 1710) can be used in conjunction with one or more wearable device such as a wrist-wearable device 1600 (or components thereof), as well as an HIPD 1800. Having thus described example the head-wearable devices, attention will now be turned to example handheld intermediary processing devices, such as HIPD 1800.

### Example Handheld Intermediary Processing Devices

FIGS. 18A and 18B illustrate an example handheld intermediary processing device (HIPD) 1800, in accordance with some embodiments. The HIPD 1800 can perform various functions and/or operations associated with navigating through user interfaces and selectively opening applications, as well as the functions and/or operations described above.

FIG. 18A shows a top view 1805 and a side view 1825 of the HIPD 1800. The HIPD 1800 is configured to communicatively couple with one or more wearable devices (or other electronic devices) associated with a user. For example, the HIPD 1800 is configured to communicatively couple with a user's wrist-wearable device 1600 (or components thereof, such as the watch body 1620 and the wearable band 1610), artificial reality device 1700, and/or VR device 1710. The HIPD 1800 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 1800 can successfully be communicatively coupled with an electronic device, such as a wearable device).

The HIPD 1800 can perform various functions independently and/or in conjunction with one or more wearable devices (e.g., wrist-wearable device 1600, artificial reality device 1700, VR device 1710, etc.). The HIPD 1800 is configured to increase and/or improve the functionality of communicatively coupled devices, such as the wearable devices. The HIPD 1800 is configured to perform one or more functions or operations associated with interacting with user interfaces and applications of communicatively coupled devices, interacting with an artificial reality environment, interacting with VR environment, and/or operating as a human-machine interface controller, as well as functions and/or operations described above. Additionally, as will be described in more detail below, functionality and/or operations of the HIPD 1800 can include, without limitation, task offloading and/or handoffs; thermals offloading and/or handoffs; 6 degrees of freedom (6DoF) raycasting and/or gaming (e.g., using imaging devices or cameras 1814A and 1814B, which can be used for simultaneous localization and mapping (SLAM) and/or with other image processing techniques); portable charging; messaging; image capturing via one or more imaging devices or cameras (e.g., cameras 1822A and 1822B); sensing user input (e.g., sensing a touch on a multi-touch input surface 1802); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 1800 and/or in communication between the HIPD 1800 and another wearable device described herein. In some embodiments, functions can be executed on the HIPD 1800 in conjunction with an artificial reality environment. As the skilled artisan will appreciate upon reading the descriptions provided herein, the novel the HIPD 1800 described herein can be used with any type of suitable artificial reality environment.

While the HIPD 1800 is communicatively coupled with a wearable device and/or other electronic device, the HIPD 1800 is configured to perform one or more operations initiated at the wearable device and/or the other electronic device. In particular, one or more operations of the wearable device and/or the other electronic device can be offloaded to the HIPD 1800 to be performed. The HIPD 1800 performs the one or more operations of the wearable device and/or the other electronic device and provides to data corresponded to the completed operations to the wearable device and/or the other electronic device. For example, a user can initiate a video stream using artificial reality device 1700 and back-end tasks associated with performing the video stream (e.g., video rendering) can be offloaded to the HIPD 1800, which the HIPD 1800 performs and provides corresponding data to the artificial reality device 1700 to perform remaining front-end tasks associated with the video stream (e.g., presenting the rendered video data via a display of the artificial reality device 1700). In this way, the HIPD 1800, which has more computational resources and greater thermal headroom than a wearable device, can perform computationally intensive tasks for the wearable device improving performance of an operation performed by the wearable device.

The HIPD 1800 includes a multi-touch input surface 1802 on a first side (e.g., a front surface) that is configured to detect one or more user inputs. In particular, the multi-touch input surface 1802 can detect single tap inputs, multi-tap inputs, swipe gestures and/or inputs, force-based and/or pressure-based touch inputs, held taps, and the like. The multi-touch input surface 1802 is configured to detect capacitive touch inputs and/or force (and/or pressure) touch inputs. The multi-touch input surface 1802 includes a first touch-input surface 1804 defined by a surface depression, and a second touch-input surface 1806 defined by a substantially planar portion. The first touch-input surface 1804 can be disposed adjacent to the second touch-input surface 1806. In some embodiments, the first touch-input surface 1804 and the second touch-input surface 1806 can be different dimensions, shapes, and/or cover different portions of the multi-touch input surface 1802. For example, the first touch-input surface 1804 can be substantially circular and the second touch-input surface 1806 is substantially rectangular. In some embodiments, the surface depression of the multi-touch input surface 1802 is configured to guide user handling of the HIPD 1800. In particular, the surface depression is configured such that the user holds the HIPD 1800 upright when held in a single hand (e.g., such that the using imaging devices or cameras 1814A and 1814B are pointed toward a ceiling or the sky). Additionally, the surface depression is configured such that the user's thumb rests within the first touch-input surface 1804.

In some embodiments, the different touch-input surfaces include a plurality of touch-input zones. For example, the second touch-input surface 1806 includes at least a first touch-input zone 1808 within a second touch-input zone 1806 and a third touch-input zone 1810 within the first touch-input zone 1808. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 1808 causes the HIPD 1800 to perform a first command and a user input detected within the second touch-input zone 1806 causes the HIPD 1800 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 1808 can be configured to detect force touch inputs (e.g., a magnitude at which the user presses down) and capacitive touch inputs, and the second touch-input zone 1806 can be configured to detect capacitive touch inputs.

The HIPD 1800 includes one or more sensors 1851 for sensing data used in the performance of one or more operations and/or functions. For example, the HIPD 1800 can include an IMU that is used in conjunction with cameras 1814 for 3-dimensional object manipulation (e.g., enlarging, moving, destroying, etc. an object) in an artificial reality environment. Non-limiting examples of the sensors 1851 included in the HIPD 1800 include a light sensor, a magnetometer, a depth sensor, a pressure sensor, and a force sensor. Additional examples of the sensors 1851 are provided below in reference to FIG. 18B.

The HIPD 1800 can include one or more light indicators 1812 to provide one or more notifications to the user. In some embodiments, the light indicators are LEDs or other types of illumination devices. The light indicators 1812 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 1804. The light indicators can be illuminated in different colors and/or patterns to provide the user with one or more notifications and/or information about the device. For example, a light indicator positioned around the first touch-input surface 1804 can flash when the user receives a notification (e.g., a message), change red when the HIPD 1800 is out of power, operate as a progress bar (e.g., a light ring that is closed when a task is completed (e.g., 0% to 100%)), operates as a volume indicator, etc.).

In some embodiments, the HIPD 1800 includes one or more additional sensors on another surface. For example, as shown FIG. 18A, HIPD 1800 includes a set of one or more sensors (e.g., sensor set 1820) on an edge of the HIPD 1800. The sensor set 1820, when positioned on an edge of the of the HIPD 1800, can be pe positioned at a predetermined tilt angle (e.g., 26 degrees), which allows the sensor set 1820 to be angled toward the user when placed on a desk or other flat surface. Alternatively, in some embodiments, the sensor set 1820 is positioned on a surface opposite the multi-touch input surface 1802 (e.g., a back surface). The one or more sensors of the sensor set 1820 are discussed in detail below.

The side view 1825 of the of the HIPD 1800 shows the sensor set 1820 and camera 1814B. The sensor set 1820 includes one or more cameras 1822A and 1822B, a depth projector 1824, an ambient light sensor 1828, and a depth receiver 1830. In some embodiments, the sensor set 1820 includes a light indicator 1826. The light indicator 1826 can operate as a privacy indicator to let the user and/or those around them know that a camera and/or microphone is active. The sensor set 1820 is configured to capture a user's facial expression such that the user can puppet a custom avatar (e.g., showing emotions, such as smiles, laughter, etc., on the avatar or a digital representation of the user). The sensor set 1820 can be configured as a side stereo RGB system, a rear indirect Time-of-Flight (iToF) system, or a rear stereo RGB system. As the skilled artisan will appreciate upon reading the descriptions provided herein, the novel HIPD 1800 described herein can use different sensor set 1820 configurations and/or sensor set 1820 placement.

In some embodiments, the HIPD 1800 includes one or more haptic devices 1871 (FIG. 18B; e.g., a vibratory haptic actuator) that are configured to provide haptic feedback (e.g., kinesthetic sensation). The sensors 1851, and/or the haptic devices 1871 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 1800 is configured to operate without a display. However, in optional embodiments, the HIPD 1800 can include a display 1868 (FIG. 18B). The HIPD 1800 can also income one or more optional peripheral buttons 1867 (FIG. 18B). For example, the peripheral buttons 1867 can be used to turn on or turn off the HIPD 1800. Further, the HIPD 1800 housing can be formed of polymers and/or elastomer elastomers. The HIPD 1800 can be configured to have a non-slip surface to allow the HIPD 1800 to be placed on a surface without requiring a user to watch over the HIPD 1800. In other words, the HIPD 1800 is designed such that it would not easily slide off a surfaces. In some embodiments, the HIPD 1800 include one or magnets to couple the HIPD 1800 to another surface. This allows the user to mount the HIPD 1800 to different surfaces and provide the user with greater flexibility in use of the HIPD 1800.

As described above, the HIPD 1800 can distribute and/or provide instructions for performing the one or more tasks at the HIPD 1800 and/or a communicatively coupled device. For example, the HIPD 1800 can identify one or more back-end tasks to be performed by the HIPD 1800 and one or more front-end tasks to be performed by a communicatively coupled device. While the HIPD 1800 is configured to offload and/or handoff tasks of a communicatively coupled device, the HIPD 1800 can perform both back-end and front-end tasks (e.g., via one or more processors, such as CPU 1877; FIG. 18B). The HIPD 1800 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, artificial reality object manipulation, artificial reality content display (e.g., presenting content via a virtual display), and/or other artificial reality interactions. The HIPD 1800 can perform the above operations alone or in conjunction with a wearable device (or other communicatively coupled electronic device).

FIG. 18B shows block diagrams of a computing system 1840 of the HIPD 1800, in accordance with some embodiments. The HIPD 1800, described in detail above, can include one or more components shown in HIPD computing system 1840. The HIPD 1800 will be understood to include the components shown and described below for the HIPD computing system 1840. In some embodiments, all, or a substantial portion of the components of the HIPD computing system 1840 are included in a single integrated circuit. Alternatively, in some embodiments, components of the HIPD computing system 1840 are included in a plurality of integrated circuits that are communicatively coupled.

The HIPD computing system 1840 can include a processor (e.g., a CPU 1877, a GPU, and/or a CPU with integrated graphics), a controller 1875, a peripherals interface 1850 that includes one or more sensors 1851 and other peripheral devices, a power source (e.g., a power system 1895), and memory (e.g., a memory 1878) that includes an operating system (e.g., an operating system 1879), data (e.g., data 1888), one or more applications (e.g., applications 1880), and one or more modules (e.g., a communications interface module 1881, a graphics module 1882, a task and processing management module 1883, an interoperability module 1884, an artificial reality processing module 1885, a data management module 1886, etc.). The HIPD computing system 1840 further includes a power system 1895 that includes a charger input and output 1896, a PMIC 1897, and a battery 1898, all of which are defined above.

In some embodiments, the peripherals interface 1850 can include one or more sensors 1851. The sensors 1851 can include analogous sensors to those described above in reference to FIG. 16B. For example, the sensors 1851 can include imaging sensors 1854, (optional) EMG sensors 1856, IMUs 1858, and capacitive sensors 1860. In some embodiments, the sensors 1851 can include one or more pressure sensor 1852 for sensing pressure data, an altimeter 1853 for sensing an altitude of the HIPD 1800, a magnetometer 1855 for sensing a magnetic field, a depth sensor 1857 (or a time-of flight sensor) for determining a difference between the camera and the subject of an image, a position sensor 1859 (e.g., a flexible position sensor) for sensing a relative displacement or position change of a portion of the HIPD 1800, a force sensor 1861 for sensing a force applied to a portion of the HIPD 1800, and a light sensor 1862 (e.g., an ambient light sensor) for detecting an amount of lighting. The sensors 1851 can include one or more sensors not shown in FIG. 18B.

Analogous to the peripherals described above in reference to FIGS. 16B, the peripherals interface 1850 can also include an NFC component 1863, a GPS component 1864, an LTE component 1865, a Wi-Fi and/or Bluetooth communication component 1866, a speaker 1869, a haptic device 1871, and a microphone 1873. As described above in reference to FIG. 18A, the HIPD 1800 can optionally include a display 1868 and/or one or more buttons 1867. The peripherals interface 1850 can further include one or more cameras 1870, touch surfaces 1872, and/or one or more light emitters 1874. The multi-touch input surface 1802 described above in reference to FIG. 18A is an example of touch surface 1872. The light emitters 1874 can be one or more LEDs, lasers, etc. and can be used to project or present information to a user. For example, the light emitters 1874 can include light indicators 1812 and 1826 described above in reference to FIG. 18A. The cameras 1870 (e.g., cameras 1814A, 1814B, and 1822 described above in FIG. 18A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 1870 can be used for SLAM; 6 DoF ray casting, gaming, object manipulation, and/or other rendering; facial recognition and facial expression recognition, etc.

Similar to the watch body computing system 1660 and the watch band computing system 1630 described above in reference to FIG. 16B, the HIPD computing system 1840 can include one or more haptic controllers 1876 and associated componentry (e.g., haptic devices 1871) for providing haptic events at the HIPD 1800.

Memory 1878 can include high-speed random-access memory and/or non-volatile memory, such as one or more magnetic disk storage devices, flash memory devices, or other non-volatile solid-state memory devices. Access to the memory 1878 by other components of the HIPD 1800, such as the one or more processors and the peripherals interface 1850, can be controlled by a memory controller of the controllers 1875.

In some embodiments, software components stored in the memory 1878 include one or more operating systems 1879, one or more applications 1880, one or more communication interface modules 1881, one or more graphics modules 1882, one or more data management modules 1885, which are analogous to the software components described above in reference to FIG. 16B.

In some embodiments, software components stored in the memory 1878 include a task and processing management module 1883 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 1883 uses data 1888 (e.g., device data 1890) to distribute the one or more front-end and/or back-end tasks based on communicatively coupled devices' computing resources, available power, thermal headroom, ongoing operations, and/or other factors. For example, the task and processing management module 1883 can cause the performance of one or more back-end tasks (of an operation performed at communicatively coupled artificial reality device 1700) at the HIPD 1800 in accordance with a determination that the operation is utilizing a predetermined amount (e.g., at least 70%) of computing resources available at the artificial reality device 1700.

In some embodiments, software components stored in the memory 1878 include an interoperability module 1884 for exchanging and utilizing information received and/or provided to distinct communicatively coupled devices. The interoperability module 1884 allows for different systems, devices, and/or applications to connect and communicate in a coordinated way without user input. In some embodiments, software components stored in the memory 1878 include an artificial reality module 1885 that is configured to process signals based at least on sensor data for use in an artificial reality environment. For example, the artificial reality processing module 1885 can be used for 3D object manipulation, gesture recognition, facial and facial expression, recognition, etc.

The memory 1878 can also include data 1888, including structured data. In some embodiments, the data 1888 can include profile data 1889, device data 1889 (including device data of one or more devices communicatively coupled with the HIPD 1800, such as device type, hardware, software, configurations, etc.), sensor data 1891, media content data 1892, and application data 1893.

It should be appreciated that the HIPD computing system 1840 is an example of a computing system within the HIPD 1800, and that the HIPD 1800 can have more or fewer components than shown in the HIPD computing system 1840, combine two or more components, and/or have a different configuration and/or arrangement of the components. The various components shown in HIPD computing system 1840 are implemented in hardware, software, firmware, or a combination thereof, including one or more signal processing and/or application-specific integrated circuits.

The techniques described above in FIG. 18A-18B can be used with any device used as a human-machine interface controller. In some embodiments, an HIPD 1800 can be used in conjunction with one or more wearable device such as a head-wearable device (e.g., artificial reality device 1700 and VR device 1710) and/or a wrist-wearable device 1600 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method comprising, by a computing system of an artificial reality device:
assessing, using the artificial reality device, a semantic-based query for a user, wherein the semantic-based query includes a plurality of user goals associated with an intention of the user;
assessing, based on the semantic-based query for the user, a plurality of probability values associated with a plurality of active digital actions and a plurality of first goal probability values associated with the plurality of active digital actions;
generating a decision engine to determine a user friction value and a plurality of second goal probability values associated with the plurality of user goals using the plurality of first goal probability values and the plurality of probability values associated with the plurality of active digital actions;
determining, using the decision engine, the user friction value and the plurality of second goal probability values associated with the plurality of user goals using the plurality of first goal probability values and the plurality of probability values associated with the plurality of active digital actions;
determining a plan of digital actions based on the user friction value, the plurality of second goal probability values, and the plurality of user goals; and
in response to determining the user friction value exceeds a predetermined threshold, generating a query to the artificial reality device to adjust the plurality of active digital actions based on the semantic-based query for the user.

2. The method of claim 1, further comprising:
in response to determining the user friction value does not exceed a predetermined threshold, transmitting the plan of digital actions to a server computer to perform an operation to deploy the plan of digital actions using a plurality of home-smart devices.

3. The method of claim 1, further comprising:
displaying, using the artificial reality device, the user friction value and the plan of digital actions on a user interface.

4. The method of claim 1, further comprising:
training the decision engine using a greedy optimal ultra-low-friction interface algorithm, wherein the decision engine includes an objective to minimize the user friction value by maximizing a net information gain of the plan of digital actions in current context, and wherein the net information gain is determined by subtracting an information cost from an information gain of the plan of digital actions.

5. The method of claim 1,
wherein the plurality of first goal probability values are associated with a prior probability distribution associated with the plurality of active digital actions before engaging the user, and
wherein the plurality of second goal probability values are associated with a conditional probability distribution associated with the plurality of active digital actions after engaging the user.

6. The method of claim 1, further comprising:
determining an agent aggregator to map current context of the plan of digital actions to a plurality of AI agent aggregations of task representations, wherein the task representations comprise task state, task constraints, and task rewards.

7. The method of claim 6, further comprising:
generating, using the decision engine and the agent aggregator, a dialogue to minimize expected number of explicit input commands needed to disambiguate the intention of the user.

8. The method of claim 1,
wherein the user friction value is a learned function of myriad features which include user's familiarity with a command codality, a user expertise, an environment context, a cognitive load, and
wherein the user friction value is a number of input bits needed to issue a given command for disambiguating the intention of the user.

9. The method of claim 1, further comprising:
determining an I/O mediator to appropriately tailor a current context and promote consistency of a plurality of modalities across multiple deployments of an AI agent; and
determining, using the I/O mediator, a user experience quality value associated with contextual appropriateness and consistency based on the plan of digital actions.

10. One or more non-transitory, computer-readable storage media embodying software that is operable when executed to:
assess, using an artificial reality device, a semantic-based query for a user, wherein the semantic-based query includes a plurality of user goals associated with an intention of the user;
assess, using a server computer and the semantic-based query for the user, a plurality of probability values associated with a plurality of active digital actions and a plurality of first goal probability values associated with the plurality of active digital actions;
generate a decision engine to determine a user friction value and a plurality of second goal probability values associated with the plurality of user goals using the plurality of first goal probability values and the plurality of probability values associated with the plurality of active digital actions;
determine, using the decision engine, the user friction value and the plurality of second goal probability values associated with the plurality of user goals using the plurality of first goal probability values and the plurality of probability values associated with the plurality of active digital actions;
determine a plan of digital actions based on the user friction value, the plurality of second goal probability values, and the plurality of user goals; and
in response to determining the user friction value exceeds a predetermined threshold, generate a query to the artificial reality device to adjust the plurality of active digital actions based on the semantic-based query for the user.

11. The one or more non-transitory, computer-readable storage media of claim 10, wherein the software is further operable when executed to:
in response to determining the user friction value does not exceed a predetermined threshold, transmit the plan of digital actions to a server computer to perform an operation to deploy the plan of digital actions using a plurality of home-smart devices.

12. The one or more non-transitory, computer-readable storage media of claim 10, wherein the software is further operable when executed to:
display, using the artificial reality device, the user friction value and the plan of digital actions on a user interface.

13. The one or more non-transitory, computer-readable storage media of claim 10, wherein the software is further operable when executed to:
train the decision engine using a greedy optimal ultra-low-friction interface algorithm, wherein the decision engine includes an objective to minimize the user friction value by maximizing a net information gain of the plan of digital actions in current context, and wherein the net information gain is determined by subtracting an information cost from an information gain of the plan of digital actions.

14. The one or more non-transitory, computer-readable storage media of claim 10,
wherein the plurality of first goal probability values are associated with a prior probability distribution associated with the plurality of active digital actions before engaging the user, and
wherein the plurality of second goal probability values are associated with a conditional probability distribution associated with the plurality of active digital actions after engaging the user.

15. The one or more non-transitory, computer-readable storage media of claim 10, wherein the software is further operable when executed to:
determine an agent aggregator to map current context of the plan of digital actions to a plurality of AI agent aggregations of task representations, wherein the task representations comprise task state, task constraints, and task rewards.

16. The one or more non-transitory, computer-readable storage media of claim 15, wherein the software is further operable when executed to:
generate, using the decision engine and the agent aggregator, a dialogue to minimize expected number of explicit input commands needed to disambiguate the intention of the user.

17. The one or more non-transitory, computer-readable storage media of claim 10,
wherein the user friction value is a learned function of myriad features which include user's familiarity with a command codality, a user expertise, an environment context, a cognitive load, and
wherein the user friction value is a number of input bits needed to issue a given command for disambiguating the intention of the user.

18. The one or more non-transitory, computer-readable storage media of claim 10, wherein the software is further operable when executed to:
determine an I/O mediator to appropriately tailor a current context and promote consistency of a plurality of modalities across multiple deployments of an AI agent; and
determine, using the I/O mediator, a user experience quality value associated with contextual appropriateness and consistency based on the plan of digital actions.

19. A system comprising:
one or more processors; and
one or more non-transitory, computer-readable storage media coupled to one or more of the processors and comprising instructions operable when executed by one or more of the processors to cause the system to:
assess, using an artificial reality device, a semantic-based query for a user, wherein the semantic-based query includes a plurality of user goals associated with an intention of the user;
assess, using a server computer and the semantic-based query for the user, a plurality of probability values associated with a plurality of active digital actions and a plurality of first goal probability values associated with the plurality of active digital actions;
generate a decision engine to determine a user friction value and a plurality of second goal probability values associated with the plurality of user goals using the plurality of first goal probability values and the plurality of probability values associated with the plurality of active digital actions;
determine, using the decision engine, the user friction value and the plurality of second goal probability values associated with the plurality of user goals using the plurality of first goal probability values and the plurality of probability values associated with the plurality of active digital actions;
determine a plan of digital actions based on the user friction value, the plurality of second goal probability values, and the plurality of user goals; and
in response to determining the user friction value exceeds a predetermined threshold, generate a query to the artificial reality device to adjust the plurality of active digital actions based on the semantic-based query for the user.

20. The system of claim 19, wherein the instructions are further operable when executed by the one or more of the processors to cause the system to:
in response to determining the user friction value does not exceed a predetermined threshold, transmit the plan of digital actions to a server computer to perform an operation to deploy the plan of digital actions using a plurality of home-smart devices.
